(19) United States
(12) Patent Application Publication
(10) Pub. No.: US 2019/0010293 A1
(43) Pub. Date: Jan. 10, 2019

(54) SILICONE COMPOUNDS

(71) Applicant: The Procter & Gamble Company, Cincinnati, OH (US)

(72) Inventors: Gayle Marie FRANKENBACH, Cincinnati, OH (US); Judith Ann HOLLINGSHEAD, Batavia, OH (US); Bernard William KLUESENER, Harrison, OH (US); Rafael TRUJILLO, Mason, OH (US)

(21) Appl. No.: 16/027,401

(22) Filed: Jul. 5, 2018

Related U.S. Application Data
(60) Provisional application No. 62/528,997, filed on Jul. 6, 2017.

(51) Int. Cl. C08G 77/388; C11D 11/00; C11D 3/37; C11D 3/00

(52) U.S. Cl. CPC C08G 77/388; C11D 3/0068; C11D 3/3742; C11D 11/0017

(57) ABSTRACT

The present application relates to silicone compounds, compositions, packaged products and displays comprising such silicone compounds, and processes for making and using such compositions, packaged products and displays comprising such compositions. Such compositions have improved deposition and retention properties that may impart improved benefit characteristics to a composition and/or situs yet which changes its hydrophilicity/charge when desired. Such silicone compounds solve the further problem of malodor reduction as, in addition to maldor masking, such compounds block a malodor's access to a sensory cell, yet leave such sensor cell open to other molecules, for example scent molecules. Thus, the malodor control technologies disclosed herein do not unduly interfere with the scent of the perfumed or unperfumed situs that is treated with the malodor control technology.

### FIELD OF INVENTION

The present application relates to silicone compounds, compositions, packaged products and displays comprising such silicone compounds, and processes for making and using such compositions, packaged products and displays comprising such compositions.

### BACKGROUND OF THE INVENTION

Benefit agents, such as perfumes, brighteners, insect repellants, silicones, waxes, flavors, vitamins and fabric softening agents, skin care agents are expensive and may be less effective when employed at high levels in personal care compositions, cleaning compositions, and fabric care compositions. As a result, there is a desire to maximize the effectiveness of such benefit agents. One method of achieving such objective is to improve the delivery efficiencies of such benefit agents. Unfortunately, it is difficult to improve the delivery efficiencies of benefit agents as such agents may be lost due to the agents' physical or chemical characteristics, such agents may be incompatible with other compositional components or the situs that is treated, or such agents may be lost during post application processes such as rinsing or drying. In an effort to improve the delivery efficiencies of benefit agents, the industry developed perfume amine compounds and perfume thiol compounds. Such compounds were the result of the reaction of a perfume comprising an aldehyde moiety and/or ketone moiety with a carrier that comprised a primary amine, secondary amine and/or thiol moiety. Unfortunately such compounds could only provide limited scents as such compounds were limited to perfumes that contained an aldehyde or ketone moiety. In addition, such compounds were not as effective as desired as they did not deposit on a situs as efficiently as desired.

One solution to the aforementioned problem is silicone compounds that are conjugates of a silicone and a benefit agent, for example a perfume. The aforementioned conjugation is typically achieved by forming a covalent bond between the functionalized portion of the silicone and the benefit agent. Thus, the silicone typically needs to be a functionalized silicone.

Unfortunately, functionalized silicones can reduce the benefits of compositions such as cleaning compositions if such compositions are not formulated with the use of functionalized silicones in mind and/or have other use limitations.

Applicants recognized that such formulation challenges are rooted in the charge of functionalized silicones as the degree of charge and degree of functionalization are interrelated and/or the ability of the functionalized portion of the functionalized silicone to cleave from such functionalized silicone. While one can alter the charge of functionalized silicones by reducing the overall functionalization content of the silicone, such alteration can result in negatives such as a loss in the primary benefits of the functionalized silicones. For example, the reduction of the amino functionalization of an aminosilicone can result in a loss in feel and/or benefit delivery effectiveness. Thus, what is needed are silicone compounds that comprise functionalized silicones that retain all the primary benefits of a functionalized silicone during use, yet which change their hydrophilicity/charge and/or demonstrate cleavage of the functionalized silicone's functionalization when desired, for example, after use. Applicants provide such a silicone compound by employing a functionalized silicone that incorporates a moiety comprising a cleavable bond between the silicone backbone and the desired functionalization. Such silicone compounds solve the further problem of malodor reduction as, in addition to maldor masking, such compounds block a malodor's access to a sensory cell, yet leave such sensor cell open to other molecules, for example scent molecules. Thus, the malodor control technologies disclosed herein do not unduly interfere with the scent of the perfumed or unperfumed situs that is treated with the malodor control technology.

### SUMMARY OF THE INVENTION

The present application relates to silicone compounds, compositions, packaged products and displays comprising such silicone compounds, and processes for making and using such compositions, packaged products and displays comprising such compositions.

### DETAILED DESCRIPTION OF THE INVENTION

### Definitions

As used herein “consumer product” means baby care, beauty care, fabric & home care, family care, feminine care, health care, snack and/or beverage products or devices intended to be used or consumed in the form in which it is sold, and not intended for subsequent commercial manufacture or modification. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition, and water purification.

As used herein, the term “cleaning and/or treatment composition” includes, unless otherwise indicated, granular or powder-form all-purpose or “heavy-duty” washing agents, especially cleaning detergents; solid, granular or powder or beads-form fabric freshening or fabric care compositions; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners; hair shampoos and hair-rinses; shower gels and foam baths and metal cleaners; fabric care composition; as well as cleaning auxiliaries such as bleach additives and “stain-stick” or pre-treat types, substrate-laden products such as dryer added sheets, dry and wetted wipes and pads, nonwoven substrates, and sponges; unit dose products typically such unit dose products comprise a water-soluble film that encapsulates one or more materials that serve as cleaners and/or can be used to treat a surface such as a fabric; as well as sprays and mists.

As used herein, the term “fabric care composition” includes, unless otherwise indicated, fabric softening compositions, fabric enhancing compositions, fabric freshening compositions and combinations thereof. The form of such compositions includes liquids, gels, beads, powders, flakes, and granules.

As used herein, the term “amine” includes, unless otherwise indicated, primary, secondary, tertiary, and quaternary amines

As used herein, the articles such as “a” and “an” when used in a claim, are understood to mean one or more of what is claimed or described.

As used herein, the terms “include”, “includes” and “including” are meant to be synonymous with the phrase “including but not limited to”.

As used herein, the term “solid” includes granular, powder, bar and tablet product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.
A. A silicone compound comprising:
   a) a silicone moiety;
   b) a moiety comprising a substituted organic moiety that comprises a benefit agent fragment; and
   c) a moiety comprising a cleavable bond, said moiety comprising said cleavable bond linking said silicone moiety and said moiety comprising said substituted organic moiety is disclosed.
B. A silicone compound according to Paragraph A, wherein said substituted organic moiety is selected from the group consisting of a substituted C₁-C₃₂ alkyl, a substituted C₅-C₃₂ aryl, and a substituted C₆-C₃₂ alkylaryl, each of said substituted C₁-C₃₂ alkyl, a substituted C₅-C₃₂ aryl, and a substituted C₆-C₃₂ alkylaryl comprising a substitutant selected from the group consisting of:

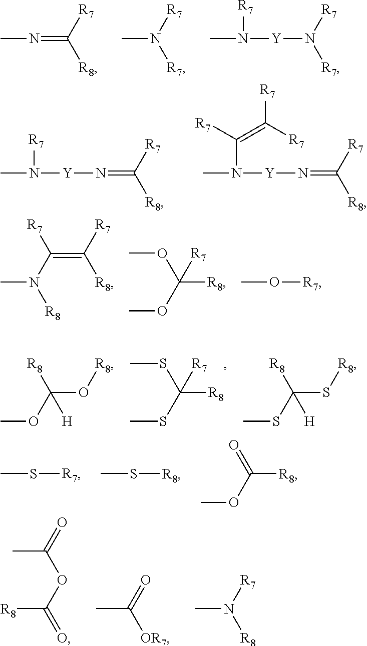

and combinations thereof; wherein: each R₇ is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl; each R₈ is independently selected from the group consisting of C₁-C₃₂ alkyl, C₁-C₃₂ substituted alkyl, C₆-C₃₂ aryl,C₅-C₃₂ substituted aryl, C₆-C₃₂ alkylaryl, and C₅-C₃₂ substituted alkylaryl.

The organic moiety of Paragraph B is an optimized Organic moiety A is tailored for the delivery of benefit agents containing an alcohol, aldehyde and/or ketone functional groups and thus results in a silicone compound that is preferred for delivery of benefit agents containing an alcohol, aldehyde and/or ketone functional groups.
C. The silicone compound according to Paragraph A wherein said silicone moiety has the formula:

[R₁R₂R₃SiO_{1/2}]₍ⱼ₊₂₁₊₂₎[R₄R₅SiO_{2/2}]ₘ[R₆SiO_{3/2}]ⱼ[SiO_{4/2}]ₗ
wherein:
   a) j is an integer from 0 to 150, preferably from 0 to 50, more preferably from 0 to 20;
   b) m is an integer from 0 to 1500, preferably 1 to 1500, more preferably from 20 to 1000, most preferably from 20 to 400;
   c) 1 is an integer from 0 to 150, preferably from 0 to 150, more preferably from 0 to 50, most preferably from 0 to 20; with the provisio j+m+l equals an integer greater than or equal to 1;
   d) each of R₁, R₂, R₃, R₄, R₅ and R₆ moiety is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy, and —Xₜ-A-Y, wherein index t is 0 or 1, with the provisio that at least one of the moieties R₁ through R₆=—Xₜ-A-Y;
      (i) each X moiety is independently, a substituted or unsubstituted divalent alkylene radical comprising 1-24 carbon atoms, preferably 1-16 carbon atoms, more preferably 1-12 carbon atoms, most preferably 2-12 carbon atoms;
      (ii) each A moiety is independently selected from the group consisting of

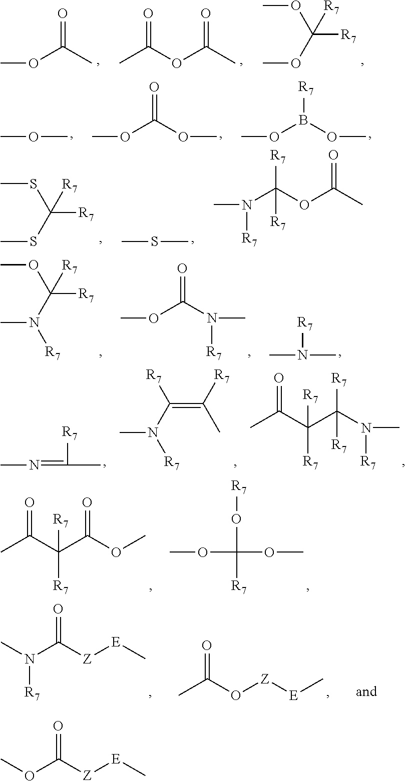

E=electron withdrawing group, preferably E is selected from the group consisting of N, O, S, an aryl moiety and an alkene moiety, more preferably E is N;

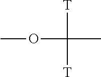

wherein T is selected from an electron withdrawing group E or R₇, with the proviso that at least one T is E; preferably E is selected from the group consisting of O, S, an aryl moiety and an alkene moiety; each R₇ moiety for each A moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; and each Z for each A moiety is independently selected from the group consisting of:

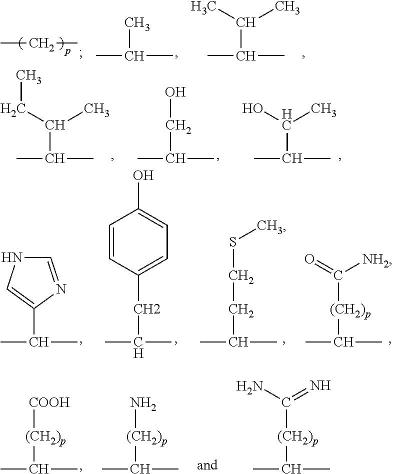

where p is an integer from 1-32, preferably p is an integer form 1-10, more preferably p is an integer from 2 to 8, most preferably p in an integer from 2 to 4;
(ii) each Y moiety is independently selected from the group consisting of a C₁-C₃₂ alkyl, a C₅-C₃₂ aryl, and a C₆-C₃₂ alkylaryl comprising at least one substituent selected from tghe group consisting of

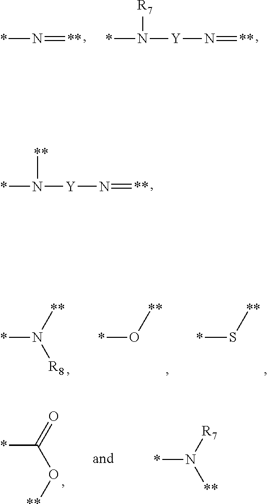

wherein a single asterisk indicates a bond to said respective A and a double asterisk represent bonds to a benefit agent fragment.

The silicone compound of Paragraph C is preferred over that of Paragraph A because the silicone compound of Paragraph C comprises a silicone that is more available, easier and thus less expensive to manufacture, and formulate with and which is tailored for benefit agents containing an alcohol, aldehyde and ketone functional group. Thus, the use of such silicone in the silicone compound of Paragraph B yields a silicone compound that has superior deposition, benefit agent release, mode of covalent attachment (functional group) and results in the silicone compound containing a cleavable bond.
D. A silicone compound according to Paragraphs A through C wherein each A moiety is independently selected from the group consisting of

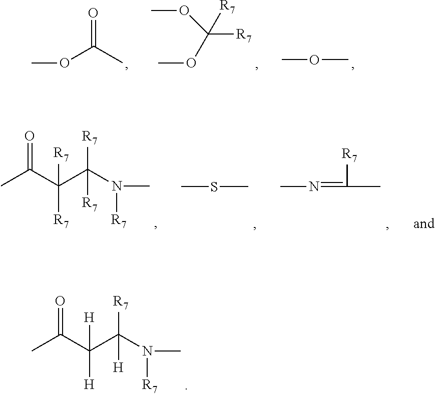

The silicone used in the silicone compound of Paragraph D is available, easy to and thus less expensive to manufacture, and formulate with. In addition, such silicone results in a silicone compound that is preferred as it contains an especially preferred cleavable bond as such bond cleaves under desired conditions.
E. A silicone compound according to Paragraph B, wherein said substituted organic moiety is selected from the group consisting of a substituted C₁-C₃₂ alkyl, a substituted C₅-C₃₂ aryl, and a substituted C₆-C₃₂ alkylaryl, each of said substituted C₁-C₃₂ alkyl, a substituted C₅-C₃₂ aryl, and a substituted C₆-C₃₂ alkylaryl comprising a substitutant selected from the group consisting of:

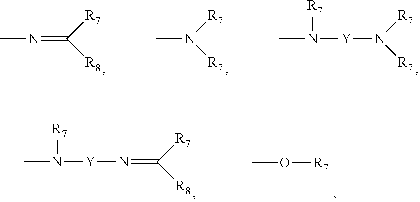

and combinations thereof; wherein: each R₇ is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl; each R₈ is independently selected from the group consisting of C₁-C₃₂ alkyl, C₁-C₃₂ substituted alkyl, C₆-C₃₂ aryl,C₅-C₃₂ substituted aryl, C₆-C₃₂ alkylaryl, and C₅-C₃₂ substituted alkylaryl.

The aforementioned organic moiety is tuned for delivering aldehyde, ketone and alcohol benefit agents. Thus, when such silicone is used to produce the silicone compound of this paragraph, such silicone compound is especially useful in delivering aldehyde, ketone and alcohol benefit agents.
F. The silicone compound according to Paragraph C wherein for said silicone moiety
   a) j is an integer from 0 to 20;
   b) m is an integer from 20 to 400;
   c) 1 is an integer from 0 to 20;
   d) each of R₁, R₂, R₃, R₄, R₅ and R₆ moiety is independently selected from the group consisting of OH, C₁-C₃₂ alkyl and —Xₜ-A-Y, wherein the index t is 0 or 1, with the provisio that at least one of the moieties R₁ through R₆=—Xₜ-A-Y;
      (i) each X moiety is independently, a substituted or unsubstituted divalent alkylene radical comprising 2-12 carbon atoms;
      (ii) each A moiety is independently selected from the group consisting of

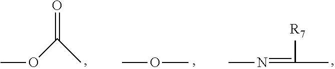

(ii) each Y moiety is independently selected from the group consisting of a C₁-C₃₂ alkyl, a C₅-C₃₂ aryl, and a C₆-C₃₂ alkylaryl comprising at least one substituent selected from the group consisting of

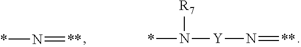

The silicone compound of Paragraph F is most preferred silicone for delivering aldehydes and ketones and utilizes and has the most preferred cleavable bond as such compound contains a silicone that is especially tuned to provide such properties.
G. A silicone compound according to Paragraph F, wherein said substituted organic moiety is selected from the group consisting of a substituted C₁-C₃₂ alkyl, a substituted C₅-C₃₂ aryl, and a substituted C₆-C₃₂ alkylaryl, each of said substituted C₁-C₃₂ alkyl, a substituted C₅-C₃₂ aryl, and a substituted C₆-C₃₂ alkylaryl comprising a substitutant selected from the group consisting of:

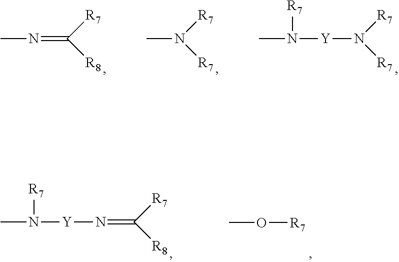

and combinations thereof; wherein: each R₇ is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl; each Rs is independently selected from the group consisting of C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl.
H. The silicone compound according to Paragraphs A through G, wherein said benefit agent fragment is a fragment of a benefit agent selected from the group consisting of a silicones, perfume raw materials, deodorants, odor counteractants, malodors, essential oils, ethers, esters, ketones, alcohols, glycols, silicone hydrocarbons, cyclic hydrocarbons, aldehydes, terpines, insecticides, insect repellants, pesticides, antimicrobial agents, fungicides, herbicides and mixtures thereof, preferably said benefit agent moiety is a fragment of a benefit agent having a molecular weight of 30 Da to 500 Da and/or a CLogP from −2.0 and to 8.0; preferably a CLogP from −2.0 and to 7.0; more preferably a CLogP from −2.0 and to 5.0.
I. The silicone compound according to Paragraphs A through G, wherein said benefit agent fragment is a fragment of a benefit agent that comprises a moiety selected from the group consisting of a vinyl ether, ketone, hydroxyl, aldehyde, thiol, carboxyl, silanol, alkoxy, acetoxy and mixtures thereof, preferably said benefit agent moiety is a fragment of a benefit agent that comprises a moiety selected from the group consisting of a ketone, hydroxyl, aldehyde, thiol, alkoxy, and mixtures thereof, most preferably said benefit agent moiety is a fragment of a benefit agent that comprises a moiety selected from the group consisting of a ketone, hydroxyl, aldehyde and mixtures thereof.
J. The silicone compound according to Paragraphs A Through G, wherein said benefit agent fragment is a fragment of a benefit agent selected from the group consisting of 2-(p-tolyl)propan-2-ol; (2-hydroxy-4-methoxyphenyl)(phenyl)methanone; 4-methyl-1-oxaspiro[5.5]undecan-4-ol; 7-methyl-2H-benzo[b][1,4]dioxepin-3(4H)-one; 1,8-dioxacycloheptadecan-9-one; 4-(tert-pentyl)cyclohexan-1-one; 3,7-dimethyloctanal; octanal; 2-methyl-6-methyleneoct-7-en-2-ol; tetradecanal; 2,2,6,8-tetramethyl-1,2,3,4,4a,5,8,8a-octahydronaphthalen-1-ol; (E)-2,6-dimethylocta-5,7-dien-2-ol; (E)-2,7-dimethylocta-1,5,7-trien-3-ol; (4R,4aS,6R)-4,4a-dimethyl-6-(prop-1-en-2-yl)-4,4a,5,6,7,8-hexahydronaphthalen-2(3H)-one; nonan-1-ol; nonanal; 3,3-Dimethyl-5 (2,2,3-Trimethyl-3-Cyclopenten-1yl)-4-Penten-2-ol; 1-(3-methylbenzofuran-2-yl)ethan-1-one; (E)-3,7,11-trimethyldodeca-1,6,10-trien-3-ol; (Z)-3,7-dimethylocta-2,6-dien-1-ol; 2-(2-(4-methylcyclohex-3-en-1-yl)propyl)cyclopentan-1-one; 6,6-dimethylbicyclo[3.1.1]hept-2-ene-2-carbaldehyde; (E)-4-(2,2,3,6-tetramethylcyclohexyl)but-3-en-2-one; (Z)-1-(2,6,6-trimethylcyclohex-1-en-1-yl)pent-1-en-3-one; 1,7-dioxacycloheptadecan-8-one; 1-(4-(tert-butyl)-2,6-dimethyl-3,5-dinitrophenyl)ethan-1-one; 3-methylcyclopentadecan-1-one; (E)-3-methylcyclopentadec-4-en-1-one; (E)-3,7-dimethylocta-4,6-dien-3-ol; 3-methyl-4-phenylbutan-2-ol; 1-(4-isopropylcyclohexyl)ethan-1-ol; 1-(4-isopropylcyclohexyl)ethan-1-ol; 2-methyldecanal; 4-phenylbutan-2-ol; undecan-2-one; 2-methylundecanal; 1-hydroxydecan-3-one; 1-(naphthalen-2-yl)ethan-1-one; 6-methoxy-2,6-dimethylheptanal; 7-methoxy-3,7-dimethyloctanal; 7-isopropyl-10-methyl-1,5-dioxaspiro[5.5]undecan-3-ol; octahydro-1H-4,7-methanoindene-1-carbaldehyde; ((1s,4s)-4-isopropylcyclohexyl)methanol; 3-(3-(tert-butyl)phenyl)-2-methylpropanal; 2,2-dimethyl-3-(m-tolyl)propan-1-ol; 8-isopropyl-6-methylbicyclo[2.2.2]oct-5-ene-2-carbaldehyde; 4-(4-hydroxy-4-methylpentyl)cyclohex-3-ene-1-carbaldehyde; (Z)-3-hexen-1-yl-2-cyclopenten-1-one; 2-(5-methyl-5-vinyltetrahydrofuran-2-yl)propan-2-ol; 6-methyl-2-(oxiran-2-yl)hept-5-en-2-ol; 3,7-dimethylocta-1,6-dien-3-ol; 3-(4-methylcyclohex-3-en-1-yl)butanal; (2,5-dimethyl-1,3-dihydroinden-2-yl)methanol; 3-(4-(tert-butyl)phenyl)-2-methylpropanal; 2-Methyl-5-(1-methylethenyl)-2-cyclohexenone; (1S,5R)-2-methyl-5-(prop-1-en-2-yl)cyclohex-2-en-1-ol; dodecan-1-ol; 5-hexyl-5-methyldihydrofuran-2(3H)-one; dodecanal; 3,6-dimethylhexahydrobenzofuran-2(3H)-one; 4-(1-ethoxyvinyl)-3,3,5,5-tetramethylcyclohexan-1-one; ((3S,3aR,6R,8aS)-7,7-dimethyl-8-methyleneoctahydro-1H-3a,6-methanoazulen-3-yl)methanol; (1-methyl-24(1,2,2-trimethylbicyclo[3.1.0]hexan-3-yl)methyl)cyclopropyl)methanol; (E)-6-(pent-3-en-1-yl)tetrahydro-2H-pyran-2-one; 2-hexylcyclopentan-1-one; (Z)-4-(6,6-dimethylcyclohex-2-en-1-yl)-3-methylbut-3-en-2-one; (1R,2S,5R)-5-methyl-2-(prop-1-en-2-yl)cyclohexan-1-ol; 4,9-dimethoxy-7H-furo[3,2-g]chromen-7-one; (E)-cyclohexadec-8-en-1-one; (2S,5S)-2-isopropyl-5-methylcyclohexan-1-one; 2-hexylcyclopent-2-en-1-one; (2S,5S)-2-isopropyl-5-methylcyclohexan-1-one; 4-(4-methylpent-3-en-1-yl)cyclohex-3-ene-1-carbaldehyde; 1-((2S,3S)-2,3,8,8-tetramethyl-1,2,3,4,5,6,7,8-octahydronaphthalen-2-yl)ethan-1-one; 2,5,6-trimethylcyclohex-3-ene-1-carbaldehyde; 4-((2R)-1,7,7-trimethylbicyclo[2.2.1]heptan-2-yl)cyclohexan-1-ol; 1,7,7-trimethylbicyclo[2.2.1]heptan-2-ol; (E)-oxacycloheptadec-10-en-2-one; (E)-8-(1H-indo1-1-yl)-2,6-dimethyloct-7-en-2-ol; 8,8-di(1H-indo1-1-yl)-2,6-dimethyloctan-2-ol; (7,7,8,8-tetramethyloctahydro-2,3b-methanocyclopenta[1,3]cyclopropa[1,2]benzen-4-yemethanol; 3,7-dimethyloctane-1,7-diol; 2-cyclododecylpropan-1-ol; 3-phenylpropan-1-ol; 5-ethyl-4-hydroxy-2-methylfuran-3(2H)-one; 2,3-dihydro-3,3-dimethyl-1H-indene-5-propanal; 3-(3,3-dimethyl-2,3-dihydro-1H-inden-5-yl)propanal; (Z)-2-benzylideneoctanal; oxacycloheptadecan-2-one; 3-(benzo[d][1,3]dioxo1-5-yl)-2-methylpropanal; (E)-oxacyclohexadec-13-en-2-one; 2-((3S,5R,8S)-3,8-dimethyl-1,2,3,4,5,6,7,8-octahydro azulen-5-yl)propan-2-ol; 1-(2,6,6-trimethylcyclohex-2-en-1-yl)pentan-3-one; (6E,10E)-3,7,11,15-tetramethylhexadeca-1,6,10,14-tetraen-3-ol; (E)-2-(3,7-dimethylocta-2,6-dien-1-yl)cyclopentan-1-one; 5-heptyldihydrofuran-2(3H)-one; 1-methyl-4-(propan-2-ylidene)cyclohexan-1-ol; 5-pentyldihydrofuran-2(3H)-one; 5-[(Z)-hex-3-enyl]oxolan-2-one; (Z)-4-(2,2-dimethyl-6-methylenecyclohexyl)but-3-en-2-one; 2-((2R,4aR)-4a, 8-dimethyl-1,2,3,4,4a,5,6,7-octahydronaphthalen-2-yl)propan-2-ol; 5-octyldihydrofuran-2(3H)-one; (Z)-1-(2,2-dimethyl-6-methylenecyclohexyl)but-2-en-1-one; 5-hexyldihydrofuran-2(3H)-one; 1-(3,3-dimethylcyclohexyl)pent-4-en-1-one; (64sopropyl-9-methyl-1,4-dioxaspiro[4.5]decan-2-yl)methanol; 2-isobutyl-4-methyltetrahydro-2H-pyran-4-ol; (Z)-6-ethylideneoctahydro-2H-5,8-methanochromen-2-one; 3-(2-ethylphenyl)-2,2-dimethylpropanal; 3-(2-ethylphenyl)-2,2-dimethylpropanal; (E)-4,8-dimethyldeca-4,9-dienal; (E)-4-((3aR,4R,7R,7aR)-1,3a,4,6,7,7a-hexahydro-5H-4,7-methanoinden-5-ylidene)-3-methylbutan-2-ol; 2-heptylcyclopentan-1-one; 1,3,3-trimethylbicyclo[2.2.1]heptan-2-ol; (2E,6E)-3,7,11-trimethyldodeca-2,6,10-trien-1-ol; oxacyclohexadecan-2-one; (E)-cyc lopentadec-4-en-1-one; 1-cyclopentadec-4-en-1-one; 2-methoxy-4-(4-methylenetetrahydro-2H-pyran-2-yl)phenol; 4-allyl-2-methoxyphenol; 1,4-dioxacycloheptadecane-5,17-dione; (E)-3,7-dimethylnona-1,6-dien-3-ol; nonan-3-one; 2-((1R,3S,4S)-4-methyl-3-(prop-1-en-2-yl)-4-vinylcyclohexyl)propan-2-ol; (E)-3-methyl-5-(2,2,3-trimethylcyclopent-3-en-1-yl)pent-4-en-2-ol; (2R,3S,4R)-2,3,4,5-tetrahydroxypentanal; (E)-4-((3aS,7aS)-octahydro-5H-4,7-methanoinden-5-ylidene)butanal; (2R,5R)-2-methyl-5-(prop-1-en-2-yl)cyclohexan-1-one; 2-(2-hydroxypropoxy)propan-1-ol; 7,9-dimethylspiro[5.5]undecan-3-one; 2,6-dimethyloct-7-en-4-one; 2,6-dimethyloct-7-en-2-ol; 3-methyl-2-pentylcyclopent-2-en-1-one; 3,3,5-trimethylcyclohexan-1-one; 2-methoxy-4-propylphenol; 2-methyl-5-(prop-1-en-2-yl)cyclohexan-1-one; 2-methyl-5-(prop-1-en-2-yl)cyclohexan-1-ol; 4-(2,6,6-trimethylcyclohex-2-en-1-yl)butan-2-one; 3,7-dimethyloct-6-en-3-ol; 6-hexyltetrahydro-2H-pyran-2-one; 6-heptyltetrahydro-2H-pyran-2-one; 6-pentyltetrahydro-2H-pyran-2-one; (Z)-1-((1R,2S)-2,6,6-trimethylcyclohex-3-en-1-yl)but-2-en-1-one; dec-9-en-1-ol; decahydronaphthalen-2-ol; 3-(4-isopropylphenyl)-2-methylpropanal; cyclopentadecanone; 1,4-dioxacyclohexadecane-5,16-dione; 8,8-dimethyl-1,2,3,4,5,6,7,8-octahydronaphthalene-2-carbaldehyde; (4-isopropylphenyl)methanol; 1-(benzofuran-2-yl)ethan-1-one; 4-cyclohexyl-2-methylbutan-2-ol; (E)-cycloheptadec-9-en-1-one; 3-(4-methylcyclohex-3-en-1-yl)butan-1-ol; 3,7-dimethyloct-6-en-1-ol; 3,7-dimethyloct-6-enal; (Z)-3-methyl-2-(pent-2-en-1-yl)cyclopent-2-en-1-one; (E)-oxacycloheptadec-11-en-2-one; (Z)-non-6-en-1-ol; (1R,5R)-2-methyl-5-(prop-1-en-2-yl)cyclohex-2-en-1-ol; (Z)-dec-4-enal; (3Z,6Z)-nona-3,6-dien-1-ol; (E)-3-phenylprop-2-en-1-ol; 4-chloro-3,5-dimethylphenol; hexadecan-1-ol; (E)-1-(2,6,6-trimethylcyclohex-2-en-1-yl)hepta-1,6-dien-3-one; 2-methyl-4-(2,6,6-trimethylcyclohex-1-en-1-yl)butanal; 1,6-dioxacycloheptadecan-7-one; 1-(6-(tert-butyl)-1,1-dimethyl-2,3-dihydro-1H-inden-4-yl)ethan-1-one; (3R,3aS,6R,7R,8aS)-3,6,8,8-tetramethyloctahydro-1H-3a,7-methanoazulen-6-ol; 1,1,2,3,3-pentamethyl-1,2,3,5,6,7-hexahydro-4H-inden-4-one; (1S,2S,5R,8S)-4,4,8-trimethyltricyclo[6.3.1.02,5]dodecan-1-ol; 5-isopropyl-2-methylphenol; 2-methyl-5-(prop-1-en-2-yl)cyclohex-2-en-1-one; octan-1-ol; decanal; 3-(4-methoxyphenyl)-2-methylpropanal; 1,7,7-trimethylbicyclo[2.2.1]heptan-2-one; 2,6-di-tert-butyl-4-methylphenol; 2-methyl-4-(2,2,3-trimethylcyclopent-3-en-1-yl)butan-1-ol; 3-(4-(tert-butyl)phenyl)propanal; (E)-2-methyl-4-(2,6,6-trimethylcyclohex-1-en-1-yl)but-2-enal; (1S,2R,4S)-1,7,7-trimethylbicyclo[2.2.1]heptan-2-ol; (5R,10R)-6,10-dimethyl-2-(propan-2-ylidene)spiro[4.5]dec-6-en-8-one; 1-methyl-4-(prop-1-en-2-yl)cyclohexan-1-ol; (2Z,6E)-2,6-dimethyl-10-methylenedodeca-2,6,11-trienal; (Z)-2-methyl-54(1S,2R,4R)-2-methyl-3-methylenebicyclo[2.2.1]heptan-2-yl)pent-2-en-1-ol; (S)-4-methyl-1-((S)-6-methylhept-5-en-2-yl)cyclohex-3-en-1-ol; (Z)-4-(2,2,6-trimethyl-7-oxabicyclo[4.1.0]heptan-1-yl)but-3-en-2-one; 4-methoxy-7H-furo[3,2-glchromen-7-one; 2-methyl-4-phenylbutan-2-ol; 2-methyl-1-phenylpropan-2-ol; benzophenone; 7-isopentyl-2H-benzo[b][1,4[dioxepin-3(4H)-one; 2,5,5-trimethyl-1,2,3,4,5,6,7,8-octahydronaphthalen-2-ol; 2,5,5-trimethyl-1,2,3,4,4a,5,6,7-octahydronaphthalen-2-ol; 1-((2-(tert-butyl)cyclohexyl)oxy)butan-2-ol; (1S,4R,5R)-1-isopropyl-4-methylbicyclo[3.1.0]hexan-3-one; (4R,4aS)-4,4a-dimethyl-6-(propan-2-ylidene)-4,4a,5,6,7,8-hexahydronaphthalen-2(3H)-one; (2Z,6E,9E)-2,6,10-trimethyldodeca-2,6,9,11-tetraenal; (E)-5-(2,3-dimethyltricyclo[2.2.1.02,6]heptan-3-yl)-2-methylpent-2-en-1-ol; 1-(5,5-dimethylcyclohex-1-en-1-yl)pent-4-en-1-one; (R,Z)-1-(2,6,6-trimethylcyclohex-2-en-1-yl)pent-1-en-3-one; (Z)-3-methyl-4-(2,6,6-trimethylcyclohex-2-en-1-yl)but-3-en-2-one; (Z)-4-(2,5,6,6-tetramethylcyclohex-2-en-1-yl)but-3-en-2-one; 2-((2R,4aR,8aR)-4a,8-dimethyl-1,2,3,4,4a,5,6,8a-octahydronaphthalen-2-yl)propan-2-ol; (1R,4S,4aR,8aR)-4-isopropyl-1,6-dimethyl-1,2,3,4,4a,7,8,8a-octahydronaphthalen-1-ol; (R)-2-((R)-4-methylcyclohex-3-en-1-yl)hex-5-en-2-ol; (E)-2-benzylideneheptan-1-ol; (E)-2-benzylideneheptanal; 1-methyl-4-(4-methylpent-3-en-1-yl)cyclohex-3-ene-1-carbaldehyde; 1-phenylpentan-2-ol; 3-methyl-1-phenylpentan-3-ol; 2,3,4-trimethoxybenzaldehyde; 2,4,5-trimethoxybenzaldehyde; 2,4,6-trimethoxybenzaldehyde; Trans,Trans-2,4-Nonadienal; 4-methoxy-2,5-dimethylfuran-3(2H)-one; 2,6,10-trimethylundecanal; alpha-4-Dimethyl benzenepropanal; (E)-undec-9-enal; 2,6,10-trimethylundec-9-enal; (Z)-2-(4-methylbenzylidene)heptanal; dec-9-enal; (Z)-oxacycloheptadec-8-en-2-one; 7-methoxy-2H-chromen-2-one; 2-((2S,4aR,8aR)-4a,8-dimethyl-1,2,3,4,4a,5,6,8a-octahydronaphthalen-2-yl)propan-2-ol; 1-(3,5,5,6,8,8-hexamethyl-5,6,7,8-tetrahydronaphthalen-2-yl)ethan-1-one; 6,8-dimethylnonan-2-ol; 3-(6,6-dimethylbicyclo[3.1.1]hept-2-en-2-yl)propanal; 6,10,14-trimethylpentadecan-2-one; (E)-cyclohexadec-5-en-1-one; 1-isopropyl-4-methylcyclohex-3-en-1-ol; 1-phenylpent-4-en-1-one; 5-methyl-5-phenylhexan-3-one; 1-isopropyl-4-methylcyclohex-3-en-1-ol; 4-(4-methoxyphenyl)butan-2-one; (1aR,2S,4aS)-2,4a,8,8-tetramethyloctahydrocyclopropa[d]naphthalen-3(1H)-one; (E)-3-propylideneisobenzofuran-1(3H)-one; (Z)-dodec-2-enal; 3-methyl-5-phenylpentanal; 3,7-dimethyl-2-methyleneoct-6-enal; 3,7-dimethyloctan-1-ol; 3,4,5-trimethoxybenzaldehyde; 3-(4-isopropylphenyl)propanal; (E)-undec-2-enal; (2E,6E)-nona-2,6-dienal; (Z)-3-(furan-2-yl)-2-phenylacrylaldehyde; 2-phenoxyethan-1-ol; (Z)-non-2-enal; nonan-2-ol; nonan-2-one; (E)-2-isopropyl-5-methylhex-2-enal; (E)-2-hexylidenecyclopentan-1-one; (E)-dec-2-enal; (2E,6E)-nona-2,6-dienal; (2E,6E)-nona-2,6-dien-1-ol; 2,6-dimethyloctanal; decan-1-ol; undec-10-en-1-ol; undec-10-enal; 2-((2R,4aS)-4a,8-dimethyl-1,2,3,4,4a,5,6,7-octahydronaphthalen-2-yl)propan-2-ol; 3,7-dimethyloct-6-en-3-ol; (Z)-1-(2,6,6-trimethylcyclohex-2-en-1-yl)but-2-en-1-one; (1S,5S)-4,6,6-trimethylbicyclo[3.1.1]hept-3-en-2-one; (Z)-dodec-3-enal; (S)-5-heptyldihydrofuran-2(3H)-one; (R)-5-heptyldihydrofuran-2(3H)-one; (R)-3,7-dimethylocta-1,6-dien-3-ol; 3,7-dimethyloct-6-enal; (R)-3,7-dimethyloct-6-enal; (2S,5S,6S)-2,6,10,10-tetramethyl-1-oxaspiro[4.5]decan-6-ol; (1S,2S,5S)-2-methyl-5-(prop-1-en-2-yl)cyclohexan-1-ol; 3,7-dimethyloct-6-en-1-ol; 3,7-dimethyloct-6-en-1-ol; (S)-2-methyl-5-(prop-1-en-2-yl)cyclohex-2-en-1-one; (2S,5R)-2-isopropyl-5-methylcyclohexan-1-one; (R,E)-2-methyl-4-(2,2,3-trimethylcyclopent-3-en-1-yl)but-2-en-1-ol; (E)-4-(2,2-dimethyl-6-methylenecyclohexyl)-3-methylbut-3-en-2-one; 3-(3-isopropylphenyl)butanal; 2-((3S,3aS,5R)-3,8-dimethyl-1,2,3,3a,4,5,6,7-octahydroazulen-5-yl)propan-2-ol; 2-hydroxy-1,2-diphenylethan-1-one; 3-(6,6-dimethylbicyclo[3.1.1]hept-2-en-2-yl)-2,2-dimethylpropanal; 1-(1,1,2,3,3,6-hexamethyl-2,3-dihydro-1H-inden-5-yl)ethan-1-one; 2-(m-tolyl)ethan-1-ol; (3E,6E)-nona-3,6-dien-1-ol; (E)-tridec-2-enal; (1R,4S,4aS,6R,8aS)-4,8a,9,9-tetramethyloctahydro-1,6-methanonaphthalen-1(2H)-ol; 5-hexyl-4-methyldihydrofuran-2(3H)-one; 4-(prop-1-en-2-yl)cyclohex-1-ene-1-carbaldehyde; (4-(prop-1-en-2-yl)cyclohex-1-en-1-yl)methanol; 2-cyclohexylhepta-1,6-dien-3-one; 2-phenylethan-1-ol; 3-methyl-5-phenylpentan-1-ol; 2-(6,6-dimethylbicyclo[3.1.1]hept-2-en-2-yl)acetaldehyde; 6,6-dimethyl-2-methylenebicyclo[3.1.1]heptan-3-ol; 4-(benzo[d][1,3]dioxo1-5-yl)butan-2-one; (4aR,8aS)-7-methyloctahydro-1,4-methanonaphthalen-6(2H)-one; 1,2-dimethyl-3-(prop-1-en-2-yl)cyclopentan-1-ol; 4-isopropyl-1-methylcyclohex-3-en-1-ol; (E)-3,3-dimethyl-5-(2,2,3-trimethylcyclopent-3-en-1-yl)pent-4-en-2-ol; (2Z,5Z)-5,6,7-trimethylocta-2,5-dien-4-one; 1-methyl-4-(4-methylpent-3-en-1-yl)cyclohex-3-ene-1-carbaldehyde; propane-1,2-diol; 4-(tert-pentyl)cyclohexan-1-ol; 3,7-dimethyloct-7-en-1-ol; 2-methyl-5-phenylpentan-1-ol; (S)-3,7-dimethylocta-1,6-dien-3-ol; 5-isopropyl-2-methylbicyclo[3.1.0]hexan-2-ol; (1S,3R,5S)-1-isopropyl-4-methylenebicyclo[3.1.0]hexan-3-ol; 2,2,7,9-tetramethylspiro(5.5)undec-8-en-1-one; 3-methyl-5-(2,2,3-trimethylcyclopent-3-en-1-yl)pentan-2-ol; (Z)-2-ethyl-4-(2,2,3-trimethylcyclopent-3-en-1-yl)but-2-en-1-ol; (E)-2-methyl-4-(2,2,3-trimethylcyclopent-3-en-1-yl)but-2-en-1-ol; 5-methoxyoctahydro-1H-4,7-methanoindene-2-carbaldehyde; 5-methoxyoctahydro-1H-4,7-methanoindene-2-carbaldehyde; 1-(3-hydroxy-3-methylpent-4-en-1-yl)-2,5,5,8a-tetramethyldecahydronaphthalen-2-ol; 3-(4-isobutylphenyl)-2-methylpropanal; (1aR,4aR,7S,7aR,7bR)-1,1,7-trimethyl-4-methylenedecahydro-1H-cyclopropa[e]azulen-7-ol; 1-(spiro[4.5]dec-7-en-7-yl)pent-4-en-1-one; 2-(4-methylthiazol-5-yl)ethan-1-ol; (Z)-dodec-4-enal; (1S,4S,4aR,8aR)-4-isopropyl-1,6-dimethyl-1,2,3,4,4a,7,8,8a-octahydronaphthalen-1-ol; (1S,4S,4aR,8aS)-4-isopropyl-1,6-dimethyl-1,2,3,4,4a,7,8,8a-octahydronaphthalen-1-ol; 3,7-dimethyloctanal; 4-(2,2,6-trimethylcyclohexyl)butan-2-ol; 3-methyl-2-pentylcyclopentan-1-one; 3,7-dimethyloctan-3-ol; 2-(2-mercaptopropan-2-yl)-5-methylcyclohexan-1-one; 2-isopropyl-5-methylphenol; 1-(2,2,6-trimethylcyclohexyl)hexan-3-ol; (2Z,4E)-nona-2,4-dienal; (2E,6E)-3,7,11-trimethyldodeca-2,6,10-trien-1-ol; (2E,6Z)-nona-2,6-dienal; (Z)-dec-2-enal; (E)-non-2-enal; (1R,2S)-2-(tert-butyl)cyclohexan-1-ol; (3E,6Z)-nona-3,6-dien-1-ol; (E)-dec-4-enal; (Z)-1-(2,6,6-trimethylcyclohex-2-en-1-yl)but-2-en-1-one; (Z)-oxacycloheptadec-8-en-2-one; (2R,5R)-2-methyl-5-(prop-1-en-2-yl)cyclohexan-1-one; (E)-3,7-dimethylocta-2,6-dien-1-ol; 7-(1,1-Dimethylethyl)-2H-1,5-benzodioxepin-3(4H)-one; (1R-(lalpha,3 alpha,4aalpha))-2,3,4,4a,5,6-hexahydro-2,2-dimethyl-1,3-methanonaphthalen-7(1H)-one; tridecan-1-ol; 1-((2E,5Z,9Z)-2,6,10-trimethylcyclododeca-2,5,9-trien-1-yl)ethan-1-one; 2-mercapto-2-methylpentan-1-ol; 13-methyl oxacyclopentadec-10-en-2-one; undecanal; (E)-4-methyldec-3-en-5-ol; 2-((2R,8R,8aS)-8,8a-dimethyl-1,2,3,4,6,7,8,8a-octahydronaphthalen-2-yl)propan-2-ol; 2,2,5-trimethyl-5-pentylcyclopentan-1-one; (Z)-2-methyl-4-(2,6,6-trimethylcyclohex-2-en-1-yl)but-2-enal; (1R,5R)-4,6,6-trimethylbicyclo[3.1.1]hept-3-en-2-one; 2-(tert-butyl)cyclohexan-1-ol; 1-((3R,3aR,7R,8aS)-3,6,8,8-tetramethyl-2,3,4,7,8,8a-hexahydro-1H-3a,7-methanoazulen-5-yl)ethan-1-one; 4,8-dimethyl-2-(propan-2-ylidene)-1,2,3,3a,4,5,6,8a-octahydroazulen-6-ol; (1aR,4S,4aS,7R,7aS,7bS)-1,1,4,7-tetramethyldecahydro-1H-cyclopropa[e]azulen-4-ol; (1S,2S,3S,5R)-2,6,6-trimethylspiro[bicyclo[3.1.1]heptane-3,1′-cyclohexan]-2′-en-4′-one; 4-(4-hydroxy-3-methoxyphenyl)butan-2-one; 1,3,4,6,7,8alpha-hexahydro-1,1,5,5-tetramethyl-2H-2,4alpha-methanophtalen-8(5H)-one; 2,2′-oxybis(ethan-1-ol); butane-1,3-diol; hexane-1,6-diol; 2,2′-(ethane-1,2-diylbis(oxy))bis(ethan-1-ol); 2-methylpentane-2,4-diol; (2E,4E)-hepta-2,4-dien-1-ol; hexane-1,2,6-triol; (Z)-oct-5-en-1-ol; (E)-oct-3-en-1-ol; (Z)-oct-5-enal; 2,5-dimethyl-1,4-dithiane-2,5-diol; 2-methyloctan-2-ol; (E)-non-2-en-1-ol; (E)-non-6-en-1-ol; (E)-non-3-en-1-ol; (Z)-non-3-en-1-ol; (2E,6Z)-nona-2,6-dien-1-ol; Mannitol; 3,5-dimethylcyclopentane-1,2-dione; 2,2′,2″-nitrilotris(ethan-1-ol); 3,4,4-trimethylcyclopentane-1,2-dione; 3-Nonen-2-one; (E)-non-5-en-2-one; 2-(cyclohexyloxy)ethan-1-ol; octane-1,8-dithiol; (E)-dec-2-en-1-ol; a-D-Glucopyranose; (E)-dec-5-en-1-ol; 2,3,6-trimethylphenol; (2E,4E)-deca-2,4-dienal; (2E,4Z)-deca-2,4-dienal; decane-1,10-diol; 2-phenylpropan-2-ol; 5-hydroxyoctan-4-one; nonan-3-ol; (Z)-dec-7-enal; (E)-2-methyloct-2-enal; decan-2-ol; 3-(hydroxymethyl)phenol; non-1-en-3-ol; (2-methoxyphenyl)methanol; decan-2-one; 2-(o-tolyl)ethan-1-ol; undecan-1-ol; (E)-dec-3-en-2-one; 3-ethyl-2-hydroxy-4-methylcyclopent-2-en-1-one; 3-phenylpropan-1-ol; 3,5-Octadien-2-ol, 2,6-dimethyl-, (?,Z)—; 3,5-Octadien-2-ol, 2,6-dimethyl-, (?,E)-; Benzenemethanol, 4-methyl-; 2-(benzyloxy)ethan-1-ol; 4,4′-thiobis(butan-2-one); (E)-undec-2-en-1-ol; (2Z,4E)-undeca-2,4-dien-1-01; (E)-7-methyl-3-methyleneocta-4,6-dien-2-ol; (Z)-undec-2-enal; (E)-undec-2-enal; (2Z,4Z)-undeca-2,4-dienal; (2E,4E)-undeca-2,4-dienal; 3-Cyclohexene-1-propanal; decan-3-ol; (E)-undec-8-enal; cyclodecanol; decan-5-ol; 1-benzyl-2-methyldisulfane; (1S,3S,4R,5R)-1-isopropyl-4-methylbicyclo[3.1.0]hexan-3-ol; Bicyclo[3.2.1]octan-8-ol, 1,5,8-trimethyl-; 1-(p-tolyl)ethan-1-ol; undecan-2-ol; 7-methoxy-3,7-dimethyloctan-2-ol; (E)-3,7-dimethylocta-2,6-dien-1-ol; 4-(2-hydroxyethyl)phenol; 2-(tert-butyl)cyclohexan-1-one; 2,6-dimethylheptan-4-one; 2-(furan-2-yl)-4-methyl-1,3-dioxolane; decan-4-one; (4-methoxyphenyl)methanol; 2-methoxy-2-phenylethan-1-ol; (E)-2-isopropyl-5-methylhex-2-en-1-ol; re1-2-42R,5S)-5-methyl-5-vinyltetrahydrofuran-2-yepropan-2-ol; 4-phenylbutan-1-ol; 2-(p-tolyl)ethan-1-ol; 6-methyl-3-(propan-2-ylidene)-7-oxabicyclo[4.1.0]heptan-2-one; (E)-dodec-2-en-1-ol; (2E,6Z)-nona-2,6-dien-1-yl acetate; 2-(p-tolyloxy)ethan-1-ol; 7-methyl-3-methyleneoct-6-enal; (2E,4E)-dodeca-2,4-dien-1-ol; 3-(hydroxymethyl)nonan-2-one; (E)-dodec-2-enal; (2E,4E)-dodeca-2,4-dienal; (E)-2,6-dimethylocta-1,5,7-trien-3-ol; (E)-5-(methylthio)-2-((methylthio)methyl)pent-2-enal; (E)-3-methylnon-3-enoic acid; 1-methyl-4-(prop-1-en-2-yl)-7-oxabicyclo[4.1.0]heptane; (E)-dodec-3-enal; 4-(hydroxymethyl)-2-methoxyphenol; 3,7-dimethyloctane-1,6-diol; undecan-1-ol; (E)-dodec-4-enal; 4-allylphenol; (2E,6Z)-dodeca-2,6-dienal; 3-(5-methylfuran-2-yl)butanal; (E)-4-phenylbut-3-en-2-ol; 2-pentylcyclopent-2-en-1-one; 2-isopropyl-4-methylphenol; dodecan-2-ol; 3,7-dimethyloct-7-ene-1,6-diol; (E)-2-(pent-2-en-1-yl)cyclopentan-1-one; (1R,2S,3R,5S)-2,6,6-trimethylbicyclo[3.1.1]heptan-3-ol; 1-(furan-2-yl)hexan-1-one; benzo[d][1,3]dioxo1-5-ylmethanol; undecane-2,3-dione; undecan-4-one; (Z)-2,7-dimethyloct-5-en-4-one; (E)-3-methylnon-2-enenitrile; 8-ethyl-1,5-dimethylbicyclo[3.2.1]octan-8-ol; dodecan-2-one; undec-1-en-3-one; 2,6-dimethoxy-4-methylphenol; (1S,2S,5S)-2-methyl-5-(prop-1-en-2-yl)cyclohexan-1-ol; 5-phenylpentan-1-ol; rel-(1R,2S,5R)-5-methyl-2-(prop-1-en-2-yl)cyclohexan-1-ol; (1S,2R,5R)-2,6,6-trimethylbicyclo[3.1.1]heptan-3-one; (2R,5R)-5-isopropyl-2-methylcyclohexan-1-one; allyl octanoate; (E)-2-methyl-3-phenylprop-2-en-1-ol; (2S,5R)-2-isopropyl-5-methylcyclohexan-1-one; (E)-2-(3-methylbut-1-en-1-yl)cyclopentan-1-one; (E)-tridec-2-en-1-ol; 41S,2S,5S)-6,6-dimethylbicyclo[3.1.1]heptan-2-yl)methanol; tridecanal; 2-methylundecan-1-ol; 2-(3,4-dimethylphenyl)acetaldehyde; 2-(2,4-dimethylphenyl)acetaldehyde; 6,6-dimethyl-2-methylenebicyclo[3.1.1]heptan-3-one; 1,3-dihydro-2H-inden-2-one; (2E,4E)-trideca-2,4-dienal; (6,6-dimethylbicyclo[3.1.1]hept-2-en-2-yl)methanol; 3-(p-tolyl)propanal; (4S,4aS,8aR)-4,8a-dimethyloctahydronaphthalen-4a(2H)-ol; (E)-2-(hex-2-en-1-yl)cyclopentan-1-ol; 2-(2-hydroxypropan-2-yl)-5-methylcyclohexan-1-ol; 11-methyldodecan-1-ol; (2E,4Z,7Z)-trideca-2,4,7-trienal; cyclododecanol; 2-(4-methylcyclohex-3-en-1-yl)prop-2-en-1-ol; (R)-2-(4-methylcyclohex-3-en-1-yl)prop-2-en-1-ol; (E)-2-methyl-3-(pent-2-en-1-yl)cyclopent-2-en-1-one; (Z)-2-hexylidenecyclopentan- l-one; (E)-3-methyl-2-(pent-2-en-1-yl)cyclopent-2-en-1-one; (2E,6E)-3,7-dimethylnona-2,6-dienal; dodecan-3-one; 1-phenylpentan-1-one; 2,6-diisopropylphenol; (E)-2-(hex-2-en-1-yl)cyclopentan-1-one; 1-(3,3-dimethylbicyclo[2.2.1]heptan-2-yl)ethan-1-ol; 2-(4-methylenecyclohexyl)propanal; 6-pentyl-2H-pyran-2-one; (S)-4-(prop-1-en-2-yl)cyclohex-1-ene-1-carbaldehyde; 4-methyl-5-pentyldihydrofuran-2(3H)-one; (4aS,8aS)-4,4,8a-trimethyloctahydronaphthalen-4a(2H)-ol; tridecan-2-one; 3-methyl-1-phenylbutan-2-ol; 1-(4-isopropylphenyl)ethan-1-one; (E)-3-(4-methoxyphenyl)acrylaldehyde; (R)-6-pentyl-5,6-dihydro-2H-pyran-2-one; tetradecan-1-ol; (E)-6-(pent-2-en-1-yl)tetrahydro-2H-pyran-2-one; 6-phenylhexan-1-ol; 2-(4-isopropylcyclohexyl)ethan-1-ol; 2-methyl-1-(p-tolyl)propan-2-ol; 1-(3,3-dimethylbicyclo[2.2.1]heptan-2-yl)ethan-1-one; (E)-2-ethyl-2-(3-methylbut-2-en-1-yl)hex-3-en-1-ol; 2-(4-ethylphenyl)acetaldehyde; 3-ethylhexahydrobenzofuran-2(3H)-one; (E)-3-methyl-1-phenylpent-1-en-3-ol; (2-hexyl-1,3-dioxolan-4-yl)methanol; 6-ethyl-3-methyloct-5-en-1-ol; 1-(3,4-dimethoxyphenyl)ethan-1-one; octahydronaphthalen-2(1H)-one; 2-(4-isopropylphenyl)ethan-1-ol; 1-methyl-4-(prop-1-en-2-yl)-7-oxabicyclo[4.1.0]heptan-2-one; (E)-5,9-dimethyldeca-4,9-dienal; 5-methyl-3,4-dihydronaphthalen-1(2H)-one; 8-methyl-3,4-dihydronaphthalen-1(2H)-one; (E)-tetradec-2-enal; 4-(tert-butyl)cyclohexane-1-carbaldehyde; 2-(6,6-dimethylbicyclo[3.1.1]hept-2-en-2-yl)ethan-1-ol; (4,7,7-trimethylbicyclo[4.1.0]hept-4-en-3-yl)methanol; (Z)-2-(3,3-dimethylbicyclo[2.2.1]heptan-2-ylidene)ethan-1-ol; (3aR,7aR)-octahydro-5H-4,7-methanoinden-5-one; 4-(3-hydroxybutyl)phenol; 2,5,7,7-tetramethyloctanal; 7-isopropyl-4-methyloxepan-2-one; 2-phenylpent-4-enal; 4-hydroxy-3,5-dimethoxybenzaldehyde; (E)-4-(3-hydroxyprop-1-en-1-yl)-2-methoxyphenol; 3,6-dimethyl-5,6,7,7a-tetrahydrobenzofuran-2(4H)-one; (6R,7aR)-3,6-dimethyl-5,6,7,7a-tetrahydrobenzofuran-2(4H)-one; 2-methyl-4-phenylbutanal; (Z)-2-heptylidenecyclopentan-1-one; 3-(4-methoxyphenyl)butan-2-one; 2-ethyl-5-methoxybicyclo[2.2.1]heptane; tridecan-3-one; (Z)-2-hexylidenecyclohexan-1-one; 2-pentylcyclohex-2-en-1-one; 4-ethyl-2,6-dimethoxyphenol; 2-((1,7,7-trimethylbicyclo[2.2.1]heptan-2-yeoxy)ethan-1-ol; 4-(2,6,6-trimethylcyclohex-1-en-1-yl)butan-2-ol; 1-(5-isopropyl-2-methylphenyeethan-1-one; pentadecan-1-ol; (E)-4-(2,6,6-trimethylcyclohex-1-en-1-yl)but-3-en-2-ol; 1-(4-hydroxy-3,5-dimethoxyphenyl)ethan-1-one; (2-phenyl-1,3-dioxolan-4-yl)methanol; 1-(4,7,7-trimethylbicyclo[4.1.0]hept-4-en-3-yl)ethan-1-one; octyl 2-methylbutanoate; (E)-4-(2,6,6-trimethylcyclohex-2-en-1-yl)but-3-en-2-ol; 1-allyl-2,2,7,7-tetramethylcycloheptan-1-ol; (S)-2,5,5-trimethyl-1,2,3,4,5,6,7,8-octahydronaphthalen-2-ol; 1-(naphthalen-1-yl)ethan-1-one; 5-ethyl-2-methylnonan-1-ol; 8,8-dimethoxy-2,6-dimethyloctan-2-ol; 3-(but-3-en-1-yl)-2,4,4-trimethylcyclohex-2-en-1-one; 2-(4-isopropylcyclohexyl)propan-1-ol; pentadecanal; (E)-3,7,9-trimethyldeca-1,6-dien-3-ol; (Z)-2-ethylideneundecanal; (E)-1-(2,6,6-trimethylcyclohex-3-en-1-yl)but-2-en-1-one; 4-(2,2-dimethyl-6-methylenecyclohexyl)butan-2-ol; (5s,8s)-8-isopropyl-1-oxaspiro[4.5]clecan-2-one; (5r,8r)-8-isopropyl-1-oxaspiro[4.5]clecan-2-one; 2,5,5-trimethyl-2,3,4,4a,5,6,7,8-octahydronaphthalen-2-ol; 3,5-diethyl-2,6-dimethylcyclohex-2-en-1-one; (Z)-4-(4-methylcyclohex-3-en-1-ylidene)pentanal; (2R,5S,6S)-2,6,10,10-tetramethyl-1-oxaspiro[4.5]decan-6-ol; 6-methyl-3,4-dihydronaphthalen-1(2H)-one; ethyl benzo[d][1,3[dioxole-5-carboxylate; 7-methyl-3,4-dihydronaphthalen-1(2H)-one; 5-ethyl-2-methylnonanal; (3E,5E)-6,10-dimethylundeca-3,5,9-trien-2-one;[1,1′-bncyclohexan)]-1′-en-2-one; 4-(2,2-dimethyl-6-methylenecyclohexyl)butan-2-one; 2-isopropyl-2,3-dihydro-1H-inden-1-one; (E)-4-(2,3,6-trimethylphenyl)but-3-en-2-one; 2-(4-isopropylphenyl)propanal; 6,10-dimethylundec-9-en-2-one; (E)-6,10-dimethylundec a-5,9-dien-2-one; 1-(4-methoxy-2,2,6,6-tetramethylcyclohex-3-en-1-yl)ethan-1-one; (E)-6,10-dimethylundeca-3,9-dien-2-one; 1-(4-butylphenyl)ethan-1-one; tetradecan-3-one; 3-propylbicyclo[2.2.1]hept-5-ene-2-carbaldehyde; (E)-2,6-dimethoxy-4-(prop-1-en-1-yl)phenol; (E)-2-(oct-2-en-1-yl)cyclopentan-1-one; pentadecan-2-one; (E)-6,10-dimethylundeca-5,10-dien-2-one; 4,4a,6,7,8,8a-hexahydro-1,4-methanonaphthalen-5(1H)-one; 3-heptyl-5-methyldihydrofuran-2(3H)-one; (Z)-5-(oct-2-en-1-yl)dihydrofuran-2(3H)-one; 4,7,7-trimethylspiro[bicyclo[2.2.1]heptane-2,1′-cyclopentan]-3-one; (E)-1-(2,6,6-trimethylcyclohex-1-en-1-yl)pent-1-en-3-ol; 4-allyl-2,6-dimethoxyphenol; 2,6,8-trimethylnonan-4-one; (2,8,8-trimethyl-1,2,3,4,5,6,7,8-octahydronaphthalen-2-yl)methanol; (E)-3-(4-methoxyphenyl)-2-methylacrylaldehyde; (2E,6E)-3,7,9-trimethyldeca-2,6-dienal; (5,6-dimethyl-1-(prop-1-en-2-yl)bicyclo[2.2.1]hept-5-en-2-yl)methanol; 1-(2,4-dimethylcyclohex-3-en-1-yl)-2,2-dimethylpropan-1-one; (E)-3-butylideneisobenzofuran-1(3H)-one; 5-(6-methylhept-5-en-2-yl)dihydrofuran-2(3H)-one; 2-(4-(tert-butyl)-2-methylphenoxy)acetaldehyde; (E)-4-(4-hydroxy-3-methoxyphenyl)but-3-en-2-one; 1-(2,4-diethylphenyl)ethan-1-one; (E)-4-(3-hydroxyprop-1-en-1-yl)-2,6-dimethoxyphenol; 3-butylisobenzofuran-1(3H)-one; 2,4,5-trimethyl-4-phenyl-1,3-dioxane; 4-methyl-1-phenylpentan-2-one; 14-methylpentadecan-1-ol; adamantan-2-ol; (3 aS,4S,8S,8aR)-2,2,4-trimethyldecahydro-4,8-methanoazulen-9-ol; (E)-3-(4-hydroxy-3,5-dimethoxyphenyl)acrylaldehyde; (3E,5E)-3,6,10-trimethylundeca-3,5,9-trien-2-one; (E)-2,5,9-trimethyldeca-4,9-dienal; (E)-4-(benzo[d][1,3]dioxo1-5-yl)but-3-en-2-one; 446,6-dimethylbicyclo[3.1.1]hept-2-en-2-yl)butanal; 2,8,8-trimethyloctahydro-2H-4a,2-(epoxymethano)naphthalen-10-one; (E)-3,6,10-trimethylundeca-3,9-dien-2-one; 4-methyl-8-methyleneadamantan-2-ol; 3-methyl-4-(2,2,6-trimethylcyclohexyl)butan-2-ol; hexadecan-2-one; adamantan-2-one; heptadecan-1-ol; 4-(4-methoxyphenyl)-3-methylbutan-2-one; (E)-3-methyl-5-10(2,2,3-trimethylcyclopent-3-en-1-yl)pent-3-en-2-one; 2,4-di-tert-butylcyclohexan-1-one; 145-isopropyl-2-methylcyclohex-2-en-1-yl)propan-1-one; (E)-2-methyl-4-(2,6,6-trimethylcyclohex-2-en-1-yl)but-3-enal; (E)-2,6,10-trimethylundeca-5,9-dien-1-ol; 1-methyl-4-(4-methylpentyl)cyclohex-3-ene-1-carbaldehyde; (E)-3-(benzo[d][1,3]dioxo1-5-yl)-2-methylacrylaldehyde; 1-(2,6,6-trimethylcyclohex-2-en-1-yl)pentan-3-one; (R,E)-1-(2,6,6-trimethylcyclohex-2-en-1-yl)pent-1-en-3-one; (S,E)-3,7,11-trimethyldodeca-1,6,10-trien-3-ol; (E)-2,6,10-trimethylundeca-5,9-dienal; 2,6-di-tert-butyl-4-(hydroxymethyl)phenol; (Z)-2-benzylidenehexanal; 5,5,6,7,7-pentamethylhexahydroindeno[3a,4-b]oxiren-4(1aH)-one; (4E,6E)-7,11-dimethyldodeca-4,6,10-trien-3-one; 2,5-di-tert-butylbenzene-1,4-diol; 2-methoxy-4-(4-methyl-1,3-dioxolan-2-yl)phenol; 4-(3,4-dimethoxyphenyl)butan-2-one; (Z)-2-(furan-2-ylmethylene)octanal; (E)-1-(4-methoxyphenyl)pent-1-en-3-one; 3-(4-isopropylphenyl)-2-methylpropan-1-ol; (E)-6-(2,2,3-trimethylcyclopent-3-en-1-yl)hex-5-en-3-ol; 1-(benzo[cl][1,3]dioxo1-5-yl)butan-2-one; 1-(1,1,3-trimethyl-2,3,4,5,6,7-hexahydro-1H-inden-5-yl)ethan-1-one; 10-methyl-1,2,3,4,5,6,7,8,9,10-decahydro-5,9-methanobenzo[8]annulen-11-one; 3-(2-oxopropyl)-2-pentylcyclopentan-1-one; octadecan-1-ol; 3-(4-hydroxy-4-methylpentyl)cyclohex-3-ene-1-carbaldehyde; 2-((1R,35,45)-4-methyl-3-(prop-1-en-2-yl)-4-vinylcyclohexyl)propan-2-ol; (E)-1-(4-methoxyphenyl)-4-methylpent-1-en-3-one; (2R,4aR,8aS)-1,1,5,5-tetramethylhexahydro-2H-2,4a-methanonaphthalen-8(5H)-one; (E)-2,3-dimethyl-4-(2,6,6-trimethylcyclohex-2-en-1-yl)but-3-enal; 6-isopropyldecahydronaphthalen-2-ol; (2E,6E)-3,7,11-trimethyldodeca-2,6,10-trienal; 1,7,7-trimethylbicyclo[2.2.1]heptan-2-yl isobutyrate; (Z)-octadec-9-en-1-ol; 2-methyl-3-41,7,7-trimethylbicyclo[2.2.1]heptan-2-yl)oxy)propan-1-ol; (E)-2-methyl-1-(2,6,6-trimethylcyclohex-2-en-1-yl)pent-1-en-3-one; 3-(4-(tert-butyl)phenyl)-2-methylpropan-1-ol; 4,7,7-trimethyl-4-(3-methylbut-2-en-1-yl)bicyclo[4.1.0]heptan-3-one; (Z)-2-methyl-1-(2,2,6-trimethylcyclohex-3-en-1-yl)pent-1-en-3-one; 34(2-isopropyl-5-methylcyclohexyl)oxy)propane-1,2-diol; (Z)-2-benzylideneheptanal; 4,7,7-trimethyl-2-(3-methylbut-2-en-1-yl)bicyclo[4.1.01heptan-3-one; (E)-2-((1S,3aR,4S,8aS)-4, 8,8-trimethyldecahydro-1,4-methanoazulen-9-ylidene)ethan-1-ol; 6-isopropyloctahydronaphthalen-2(1H)-one; 7-ethoxy-4-methyl-2H-chromen-2-one; (E)-4-methyl-6-(2,2,3-trimethylcyclopent-3-en-1-yl)hex-4-en-3-ol; 3, 8,8-trimethyl-6-methyleneoctahydro-1H-3a,7-methanoazulen-5-ol; (3R,3aR,6S,7S,8aS)-3,6,8,8-tetramethylhexahydro-1H-3a,7-methanoazulen-5(4H)-one; (E)-4-methyl-6-(2,2,3-trimethylcyclopent-3-en-1-yl)hex-5-en-3-ol; 1-(4,4-dimethyl-1,2,3,4-tetrahydronaphthalen-1-yl)propan-1-one; 8,12-dimethyltridec-11-en-6-one; 2-ethoxy-4-(4-methyl-1,3-dioxolan-2-yl)phenol; 3-benzylheptan-4-one; heptadecan-9-one; ((2S,4aR)-1,1,5,5-tetramethyl-1,3,4,5,6,7-hexahydro-2H-2,4a-methanonaphthalen-8-yl)methanol; (octahydro-1H-4,7-methanoindene-2,5-diyl)dimethanol; (1R,5S,9S,E)-4,11,11-trimethyl-8-methylenebicyclo[7.2.01undec-3-en-5-ol; 1-(4-butoxy-2,2,6,6-tetramethylcyclohex-3-en-1-yl)ethan-1-one; (E)-2-methyl-1-(1-methylbicyclo[2.2.1]hept-5-en-2-yl)pent-1-en-3-ol; (E)-1-(3,5,6-trimethylcyclohex-3-en-1-yl)pent-1-en-3-one; (E)-1-(2,4,6-trimethylcyclohex-3-en-1-yl)pent-1-en-3-one; 2-((3S,3aS,5R,8S,8aS)-3,8-dimethyldecahydroazulen-5-yl)propan-2-ol; (2E,6E,9E)-2,6,10-trimethyldodeca-2,6,9,11-tetraenal; 1-(2,5,5-trimethyl-1,3,4,5,6,7-hexahydro-2H-2,4a-ethanonaphthalen-8-yl)ethan-1-one; oxacyclohexadecane-2,13-dione; (3R,3aR,7S,8aS)-3,6,8,8-tetramethyl-1,2,3,7,8,8a-hexahydro-4H-3a,7-methanoazulen-4-one; 1-(2,3,8,8-tetramethyl-1,2,3,5,6,7,8,8a-octahydronaphthalen-2-yl)ethan-1-one; (E)-chalcone; (E)-4-(1,3a,4,6,7,7a-hexahydro-5H-4,7-methanoinden-5-ylidene)butan-2-ol; (E)-3-((2,6,6-trimethylcyclohex-2-en-1-ylidene)methyl)hex-5-en-2-one; (3aR,5aS,9aS,9bR)-3a,6,6,9a-tetramethyldecahydronaphtho[2,1-blfuran-2(1H)-one; (E)-5-methyl-1-(2,6,6-trimethylcyclohex-2-en-1-yl)hex-1-en-3-one; 10,11-dihydro-5H-dibenzo[a,c11[71annulen-5-one; pentamethyl-5,6,7,8-tetrahydronaphthalene-2-c arbaldehyde; (4R,4aS,6R,8aS)-4,4a-dimethyl-6-(prop-1-en-2-yl)octahydronaphthalen-2(1H)-one; 2-(1,1,2,3,3-pentamethyl-2,3-dihydro-1H-inden-5-yl)propan-1-ol; 8-(tert-butyl)-4,6-dimethyl-2H-chromen-2-one; (E)-4-(3a,4,5,6,7,7 a-hexahydro-1H-4,7-methanoinden-5-yl)-3-methylbut-3-en-2-ol; (E)-4-(3a,4,5,6,7,7a-hexahydro-1H-4,7-methanoinden-6-yl)-3-methylbut-3-en-2-ol; 2-((4-isopropylcyclohex-1-en-1-yl)methyl)cyclopentan-1-one; 445,5,6-trimethylbicyclo[2.2.11heptan-2-yl)cyclohexan-1-ol; 1,3-diphenylpropan-2-one; 3-((2R)-5,5,6-trimethylbicyclo[2.2.11heptan-2-yl)cyclohexan-1-ol; 3-ethyl-5,5,8,8-tetramethyl-5,6,7,8-tetrahydronaphthalene-2-carbaldehyde; (1S)-3-((Z)-benzylidene)-1,7,7-trimethylbicyclo[2.2.11heptan-2-one; (Z)-3-benzylidene-1,7,7-trimethylbicyclo[2.2.11heptan-2-one; 3-(5,5-dimethyl-6-methylenebicyclo[2.2.11heptan-2-yl)cyclohexan-1-ol; 6,10,14-trimethylpentadecan-2-one; 1-(3-ethyl-5,5,8,8-tetramethyl-5,6,7,8-tetrahydronaphthalen-2-yl)ethan-1-one; 2-octyldodecan-1-ol; 2-isopropoxy-1,2-diphenylethan-1-one; 2-methoxy-4-(1,7,7-trimethylbicyclol2.2.11heptan-2-yl)phenol; 2-(2-(3,3,5-trimethylcyclohexyl)acetyl)cyclopentan-1-one; 2-butoxy-1,2-diphenylethan-1-one; (6E,10E)-3,7,11,15-tetramethylhexadeca-6,10,14-trien-3-ol; (6E,10E)-3,7,11,15-tetramethylhexadeca-1,6,10,14-tetraen-3-ol; 2-isobutoxy-1,2-diphenylethan-1-one; (1R)-1,7,7-trimethyl-3-((Z)-4-methylbenzylidene)bicyclo112.2.11heptan-2-one; 1-(4-hydroxy-3-methoxyphenyl)decan-3-one; 3,7,11,15-tetramethylhexadec-1-yn-3-ol; (7R,11R,E)-3,7,11,15-tetramethylhexadec-2-en-1-ol; (3R,5S,8R,9S,10S,13R,14S)-10,13-dimethyl-2,3,4,5,6,7,8,9,10,11,12,13,14,15-tetradecahydro-1H-cyclopentalalphenanthren-3-ol; 1-phenethoxy-2-(p-tolyloxy)ethan-1-ol; (7-isopropyl-1,4a-dimethyltetradecahydrophenanthren-1-yl)methanol; (5S,8R,9S,10S,13R,14S)-10,13-dimethyl-1,2,4,5,6,7,8,9,10,11,12,13,14,15-tetradecahydro-3H-cyclopentalalphenanthren-3-one; (7-isopropyl-1,4a-dimethyl-1,2,3,4,4b,5,6,7,8,8a,9,10-dodecahydro-4a15-phenanthren-1-yl)methanol; 1-(4-(tert-butyl)phenyl)-3-(4-methoxyphenyl)propane-1,3-dione; 2,5,7,8-tetramethyl-2-(4, 8,12-trimethyltridecyl)chroman-6-ol; 2,5,8-trimethyl-2-(4,8,12-trimethyltridecyl)chroman-6-ol; 2,7,8-trimethyl-2-(4,8,12-trimethyltridecyl)chroman-6-ol; 2,8-dimethyl-2-(4,8,12-trimethyltridecyl)chroman-6-ol; (1E,6E)-1,7-bis(4-hydroxy-3-methoxyphenyl)hepta-1,6-diene-3,5-dione; (1R,2R,4aS,8aS)-14(E)-6-((S)-2,2-dimethyl-6-methylenecyclohexyl)-4-methylhex-3-en-1-yl)-2,5,5,8a-tetramethyldecahydronaphthalen-2-ol; (2E,4E,6E,8E,10E,12E,14E,16E)-2,6,11,15-tetramethyl-17-(2,6,6-trimethylcyclohex-1-en-1-yl)heptadeca-2,4,6,8,10,12,14,16-octaenal; 8,8-di(1H-indol-3-yl)-2,6-dimethyloctan-2-ol and mixtures thereof.
K. The silicone compound according to Paragraphs A Through G, wherein said benefit agent moiety is a fragment of a benefit agent selected from the group consisting of 3,7-dimethyloctanal; octanal; tetradecanal; 2,2,6,8-tetramethyl-1,2,3,4,4a,5,8,8a-octahydronaphthalen-1-ol; (4R,4aS,6R)-4,4a-dimethyl-6-(prop-1-en-2-yl)-4,4a,5,6,7,8-hexahydronaphthalen-2(3H)-one; nonan-1-ol; nonanal; (Z)-3,7-dimethylocta-2,6-dien-1-ol; 6,6-dimethylbicyclol3.1.11hept-2-ene-2-carbaldehyde; (E)-4-(2,2,3,6-tetramethylcyclohexyl)but-3-en-2-one; (Z)-1-(2,6,6-trimethylcyclohex-1-en-1-yl)pent-1-en-3-one; (E)-3-methylcyclopentadec-4-en-1-one; 1-(4-isopropylcyclohexyl)ethan-1-ol; 1-(4-isopropylcyclohexyl)ethan-1-ol; 2-methyldecanal; 2-methylundecanal; 6-methoxy-2,6-dimethylheptanal; 7-methoxy-3,7-dimethyloctanal; octahydro-1H-4,7-methanoindene-1-carbaldehyde; ((ls,4s)-4-isopropylcyclohexyl)methanol; 3-(3-(tert-butyl)phenyl)-2-methylpropanal; 2,2-dimethyl-3-(m-tolyl)propan-1-ol; 8-isopropyl-6-methylbicyclol2.2.2loct-5-ene-2-carbaldehyde; 4-(4-hydroxy-4-methylpentyl)cyclohex-3-ene-1-carbaldehyde; (Z)-3-hexen-1-yl-2-cyclopenten-1-one; 3-(4-methylcyclohex-3-en-1-yl)butanal; 3-(4-(tert-butyl)phenyl)-2-methylpropanal; 2-Methyl-5-(1-methylethenyl)-2-cyclohexenone; (1S,5R)-2-methyl-5-(prop-1-en-2-yl)cyclohex-2-en-1-ol; dodecan-1-ol; Dodecanal; ((3S,3aR,6R,8aS)-7,7-dimethyl-8-methyleneoctahydro-1H-3a,6-methanoazulen-3-yl)methanol; (1-methyl-24(1,2,2-trimethylbicyclo[3.1.0]hexan-3-yl)methyl)cyclopropyl)methanol; (Z)-4-(6,6-dimethylcyclohex-2-en- l-yl)-3-methylbut-3-en-2-one; (1R,2S,5R)-5-methyl-2-(prop-1-en-2-yl)cyclohexan-1-ol; 4,9-dimethoxy-7H-furo[3,2-g]chromen-7-one; 2-hexylcyclopent-2-en-1-one; 4-(4-methylpent-3-en-1-yl)cyclohex-3-ene-1-carbaldehyde; 2,5,6-trimethylcyclohex-3-ene-1-carbaldehyde; 4-((2R)-1,7,7-trimethylbicyclo[2.2.1]heptan-2-yl)cyclohexan-1-ol; (7,7,8, 8-tetramethyloctahydro-2,3b-methanocyclopenta[1,3]cyclopropa[1,2]benzen-4-yl)methanol; 2-cyclododecylpropan-1-ol; 3-phenylpropan-1-ol; 2,3-dihydro-3,3-dimethyl-1H-indene-5-propanal; 343,3-dimethyl-2,3-dihydro-1H-inden-5-yl)propanal; (Z)-2-benzylideneoctanal; 3-(benzo[di[1,3]dioxo1-5-yl)-2-methylpropanal; 1-methyl-4-(propan-2-ylidene)cyclohexan-1-ol; (Z)-4-(2,2-dimethyl-6-methylenecyclohexyl)but-3-en-2-one; (Z)-1-(2,2-dimethyl-6-methylenecyclohexyl)but-2-en-1-one; 1-(3,3-dimethylcyclohexyl)pent-4-en-1-one; (6-isopropyl-9-methyl-1,4-dioxaspiro[4.5]decan-2-yl)methanol; 3-(2-ethylphenyl)-2,2-dimethylpropanal; 3-(2-ethylphenyl)-2,2-dimethylpropanal; (E)-4,8-dimethyldeca-4,9-dienal; (2E,6E)-3,7,11-trimethyldodeca-2,6,10-trien-1-ol; (E)-cyclopentadec-4-en-1-one; 1-cyclopentadec-4-en-1-one; 2-methoxy-4-(4-methylenetetrahydro-2H-pyran-2-yl)phenol; 4-allyl-2-methoxyphenol; (2R,3S,4R)-2,3,4,5-tetrahydroxypentanal; (E)-4-((3aS,7aS)-octahydro-5H-4,7-methanoinden-5-ylidene)butanal; 2-(2-hydroxypropoxy)propan-1-ol; 2,6-dimethyloct-7-en-4-one; 3-methyl-2-pentylcyclopent-2-en-1-one; 2-methoxy-4-propylphenol; 2-methyl-5-(prop-1-en-2-yl)cyclohexan-1-ol; (Z)-1-((1R,2S)-2,6,6-trimethylcyclohex-3-en-1-yl)but-2-en-1-one; dec-9-en-1-ol; 3-(4-isopropylphenyl)-2-methylpropanal; 8,8-dimethyl-1,2,3,4,5,6,7,8-octahydronaphthalene-2-carbaldehyde; (4-isopropylphenyl)methanol; 3-(4-methylcyclohex-3-en-1-yl)butan-1-ol; 3,7-dimethyloct-6-en-1-ol; 3,7-dimethyloct-6-enal; (Z)-3-methyl-2-(pent-2-en-1-yl)cyclopent-2-en-1-one; (Z)-non-6-en-1-ol; (1R,5R)-2-methyl-5-(prop-1-en-2-yl)cyclohex-2-en-1-ol; (Z)-dec-4-enal; (3Z,6Z)-nona-3,6-dien-1-ol; (E)-3-phenylprop-2-en-1-ol; 4-chloro-3,5-dimethylphenol; hexadecan-1-ol; (E)-1-(2,6,6-trimethylcyclohex-2-en-1-yl)hepta-1,6-dien-3-one; 2-methyl-4-(2,6, 6-trimethylcyclohex-1-en-1-yl)butanal; 1,1,2,3,3-pentamethyl-1,2,3,5,6,7-hexahydro-4H-inden-4-one; (1S,2S,5R,8S)-4,4,8-trimethyltricyclo[6.3.1.02,5]dodecan-1-ol; 5-isopropyl-2-methylphenol; 2-methyl-5-(prop-1-en-2-yl)cyclohex-2-en-1-one; octan-1-ol; Decanal; 3-(4-methoxyphenyl)-2-methylpropanal; 2,6-di-tert-butyl-4-methylphenol; 2-methyl-4-(2,2,3-trimethylcyclopent-3-en-1-yl)butan-1-ol; 3-(4-(tert-butyl)phenyl)propanal; (E)-2-methyl-4-(2,6,6-trimethylcyclohex-1-en-1-yl)but-2-enal; (5R,10R)-6,10-dimethyl-2-(propan-2-ylidene)spiro[4.5]dec-6-en-8-one; 1-methyl-4-(prop-1-en-2-yl)cyclohexan-1-ol; (2Z,6E)-2,6-dimethyl-10-methylenedodeca-2,6,11-trienal; (Z)-2-methyl-5-((1S,2R,4R)-2-methyl-3-methylenebicyclo[2.2.1]heptan-2-yl)pent-2-en-1-ol; (S)-4-methyl-1-((S)-6-methylhept-5-en-2-yl)cyclohex-3-en-1-ol; (Z)-4-(2,2,6-trimethyl-7-oxabicyclo[4.1.0]heptan-1-yl)but-3-en-2-one; 4-methoxy-7H-furo[3,2-glchromen-7-one; (4R,4aS)-4,4a-dimethyl-6-(propan-2-ylidene)-4,4a,5,6,7,8-hexahydronaphthalen-2(3H)-one; (2Z,6E,9E)-2,6,10-trimethyldodeca-2,6,9,11-tetraenal; (E)-5-(2,3-dimethyltricyclo[2.2.1.02,6]heptan-3-yl)-2-methylpent-2-en-1-ol; 1-(5,5-dimethylcyclohex-1-en-1-yl)pent-4-en-1-one; (R,Z)-1-(2,6,6-trimethylcyclohex-2-en-1-yl)pent-1-en-3-one; (Z)-3-methyl-4-(2,6,6-trimethylcyclohex-2-en-1-yl)but-3-en-2-one; (Z)-4-(2,5,6,6-tetramethylcyclohex-2-en-1-yl)but-3-en-2-one; (1R,4S,4aR,8aR)-4-isopropyl-1,6-dimethyl-1,2,3,4,4a,7,8,8a-octahydronaphthalen-1-ol; (E)-2-benzylideneheptan-1-ol; (E)-2-benzylideneheptanal; 1-methyl-4-(4-methylpent-3-en-1-yl)cyclohex-3-ene-1-carbaldehyde; 2,3,4-trimethoxybenzaldehyde; 2,4,5-trimethoxybenzaldehyde; 2,4,6-trimethoxybenzaldehyde; Trans,Trans-2,4-Nonadienal; 2,6,10-trimethylundecanal; alpha-4-Dimethyl benzenepropanal; (E)-undec-9-enal; 2,6,10-trimethylundec-9-enal; (Z)-2-(4-methylbenzylidene)heptanal; dec-9-enal; 7-methoxy-2H-chromen-2-one; 1-(3,5,5,6,8,8-hexamethyl-5,6,7,8-tetrahydronaphthalen-2-yl)ethan-1-one; 3-(6,6-dimethylbicyclo[3.1.1]hept-2-en-2-yl)propanal; 1-isopropyl-4-methylcyclohex-3-en-1-ol; 1-phenylpent-4-en-1-one; 1-isopropyl-4-methylcyclohex-3-en-1-ol; (1aR,2S,4aS)-2,4a,8,8-tetramethyloctahydrocyclopropa[d]naphthalen-3(1H)-one; (Z)-dodec-2-enal; 3-methyl-5-phenylpentanal; 3,7-dimethyl-2-methyleneoct-6-enal; 3,7-dimethyloctan-1-ol; 3,4,5-trimethoxybenzaldehyde; 3-(4-isopropylphenyl)propanal; (E)-undec-2-enal; (2E,6E)-nona-2,6-dienal; (Z)-3-(furan-2-yl)-2-phenylacrylaldehyde; 2-phenoxyethan-1-ol; (Z)-non-2-enal; (E)-2-isopropyl-5-methylhex-2-enal; (E)-dec-2-enal; (2E,6E)-nona-2,6-dienal; (2E,6E)-nona-2,6-dien-1-ol; 2,6-dimethyloctanal; decan-1-ol; undec-10-en-1-ol; undec-10-enal; (Z)-1-(2,6,6-trimethylcyclohex-2-en-1-yl)but-2-en-1-one; (1S,5S)-4,6,6-trimethylbicyclo[3.1.1]hept-3-en-2-one; (Z)-dodec-3-enal; 3,7-dimethyloct-6-enal; (R)-3,7-dimethyloct-6-enal; (1S,2S,5S)-2-methyl-5-(prop-1-en-2-yl)cyclohexan-1-ol; 3,7-dimethyloct-6-en-1-ol; 3,7-dimethyloct-6-en-1-ol; (S)-2-methyl-5-(prop-1-en-2-yl)cyclohex-2-en-1-one; (R,E)-2-methyl-4-(2,2,3-trimethylcyclopent-3-en-1-yl)but-2-en-1-ol; (E)-4-(2,2-dimethyl-6-methylenecyclohexyl)-3-methylbut-3-en-2-one; 3-(3-isopropylphenyl)butanal; 3-(6,6-dimethylbicyclo[3.1.1]hept-2-en-2-yl)-2,2-dimethylpropanal; 2-(m-tolyl)ethan-1-ol; (3E,6E)-nona-3,6-dien-1-ol; (E)-tridec-2-enal; (1R,4S,4aS,6R,8aS)-4,8a,9,9-tetramethyloctahydro-1,6-methanonaphthalen-1(2H)-ol; 4-(prop-1-en-2-yl)cyclohex-1-ene-1-carbaldehyde; (4-(prop-1-en-2-yl)cyclohex-1-en-1-yl)methanol; 2-cyclohexylhepta-1,6-dien-3-one; 2-phenylethan-1-ol; 3-methyl-5-phenylpentan-1-ol; dimethylbicyclo[3.1.1]hept-2-en-2-yl)acetaldehyde; (4aR,8aS)-7-methyloctahydro-1,4-methanonaphthalen-6(2H)-one; 1,2-dimethyl-3-(prop-1-en-2-yl)cyclopentan-1-ol; 4-isopropyl-1-methylcyclohex-3-en-1-ol; (2Z,5Z)-5,6,7-trimethylocta-2,5-dien-4-one; 1-methyl-4-(4-methylpent-3-en-1-yl)cyclohex-3-ene-1-carbaldehyde; propane-1,2-diol; 4-(tert-pentyl)cyclohexan-1-ol; 3,7-dimethyloct-7-en-1-ol; 2-methyl-5-phenylpentan-1-ol; (Z)-2-ethyl-4-(2,2,3-trimethylcyclopent-3-en-1-yl)but-2-en-1-ol; (E)-2-methyl-4-(2,2,3-trimethylcyclopent-3-en-1-yl)but-2-en-1-ol; 5-methoxyoctahydro-1H-4,7-methanoindene-2-carbaldehyde; 5-methoxyoctahydro-1H-4,7-methanoindene-2-carbaldehyde; 3-(4-isobutylphenyl)-2-methylpropanal; 1-(spiro[4.5]dec-7-en-7-yl)pent-4-en-1-one; 2-(4-methylthiazol-5-yl)ethan-1-ol; (Z)-dodec-4-enal; (1S,4S,4aR,8aR)-4-isopropyl-1,6-dimethyl-1,2,3,4,4a,7,8,8a-octahydronaphthalen-1-ol; (1S,4S,4aR,8aS)-4-isopropyl-1,6-dimethyl-1,2,3,4,4a,7,8,8a-octahydronaphthalen-1-ol; 3,7-dimethyloctanal; 2-isopropyl-5-methylphenol; (2Z,4E)-nona-2,4-dienal; (2E,6E)-3,7,11-trimethyldodeca-2,6,10-trien-1-ol; (2E,6Z)-nona-2,6-dienal; (Z)-dec-2-enal; (E)-non-2-enal; (1R,2S)-2-(tert-butyl)cyclohexan-1-ol; (3E,6Z)-nona-3,6-dien-1-ol; (E)-dec-4-enal; (Z)-1-(2,6,6-trimethylcyclohex-2-en-1-yl)but-2-en-1-one; (E)-3,7-dimethylocta-2,6-dien-1-ol; (1R-(lalpha,3alpha,4aalpha))-2,3,4,4a,5,6-hexahydro-2,2-dimethyl-1,3-methanonaphthalen-7(1H)-one; tridecan-1-ol; 1-((2E,5Z,9Z)-2,6,10-trimethylcyclododeca-2,5,9-trien-1-yl)ethan-1-one; 2-mercapto-2-methylpentan-1-ol; undecanal; (Z)-2-methyl-4-(2,6,6-trimethylcyclohex-2-en-1-yl)but-2-enal; (1R,5R)-4,6,6-trimethylbicyclo[3.1.1]hept-3-en-2-one; 2-(tert-butyl)cyclohexan-1-ol; 1,3,4,6,7,8alpha-hexahydro-1,1,5,5-tetramethyl-2H-2,4alpha-methanophtalen-8(5H)-one; 3-(3,3-dimethyl-2,3-dihydro-1H-inden-5-yl)propanal; 2,2′-oxybis(ethan-1-ol); butane-1,3-diol; hexane-1,6-diol; 2,2′-(ethane-1,2-diylbis(oxy))bis(ethan-1-ol); 2-methylpentane-2,4-diol; (2E,4E)-hepta-2,4-dien-1-ol; hexane-1,2,6-triol; (Z)-oct-5-en-1-ol; (E)-oct-3-en-1-ol; (Z)-oct-5-enal; 2,5-dimethyl-1,4-dithiane-2,5-diol; (E)-non-2-en-1-ol; (E)-non-6-en-1-ol; (E)-non-3-en-1-ol; (Z)-non-3-en-1-ol; (2E,6Z)-nona-2,6-dien-1-ol; Mannitol; 2,2′, 2″-nitrilotris(ethan-1-ol); 3-Nonen-2-one; (E)-non-5-en-2-one; 2-(cyclohexyloxy)ethan-1-ol; (E)-dec-2-en-1-ol; a-D-Glucopyranose; (E)-dec-5-en-1-ol; 2,3,6-trimethylphenol; (2E,4E)-deca-2,4-dienal; (2E,4Z)-deca-2,4-dienal; decane-1,10-diol; (Z)-dec-7-enal; (E)-2-methyloct-2-enal; 3-(hydroxymethyl)phenol; (2-methoxyphenyl)methanol; decan-2-one; 2-(o-tolyl)ethan-1-ol; undecan-1-ol; (E)-dec-3-en-2-one; 3-ethyl-2-hydroxy-4-methylcyclopent-2-en-1-one; 3-phenylpropan-1-ol; 3,5-Octadien-2-ol, 2,6-dimethyl-, (?,Z)—; 3,5-Octadien-2-ol, 2,6-dimethyl-, (?,E)-; Benzenemethanol, 4-methyl-; 2-(benzyloxy)ethan-1-ol; (E)-undec-2-en-1-ol; (2Z,4E)-undeca-2,4-dien-1-ol; (E)-7-methyl-3-methyleneocta-4,6-dien-2-ol; (Z)-undec-2-enal; (E)-undec-2-enal; (2Z,4Z)-undeca-2,4-dienal; (2E,4E)-undeca-2,4-dienal; 3-Cyclohexene-1-propanal; (E)-undec-8-enal; 1-(p-tolyl)ethan-1-ol; (E)-3,7-dimethylocta-2,6-dien-1-ol; 4-(2-hydroxyethyl)phenol; (4-methoxyphenyl)methanol; 2-methoxy-2-phenylethan-1-ol; (E)-2-isopropyl-5-methylhex-2-en-1-ol; 4-phenylbutan-1-ol; 2-(p-tolyl)ethan-1-ol; (E)-dodec-2-en-1-ol; 2-(p-tolyloxy)ethan-1-ol; 7-methyl-3-methyleneoct-6-enal; (2E,4E)-dodeca-2,4-dien-1-ol; (E)-dodec-2-enal; (2E,4E)-dodeca-2,4-dienal; (E)-5-(methylthio)-2-((methylthio)methyl)pent-2-enal; (E)-dodec -3-enal; 4-(hydroxymethyl)-2-methoxyphenol; undec an-1-ol; (E)-dodec-4-enal; 4-allylphenol; (2E,6Z)-dodeca-2,6-dienal; 3-(5-methylfuran-2-yl)butanal; 2-pentylc yclopent-2-en-1-one; 2-isopropyl-4-methylphenol; 3,7-dimethyloct-7-ene-1,6-diol; benzo[d][1,3]dioxo1-5-ylmethanol; (Z)-2,7-dimethyloc t-5-en-4-one; undec -1-en-3-one; 2,6-dimethoxy-4-methylphenol; (1S,2 S,5 S)-2-methyl-5-(prop-1-en-2-yl)cyclohexan-1-ol; 5-phenylpentan-1-ol; rel-(1R,2 S,5R)-5-methyl-2-(prop-1-en-2-yl)cyclohexan-1-ol; (E)-2-methyl-3-phenylprop-2-en-1-ol; (E)-tridec -2-en-1-ol; ((1S,2S,5S)-6,6-dimethylbicyclo[3.1.1]heptan-2-yl)methanol; tridecanal; 2-methylundecan-1-ol; 2-(3,4-dimethylphenyl)acetaldehyde; 2-(2,4-dimethylphenyl)acetaldehyde; 1,3-dihydro-2H-inden-2-one; (2E,4E)-trideca-2,4-dienal; (6,6-dimethylbicyclo[3.1.1]hept-2-en-2-yl)methanol; 3-(p-tolyl)propanal; (E)-2-(hex-2-en-1-yl)cyclopentan-1-ol; 2-(2-hydroxypropan-2-yl)-5-methylcyclohexan-1-ol; 11-methyldodecan-1-ol; (2E,4Z,7Z)-trideca-2,4,7-trienal; cyclododecanol; 2-(4-methylcyclohex-3-en-1-yl)prop-2-en-1-ol; (R)-2-(4-methylcyclohex-3-en-1-yl)prop-2-en-1-ol; (E)-2-methyl-3-(pent-2-en-1-yl)cyclopent-2-en-1-one; (E)-3-methyl-2-(pent-2-en-1-yl)cyclopent-2-en-1-one; (2E,6E)-3,7-dimethylnona-2,6-dienal; 2,6-diisopropylphenol; 1-(3,3-dimethylbicyclo[2.2.1]heptan-2-yl)ethan-1-ol; 2-(4-methylenecyclohexyl)propanal; (S)-4-(prop-1-en-2-yl)cyclohex-1-ene-1-carbaldehyde; (E)-3-(4-methoxyphenyl)acrylaldehyde; tetradecan-1-ol; 6-phenylhexan-1-ol; 2-(4-isopropylcyclohexyl)ethan-1-ol; (E)-2-ethyl-2-(3-methylbut-2-en-1-yl)hex-3-en-1-ol; 2-(4-ethylphenyl) acetaldehyde; (E)-3-methyl-1-phenylpent-1-en-3-ol; (2-hexyl-1,3-dioxolan-4-yl)methanol; 6-ethyl-3-methyloct-5-en-1-ol; octahydronaphthalen-2(1H)-one; 2-(4-isopropylphenyeethan-1-ol; (E)-5,9-dimethyldeca-4,9-dienal; 5-methyl-3,4-dihydronaphthalen-1 (2H)-one; 8-methyl-3,4-dihydronaphthalen-1(2H)-one; (E)-tetradec-2-enal; 4-(tert-butyl)cyclohexane-1-carbaldehyde; dimethylbicyclo[3.1.1]hept-2-en-2-yl)ethan-1-ol; (4,7,7-trimethylbicyclo[4.1.0]hept-4-en-3-yl)methanol; (Z)-2-(3,3-dimethylbicyclo[2.2.1]heptan-2-ylidene)ethan-1-ol; (3 aR,7 aR)-octahydro-5H-4,7-methanoinden-5-one; 4-(3-hydroxybutyl)phenol; 2,5,7,7-tetramethyloctanal; 2-phenylpent-4-enal; 4-hydroxy-3,5-dimethoxybenzaldehyde; (E)-4-(3-hydroxyprop-1-en-1-yl)-2-methoxyphenol; 2-methyl-4-phenylbutanal; 2-pentylcyclohex-2-en-1-one; 4-ethyl-2,6-dimethoxyphenol; 2-((1,7,7-trimethylbicyclo[2.2.1]heptan-2-yeoxy)ethan-1-ol; pentadecan-1-ol; (2-phenyl-1,3-dioxolan-4-yl)methanol; 1-allyl-2,2,7,7-tetramethylcycloheptan-1-ol; -ethyl-2-methylnonan-1-ol; 3-(but-3-en-1-yl)-2,4,4-trimethylcyclohex-2-en-1-one; 2-(4-isopropylcyclohexyl)propan-1-ol; pentadecanal; (Z)-2-ethylideneundecanal; (E)-1-(2,6,6-trimethylcyclohex-3-en-1-yl)but-2-en-1-one; 3,5-diethyl-2,6-dimethylcyclohex-2-en-1-one; (Z)-4-(4-methylcyclohex-3-en-1-ylidene)pentanal; 6-methyl-3,4-dihydronaphthalen-1(2H)-one; 7-methyl-3,4-dihydronaphthalen-1(2H)-one; 5-ethyl-2-methylnonanal; (3E,5E)-6,10-dimethylundeca-3,5,9-trien-2-one;[1,1′-bi(cyclohexan)]-1′-en-2-one; (E)-4-(2,3,6-trimethylphenyl)but-3-en-2-one; 2-(4-isopropylphenyl)propanal; (E)-6,10-dimethylundeca-3,9-dien-2-one; 3-propylbicyclo[2.2.1]hept-5-ene-2-carbaldehyde; (E)-2,6-dimethoxy-4-(prop-1-en-1-yl)phenol; 4,4 a,6,7,8,8a-hexahydro-1,4-methanonaphthalen-5(1H)-one; 4-allyl-2,6-dimethoxyphenol; (2,8,8-trimethyl-1,2,3,4,5,6,7,8-octahydronaphthalen-2-yl)methanol; (E)-3-(4-methoxyphenyl)-2-methylacrylaldehyde; (2E,6E)-3,7,9-trimethyldeca-2,6-dienal; (5,6-dimethyl-1-(prop-1-en-2-yl)bicyclo[2.2.1]hept-5-en-2-yemethanol; 2-(4-(tert-butyl)-2-methylphenoxy)acetaldehyde; (E)-4-(4-hydroxy-3-methoxyphenyl)but-3-en-2-one; (E)-4-(3-hydroxyprop-1-en-1-yl)-2,6-dimethoxyphenol; 14-methylpentadecan-1-ol; (E)-3-(4-hydroxy-3,5-dimethoxyphenyl)acrylaldehyde; (3E,5E)-3,6,10-trimethylundeca-3,5,9-trien-2-one; (E)-2,5,9-trimethyldeca-4,9-dienal; (E)-4-(benzo[di[1,3]dioxo1-5-yl)but-3-en-2-one; 446,6-dimethylbicyclo[3.1.1]hept-2-en-2-yl)butanal; 2,8,8-trimethyloctahydro-2H-4a,2-(epoxymethano)naphthalen-10-one; (E)-3,6,10-trimethylundeca-3,9-dien-2-one; heptadecan-1-ol; (E)-3-methyl-5-(2,2,3-trimethylcyclopent-3-en-1-yl)pent-3-en-2-one; (E)-2-methyl-4-(2,6,6-trimethylcyclohex-2-en-1-yl)but-3-enal; (E)-2,6,10-trimethylundeca-5,9-dien-1-ol; 1-methyl-4-(4-methylpentyl)cyclohex-3-ene-1-carbaldehyde; (E)-3-(benzo[di[1,3]dioxo1-5-yl)-2-methylacrylaldehyde; (R,E)-1-(2,6,6-trimethylcyclohex-2-en-1-yl)pent-1-en-3-one; (E)-2,6,10-trimethylundeca-5,9-dienal; 2,6-di-tert-butyl-4-(hydroxymethyl)phenol; (Z)-2-benzylidenehexanal; (4E,6E)-7,11-dimethyldodeca-4,6,10-trien-3-one; 2,5-di-tert-butylbenzene-1,4-diol; 2-methoxy-4-(4-methyl-1,3-dioxolan-2-yl)phenol; (Z)-2-(furan-2-ylmethylene)octanal; (E)-1-(4-methoxyphenyl)pent-1-en-3-one; 3-(4-isopropylphenyl)-2-methylpropan-1-ol; octadecan-1-ol; 3-(4-hydroxy-4-methylpentyl)cyclohex-3-ene-1-carbaldehyde; (E)-1-(4-methoxyphenyl)-4-methylpent-1-en-3-one; (2R,4aR,8aS)-1,1,5,5-tetramethylhexahydro-2H-2,4 a-methanonaphthalen-8(5H)-one; (E)-2,3-dimethyl-4-(2,6,6-trimethylcyclohex-2-en-1-yl)but-3-enal; (2E,6E)-3,7,11-trimethyldodeca-2,6,10-trienal; (Z)-octadec-9-en-1-ol; 2-methyl-34(1,7,7-trimethylbicyclo[2.2.1]heptan-2-yl)oxy)propan-1-ol; (E)-2-methyl-1-(2,6,6-trimethylcyclohex-2-en-1-yl)pent-1-en-3-one; 3-(4-(tert-butyl)phenyl)-2-methylpropan-1-ol; (Z)-2-methyl-1-(2,2,6-trimethylcyclohex-3-en-1-yl)pent-1-en-3-one; 3-((2-isopropyl-5-methylcyclohexyl)oxy)propane-1,2-diol; (Z)-2-benzylideneheptanal; (E)-2-((1S,3aR,4S,8aS)-4,8,8-trimethyldecahydro-1,4-methanoazulen-9-ylidene)ethan-1-ol; 6-isopropyloctahydronaphthalen-2(1H)-one; 2-ethoxy-4-(4-methyl-1,3-dioxolan-2-yl)phenol; ((2S,4aR)-1,1,5,5-tetramethyl-1,3,4,5,6,7-hexahydro-2H-2,4a-methanonaphthalen-8-yl)methanol; (octahydro-1H-4,7-methanoindene-2,5-diyl)dimethanol; (E)-1-(3,5,6-trimethylcyclohex-3-en-1-yl)pent-1-en-3-one; (E)-1-(2,4,6-trimethylcyclohex-3-en-1-yl)pent-1-en-3-one; (2E,6E,9E)-2,6,10-trimethyldodeca-2,6,9,11-tetraenal; (E)-chalcone; (E)-5-methyl-1-(2,6,6-trimethylcyclohex-2-en-1-yl)hex-1-en-3-one;,5,7,8,8-pentamethyl-5,6,7,8-tetrahydronaphthalene-2-c arbaldehyde; (4R,4aS,6R,8aS)-4,4a-dimethyl-6-(prop-1-en-2-yl)octahydronaphthalen-2(1H)-one; 2-(1,1,2,3,3-pentamethyl-2,3-dihydro-1H-inden-5-yeprop an-1-ol; 4-(5,5,6-trimethylbicyclo[2.2.1]heptan-2-yl)cyclohexan-1-ol; 34(2R)-5,5,6-trimethylbicyclo[2.2.1]heptan-2-yl)cyclohexan-1-ol; 3-ethyl-5,5,8,8-tetramethyl-5,6,7,8-tetrahydronaphthalene-2-carbaldehyde; 3-(5,5-dimethyl-6-methylenebicyclo[2.2.1]heptan-2-yl)cyclohexan-1-ol; 2-octyldodecan-1-ol; 2-methoxy-4-(1,7,7-trimethylbicyclo[2.2.1]heptan-2-yl)phenol; (7R,11R,E)-3,7,11,15-tetramethylhexadec-2-en-1-ol; 1-phenethoxy-2-(p-tolyloxy)ethan-1-ol; (7-isopropyl-1,4 a-dimethyltetradec ahydrophenanthren-1-yl)methanol; (7-isopropyl-1,4 a-dimethyl-1,2,3,4,4b,5,6,7, 8,8 a,9,10-dodec ahydro-4a15-phenanthren-1-yl)methanol; (1E,6E)-1,7-bis(4-hydroxy-3-methoxyphenyl)hepta-1,6-diene-3,5-dione; (2E,4E,6E,8E,10E,12E,14E,16E)-2,6,11,15-tetramethyl-17-(2,6,6-trimethylcyclohex-1-en-1-yl)heptadeca-2,4,6,8,10,12,14,16-octaenal and mixtures thereof.
L. The silicone compound according to Paragraph A wherein said silicone moiety is derived from a silicone having the formula:

[R₁R₂R₃SiO_{1/2}]₍ⱼ₊₂₁₊₂₎[R₄R₅SiO_{2/2}]ₘ[R₆SiO_{3/2}]ⱼ[SiO_{4/2}]ₗ
wherein:
   a) j is an integer from 0 to 150, preferably from 0 to 50, more preferably from 0 to 20;
   b) m is an integer from 0 to 1500, preferably 1 to 1500, more preferably from 20 to 1000, most preferably from 20 to 400;
   c) 1 is an integer from 0 to 150, preferably from 0 to 150, more preferably from 0 to 50, most preferably from 0 to 20; with the provisio j+m+l equals an integer greater than or equal to 1;
   d) each of R₁, R₂, R₃, R₄, R₅ and R₆ moiety is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy,and —Xₜ-A-Y, wherein index t is 0 or 1, with the provisio that at least one of the moieties R₁ through R₆=—Xt-A-Y;
      (i) each X moiety is independently, a substituted or unsubstituted divalent alkylene radical comprising comprising 1-24 carbon atoms, preferably 1-16 carbon atoms, more preferably 1-12 carbon atoms, most preferably 2-12 carbon atoms;
      (ii) each A moiety is independently selected from the group consisting of

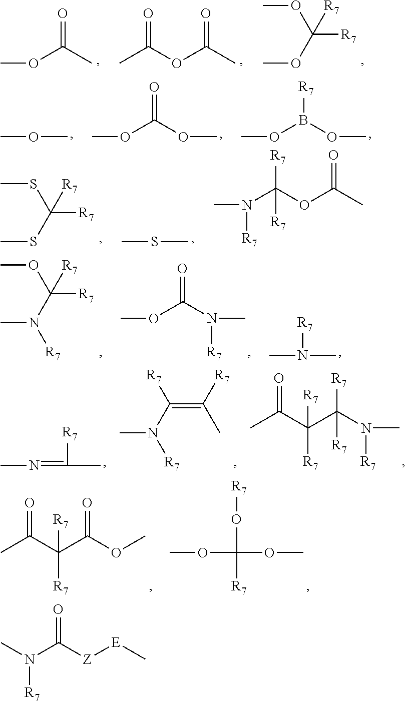

E=electron withdrawing group, preferably E is selected from the group consisting of
   O, S, an aryl moiety and an alkene moiety,

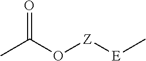

E=electron withdrawing group, preferably E is selected from the group consisting of O, S, a halide, an aryl moiety and an alkene moiety;

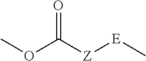

E=electron withdrawing group, preferably E is selected from the group consisting of O, S, an aryl moiety and an alkene moiety;

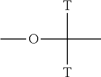

wherein each T is selected from an electron withdrawing group E or R₇, with the proviso that at least one T is E; preferably E is selected from the group consisting of O, S, an aryl moiety and an alkene moiety; each R₇ moiety for each A moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl;
and
each Z for each A moiety is independently selected from the group consisting of:

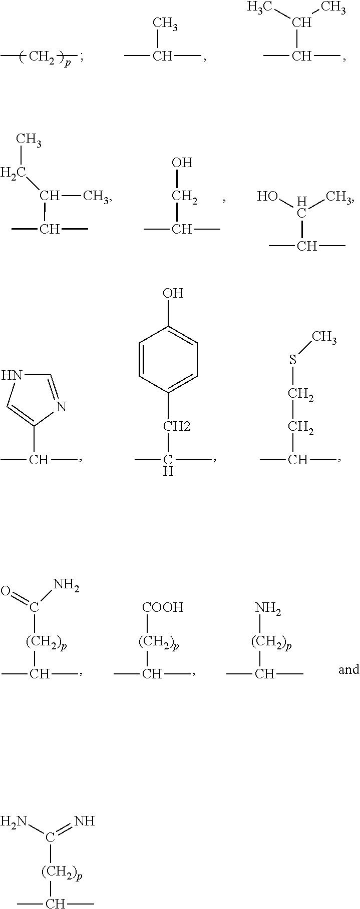

where p is an integer from 1-32, preferably p is an integer form 1-10, more preferably p is an integer from 2 to 8, most preferably p in an integer from 2 to 4;
(ii) each Y moiety is independently selected from the group consisting of a C₁-C₃₂ alkyl, a C₅-C₃₂ aryl, and a C₆-C₃₂ alkylaryl comprising at least one substituent selected from the group consisting of an ether moiety, an alkene moiety, an alkyne moiety, an aldehyde moiety, a ketone moiety, an ester moiety, a carbonate moiety, an amide moiety, a nitrile moiety, a peroxide moiety, an acetal moiety, a hemiacetal moiety, a hemiketal moiety, a ketal moiety, an orthoester moiety, orthocarbonate ester, an imine moiety, an imide moiety, an azide moiety, an azo moiety, a cyanate moiety, a nitrate moiety, a nitrite moiety, a nitro moiety, a nitroso moiety, an oxime, a sulfide moiety, a disulfide moiety, a sulfoxide moiety, a sulfone moiety, a sulfinic acid moiety, a sulfonic acid moiety, a thiocyanate moiety, a thione moiety, a thial moiety, a phosphine moiety, a phosphonic acid moiety, a phosphate moiety, a phosphodiester moiety, a boronic acid moiety, a boronic ester moiety, a borinic acid moiety, a borinic ester moiety, an amino moiety, an epoxy moiety, an alkoxy moiety, a hydroxy moiety, a thiol moiety, a halide moiety, an oxyalkylene moiety, an anhydride moiety, a carboxy moiety, a silane moiety, a siloxane moiety and a quaternary ammonium moiety; preferably said at least one substituent is selected from the group consisting of an amino moiety, an epoxy moiety, an alkoxy moiety, a hydroxy moiety, a thiol moiety, a halide moiety, an oxyalkylene moiety, an anhydride moiety, a carboxy moiety and a quaternary ammonium moiety; more preferably said at least one substituent is selected from the group consisting of an amino moiety, a hydroxy moiety, a thiol moiety, a carboxy moiety and a quaternary ammonium moiety.
M. A silicone compound according to Paragraph I wherein each A moiety of said silicone from which said silicone moiety is derived is independently selected from the group consisting of:

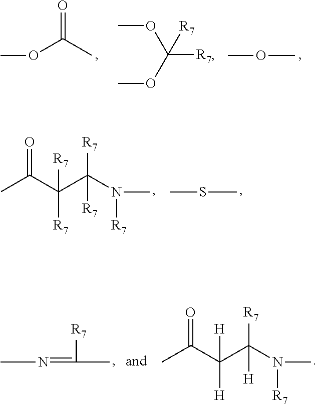

N. A silicone compound according to Paragraph I wherein each Y moiety of said silicone from which said silicone moiety is derived is independently selected from the group consisting of

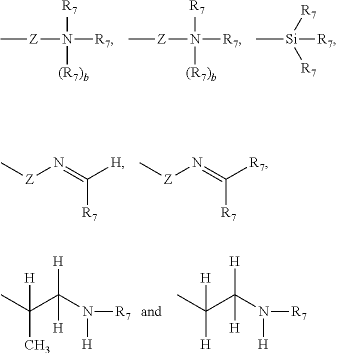

wherein b is 0 or 1 with the proviso that when b=1, the positive charge on the nitrogen is balanced by a suitable anion, preferably said anion is selected from the group consisting of methyl sulfate, chloride and bromide and each Z for each A moiety is independently selected from the group consisting of:

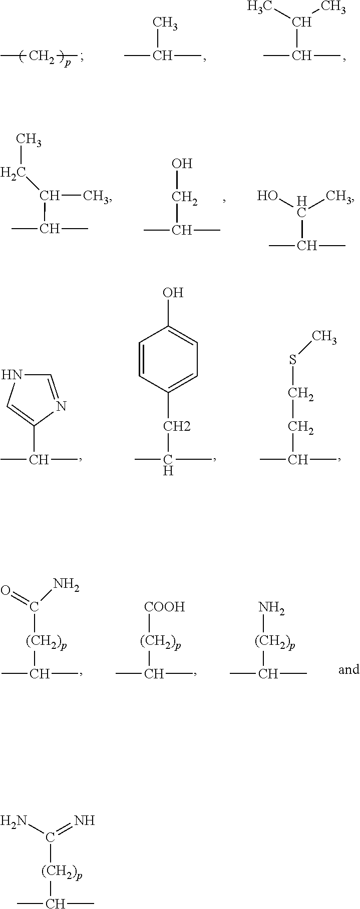

where p is an integer from 1-32, preferably p is an integer form 1-10, more preferably p is an integer from 2 to 8, most preferably p in an integer from 2 to 4.
O. A silicone compound according to Paragraph I wherein each A-Y moiety said silicone from which said silicone moiety is independently selected from the group consisting of:

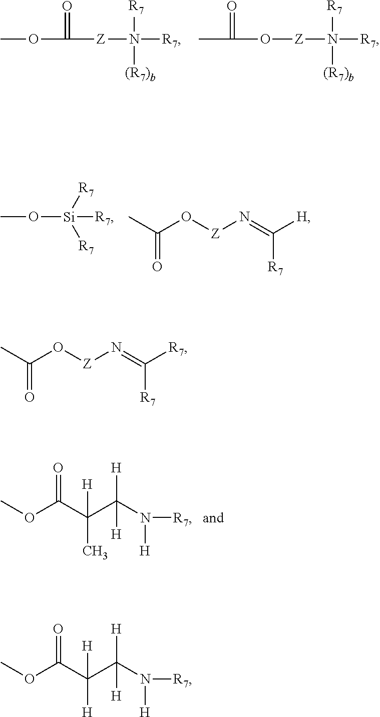

wherein b is 0 or 1, with the proviso that if b=1 then, the positive charge on the nitrogen is balanced by a suitable anion, preferably said anion is selected from the group consisting of methyl sulfate, chloride and bromide and each Z for each A moiety is independently selected from the group consisting of:

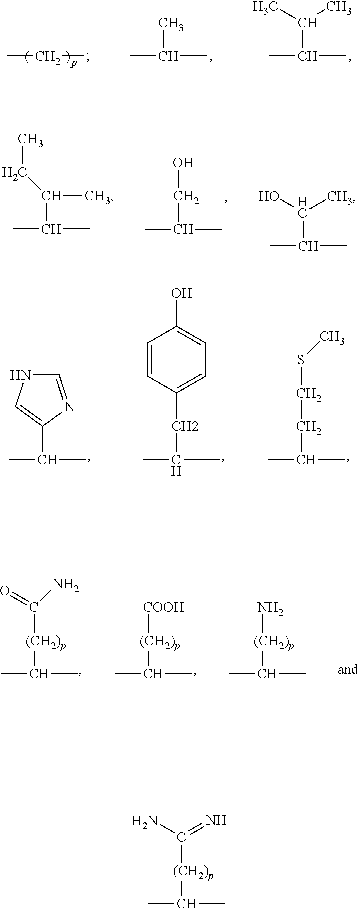

where p is an integer from 1-32, preferably p is an integer form 1-10, more preferably p is an integer from 2 to 8, most preferably p in an integer from 2 to 4.
P. A consumer product composition comprising:
   a.) from 0.0001% to 10%, preferably from 0.0002% to 1%, more preferably from 0.005% to 0.5%, most preferably from 0.001% to 0.05% of a silicone compound according to Paragraphs A through O; and
   b.) a consumer product ingredient.
Q. A consumer product according to Paragraph P, said consumer product being a cleaning and/or treatment composition, preferably, said consumer product is a bead or unit dose product.

Preferably, said bead is a solid particle comprising a polymeric material. Examples of such polymeric materials include polyethylene glycol, starches and polysaccharides, polyvinyl alcohol, celluloses. Such particles may additionally comprise additional components such as other benefit agents, inorganic fillers such as carbonate, silicate, clay, metal oxides. Particularly useful particles include particles based on polyethylene glycol.
R. A cleaning and/or treatment composition according to Paragraph Q comprising a consumer product ingredient selected from the group consisting of surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume, an additional perfume delivery system, structure elasticizing agents, thickeners/structurants, fabric softeners, carriers, hydrotropes, oligoamines, processing aids, hueing agents, pigments and mixtures thereof.
S. A consumer product comprising a silicone compound according to Paragraphs A through O and packaging, preferably said packaging comprises a silicone compound according to Paragraphs A through L that is attached or adhered to said packaging. Such packing may take any form including wrapping, or a container. Silicone compounds according to Paragraphs A through O may be adhered or attached to the exterior and/or the interior surface of such packaging. Said packaging may comprise a container comprising a cap and said silicone compounds according to Paragraphs A through O may be adhered or attached to the exterior or interior surface of said cap.
T. A display comprising a silicone compound according to Paragraphs A through O and a display material, said silicone compound being attached or adhered to said display material.

The consumer products of the present invention can be formulated into any suitable form and prepared by any process chosen by the formulator, non-limiting examples of which are described in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use and Treated Situs

Compositions containing the silicone compound disclosed herein can be used to clean or treat a situs inter alia a surface or fabric. Typically at least a portion of the situs is contacted with an embodiment of Applicants' composition, in neat form or diluted in a liquor, for example, a wash liquor and then the situs may be optionally washed and/or rinsed. In one aspect, a situs is optionally washed and/or rinsed, contacted with a particle according to the present invention or composition comprising said particle and then optionally washed and/or rinsed. For purposes of the present invention, washing includes but is not limited to, scrubbing, and mechanical agitation. The fabric may comprise most any fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

A method of treating and/or cleaning a situs, said method comprising
a.) optionally washing and/or rinsing said situs;
b.) contacting said situs with a silicone compound according to Paragraphs A through O and/or a consumer product according to Paragraphs P through R; and
c.) optionally washing and/or rinsing said situs.

The aforementioned drying may be passive drying such as line drying and/or active drying such as with a dryer.

A situs treated with a silicone compound according to Paragraphs A through O and/or a consumer product according to Paragraphs P through R.

The benefit agents and perfumes raw materials in this specification can be obtained from suppliers including: International Flavors and Fragrances of New York, NY USA; Givaudan of Vernier Switzerland; Firmenich of Geneva, Switzerland; Symrise of Holzminden, Germany; Kao of Tokyo, Japan; Takasago of Tokyo, Japan; and Florasynth of Tel-Aviv, Israel.

### Process of Making Benefit Agent Delivery Compositions

The silicone compounds disclosed in the present application may be made via the teachings and examples disclosed herein.

Suitable forms for the silicone compounds include, solids and fluids including agglomerates, emulsions, solutions, prills, beads and encapsulates.

In one aspect, the silicone compound is pre-made and added to a consumer product or intermediate for a consumer product.

In one aspect, the components of the silicone compound are added to a consumer product or an intermediate for a consumer product and the silicone compound is formed in situ.

In one aspect the components of the silicone compound are added separately to a consumer product and the silicone compound may form in the consumer product before, during and/or after use by the consumer.

In one aspect, when additional benefit agent(s) and/or benefit agent delivery system(s), for example perfume and/or encapsulated perfume, are employed to form a particle, bead and/or agglomerate, the silicone compound of the present invention may be added before, during or after said additional benefit agent(s) and/or benefit agent delivery system(s) are added to said a particle, bead and/or agglomerate.

In one aspect, when additional benefit agent(s) and/or benefit agent delivery system(s), for example perfume and/or encapsulated perfume, are employed, the silicone compound of the present invention may be added before, during or after said additional benefit agent(s) and/or benefit agent delivery system(s) are added to a consumer.

Suitable equipment for use in the processes disclosed herein may include continuous stirred tank reactors, homogenizers, turbine agitators, recirculating pumps, paddle mixers, ploughshear mixers, ribbon blenders, vertical axis granulators, twin screw extruders and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., USA), Arde Barinco (N.J., USA), Wenger (Sabetha, Kans. USA).

### Compositions Comprising Silicone Compounds

Applicants' compositions comprise an embodiment of the silicone compounds disclosed in the present application. In one aspect, such compositions may be a consumer product. While the precise level of silicone compound that is employed depends on the type and end use of the product comprising such composition, a consumer products, including cleaning and/or fabric treatment products, may comprise, based on total product weight, from 0.0001% to 10%, preferably from 0.0002% to 1%, more preferably from 0.005% to 0.5%, most preferably from 0.001% to 0.05% of the silicones compound of A through L.

In one aspect, an embodiment of the silicone compounds disclosed in the present application into solid particles, particularly polymeric based particles. Examples of such polymeric particles may include particles comprising polyethylene glycol, starches and polysaccharides, polyvinyl alcohol, celluloses. Such particles may additionally comprise additional components such as other benefit agents, inorganic fillers such as carbonate, silicate, clay, metal oxides. Particularly useful particles include particles based on polyethylene glycol.

### Adjunct Materials

While not essential for each consumer product embodiment of the present invention, the non-limiting list of adjuncts illustrated hereinafter are suitable for use in the instant consumer products and may be desirably incorporated in certain embodiments of the invention, for example to assist or enhance performance, for treatment of the substrate to be cleaned, or to modify the aesthetics of the composition as is the case with perfumes, colorants, dyes or the like. The precise nature of these additional components, and levels of incorporation thereof, will depend on the physical form of the composition and the nature of the operation for which it is to be used. Suitable adjunct materials include, but are not limited to surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume and perfume delivery systems, structure elasticizing agents, thickeners/structurants, fabric softeners, carriers, hydrotropes, oligoamines, processing aids, hueing agents, and/or pigments.

As stated, the adjunct ingredients are not essential for each consumer product embodiment of the present invention. Thus, certain embodiments of Applicants' compositions do not contain one or more of the following adjuncts materials: surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume and perfume delivery systems, structure elasticizing agents, thickeners/structurants, fabric softeners, carriers, hydrotropes, oligoamines, processing aids, hueing agents, and/or pigments. However, when one or more adjuncts is present, such one or more adjuncts may be present as detailed below.

### Suitable Fabric Softening Actives

The fluid fabric enhancer compositions disclosed herein comprise a fabric softening active (“FSA”). Suitable fabric softening actives, include, but are not limited to, materials selected from the group consisting of quaternary ammonium compounds (quats), amines, fatty esters, sucrose esters, silicones, dispersible polyolefins, clays, polysaccharides, fatty acids, softening oils, polymer latexes and mixtures thereof.
Quat—Suitable quats include but are not limited to, materials selected from the group consisting of quaternary ammonium esters, amide quats, imidazoline quats, alkyl quats, amdioester quats and mixtures thereof.

The quaternary ammonium ester softening active may be present at a level of from 3.0% to 25.0%, more preferably from 4.0% to 18%, even more preferably from 4.5% to 15% by weight of the composition. The level of quaternary ammonium ester softening active may depend of the desired concentration of total softening active in the composition (diluted or concentrated composition) and of the presence or not of other softening active. While higher FSA levels improve the softness benefits, the risk on instabilities is typically higher in fabric softener compositions with higher FSA levels.

Suitable quaternary ammonium ester softening actives include but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

{R²₍₄₋ₘ₎−N+−[X−Y−R¹]ₘ}A⁻

wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently —(CH₂)n-, —CH₂—CH(CH₃)— or —CH—(CH₃)—CH₂— and
each n is independently 1, 2, 3 or 4, preferably each n is 2;
each Y is independently —O—(O)C— or —C(O)—O—;
A⁻ is independently selected from the group consisting of chloride, methyl sulfate, and ethyl sulfate, preferably A⁻ is selected from the group consisting of chloride and methyl sulfate;
   with the proviso that when Y is —O—(O)C—, the sum of carbons in each R¹ is from 13 to 21, preferably from 13 to 19. Preferably, X is —CH₂—CH(CH₃)— or —CH—(CH₃)—CH₂-to improve the hydrolytic stability of the quaternary ammonium ester softening active, and hence further improve the stability of the fabric softener composition.

In preferred liquid fabric softener compositions the iodine value of the parent fatty acid from which the quaternary ammonium fabric softening active is formed is from 0 to 100, more preferably from 10 to 60, even more preferably from 15 to 45.

Examples of suitable quaternary ammonium ester softening actives are commercially available from KAO Chemicals under the trade name Tetranyl AT-1 and Tetranyl AT-7590, from Evonik under the tradename Rewoquat WE16 DPG, Rewoquat WE18, Rewoquat WE20, Rewoquat WE28, and Rewoquat 38 DPG, from Stepan under the tradename Stepantex GA90, Stepantex VR90, Stepantex VK90, Stepantex VA90, Stepantex DC_{90,} Stepantex VL90A.

These types of agents and general methods of making them are disclosed in U.S. Pat. No. 4,137,180.

### Silicone

In one embodiment, the fabric softening composition comprises a silicone. Suitable levels of silicone may comprise from about 0.1% to about 70%, alternatively from about 0.3% to about 40%, alternatively from about 0.5% to about 30%, alternatively from about 1% to about 20% by weight of the composition. Useful silicones can be any silicone comprising compound. In one embodiment, the silicone polymer is selected from the group consisting of cyclic silicones, polydimethylsiloxanes, aminosilicones, cationic silicones, silicone polyethers, silicone resins, silicone urethanes, and mixtures thereof. In one embodiment, the silicone is a polydialkylsilicone, alternatively a polydimethyl silicone (polydimethyl siloxane or “PDMS”), or a derivative thereof. In another embodiment, the silicone is chosen from an aminofunctional silicone, amino-polyether silicone, alkyloxylated silicone, cationic silicone, ethoxylated silicone, propoxylated silicone, ethoxylated/propoxylated silicone, quaternary silicone, or combinations thereof.

### Surfactants

In some examples, the additional surfactant comprises one or more anionic surfactants. In some examples, the additional surfactant may consist essentially of, or even consist of one or more anionic surfactants.

Specific, non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates.

Alkoxylated alkyl sulfate materials comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric compounds having in their molecular structure an alkyl group containing from about 8 to about 30 carbon atoms and a sulfonic acid and its salts. (Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, said mixture having an average (arithmetic mean) carbon chain length within the range of about 12 to 30 carbon atoms, and in some examples an average carbon chain length of about 12-15 carbon atoms, and an average (arithmetic mean) degree of ethoxylation of from about 1 mol to 4 mols of ethylene oxide, and in some examples an average (arithmetic mean) degree of ethoxylation of about 1.8 mols to about 4 mols of ethylene oxide. In further examples, the alkyl ether sulfate surfactant may have a carbon chain length between about 10 carbon atoms to about 18 carbon atoms, and a degree of ethoxylation of from about 1 to about 6 mols of ethylene oxide. In yet further examples, the alkyl ether sulfate surfactant may contain a peaked ethoxylate distribution,

Non-ethoxylated alkyl sulfates may also be added to the disclosed cleaning compositions and used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₅ alkyl, and M is an alkali metal. In other examples, R is a C₁₂-C₁₄ alkyl and M is sodium.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C_{11.8} LAS.

Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

Nonionic Surfactants

In some aspects, the additional surfactant comprises one or more nonionic surfactants. In certain aspects, the detergent composition comprises from about 0.1% to about 40%, by weight of the composition, of an additional surfactant selected from one or more nonionic surfactants. In certain aspects, the detergent composition comprises from about 0.1% to about 15%, by weight of the composition, of an additional surfactant selected from one or more nonionic surfactants. In further aspects, the detergent composition comprises from about 0.3% to about 10%, by weight of the composition, of an additional surfactant selected from one or more nonionic surfactants.

Suitable nonionic surfactants useful herein can comprise any conventional nonionic surfactant. These can include, for e.g., alkoxylated fatty alcohols and amine oxide surfactants. In some examples, the cleaning compositions may contain an ethoxylated nonionic surfactant. The nonionic surfactant may be selected from the ethoxylated alcohols and ethoxylated alkyl phenols of the formula R(OC₂H₄)ₙOH, wherein R is selected from the group consisting of aliphatic hydrocarbon radicals containing from about 8 to about 17 carbon atoms and alkyl phenyl radicals in which the alkyl groups contain from about 8 to about 12 carbon atoms, and the average value of n is from about 5 to about 15. In one example, the nonionic surfactant is selected from ethoxylated alcohols having an average of about 24 carbon atoms in the alcohol and an average degree of ethoxylation of about 9 moles of ethylene oxide per mole of alcohol.

Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, alkylpolysaccharides, polyhydroxy fatty acid amides and ether capped poly(oxyalkylated) alcohol surfactants

Cationic Surfactants

In some examples, the additional surfactant comprises one or more cationic surfactants.

In certain aspects, the detergent composition comprises from about 0.1% to about 10%, by weight of the composition, of an additional surfactant selected from one or more cationic surfactants. In certain aspects, the detergent composition comprises from about 0.1% to about 7%, by weight of the composition, of an additional surfactant selected from one or more cationic surfactants. In further aspects, the detergent composition comprises from about 0.3% to about 5%, by weight of the composition, of an additional surfactant selected from one or more cationic surfactants.

Enzymes

The cleaning compositions described herein may comprise one or more enzymes which provide cleaning performance and/or fabric care benefits. Examples of suitable enzymes include, but are not limited to, hemicellulases, peroxidases, proteases, cellulases, xylanases, lipases, xylogluc anase, phospholipases, esterases, cutinas es, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a detergent composition, the aforementioned additional enzymes may be present at levels from about 0.00001% to about 2%, from about 0.0001% to about 1% or even from about 0.001% to about 0.5% enzyme protein by weight of the detergent composition.

Structurant/Thickeners

i. Non-Bacterial Derived Cellulose Fibers

In one aspect, the composition may further comprise from about 0.01 to about 5% by weight of the composition of a cellulosic fiber. Said cellulosic fiber may be extracted from vegetables, fruits or wood. Commercially available examples are Avicel® from FMC, Citri-Fi from Fiberstar or Betafib from Cosun.

ii. Non-Polymeric Crystalline Hydroxyl-Functional Materials

In one aspect, the composition may further comprise from about 0.01 to about 1% by weight of the composition of a non-polymeric crystalline, hydroxyl functional structurant. Said non-polymeric crystalline, hydroxyl functional structurants generally may comprise a crystallizable glyceride which can be pre-emulsified to aid dispersion into the final fluid detergent composition. In one aspect, crystallizable glycerides may include hydrogenated castor oil or “HCO” or derivatives thereof, provided that it is capable of crystallizing in the liquid detergent composition.

iii. Polymeric Structuring Agents

Fluid detergent compositions of the present invention may comprise from about 0.01% to about 5% by weight of a naturally derived and/or synthetic polymeric structurant. Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Examples of synthetic polymeric structurants of use in the present invention include: polycarboxylates, polyacrylates, hydrophobically modified ethoxylated urethanes, hydrophobic ally modified non-ionic polyols and mixtures thereof. In one aspect, said polycarboxylate polymer is a polyacrylate, polymethacrylate or mixtures thereof. In another aspect, the polyacrylate is a copolymer of unsaturated mono- or di-carbonic acid and C₁-C₃₀ alkyl ester of the (meth)acrylic acid. Said copolymers are available from Noveon inc under the tradename Carbopol Aqua 30.

### Amines

Various amines may be used in the cleaning compositions described herein for added removal of grease and particulates from soiled materials. The detergent compositions described herein may comprise from about 0.1% to about 10%, in some examples, from about 0.1% to about 4%, and in other examples, from about 0.1% to about 2%, by weight of the cleaning composition, of additional amines. Non-limiting examples of amines include, but are not limited to, polyamines, oligoamines, triamines, diamines, pentamines, tetraamines, polyetheramines, or combinations thereof. Specific examples of suitable additional amines include tetraethylenepentamine, triethylenetetraamine, diethylenetriamine, polyetheramines, or a mixture thereof. A suitable polyetheramine is represented by the structure of Formula (I):

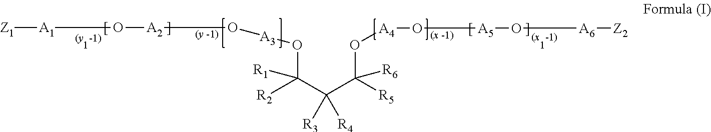

where each of R₁-R₆ is independently selected from H, alkyl, cycloalkyl, aryl, alkylaryl, or arylalkyl, where at least one of R₁-R₆ is different from H, typically at least one of R₁-R₆ is an alkyl group having 2 to 8 carbon atoms, each of A₁i-A₆ is independently selected from linear or branched alkylenes having 2 to 18 carbon atoms, typically 2 to 10 carbon atoms, more typically, 2 to 5 carbon atoms, each of Z₁-Z₂ is independently selected from OH or NH₂, where at least one of Z₁-Z₂ is NH₂, typically each of Z₁ and Z₂ is NH₂, where the sum of x+y is in the range of about 2 to about 200, typically about 2 to about 20 or about 3 to about 20, more typically about 2 to about 10 or about 3 to about 8 or about 4 to about 6, where x≥1 and y≥1, and the sum of x₁+y₁ is in the range of about 2 to about 200, typically about 2 to about 20 or about 3 to about 20, more typically about 2 to about 10 or about 3 to about 8 or about 2 to about 4, where x₁≥1 and y₁≥1. Another suitable polyetheramine is represented by the structure of Formula (II):

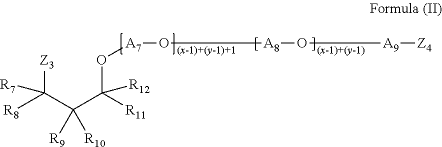

where each of R₇-R₁₂ is independently selected from H, alkyl, cycloalkyl, aryl, alkylaryl, or arylalkyl, where at least one of R₇-R₁₂ is different from H, typically at least one of R₇-R₁₂ is an alkyl group having 2 to 8 carbon atoms, each of A₇-A₉ is independently selected from linear or branched alkylenes having 2 to 18 carbon atoms, typically 2 to 10 carbon atoms, more typically, 2 to 5 carbon atoms, each of Z₃-Z₄ is independently selected from OH or NH₂, where at least one of Z₃-Z₄ is NH₂, typically each of Z₃ and Z₄ is NH₂, where the sum of x+y is in the range of about 2 to about 200, typically about 2 to about 20 or about 3 to about 20, more typically about 2 to about 10 or about 3 to about 8 or about 2 to about 4, where x≥1 and y≥1, and the sum of x₁+y₁ is in the range of about 2 to about 200, typically about 2 to about 20 or about 3 to about 20, more typically about 2 to about 10 or about 3 to about 8 or about 2 to about 4, where x₁≥1 and y₁≥1.

Another suitable polyetheramine is represented by the structure of Formula III:

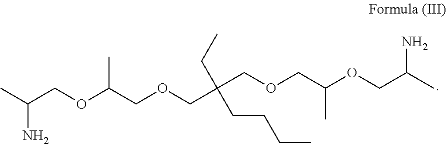 [SMILES: CCCCC(CC)(COCC(C)OCC(C)N)COCC(C)OCC(C)N]

Solvents—suitable solvents include, but are not limited to, water, alcohol, paraffins, glycols, glycerols, and mixtures thereof.

Bleaching Agents—The detergent compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the detergent compositions of the present invention may comprise from about 0.1% to about 50% or even from about 0.1% to about 25% bleaching agent by weight of the detergent composition. Examples of suitable bleaching agents include:

(1) photobleaches for example sulfonated zinc phthalocyanine sulfonated aluminium phthalocyanines, xanthene dyes and mixtures thereof;

(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone ®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;

(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall fabric and home care product and are typically incorporated into such fabric and home care products as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof - especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). While any suitable bleach activator may be employed, in one aspect of the invention the subject detergent composition may comprise NOBS, TAED or mixtures thereof.

When present, the peracid and/or bleach activator is generally present in the detergent composition in an amount of from about 0.1 to about 60 wt %, from about 0.5 to about 40 wt % or even from about 0.6 to about 10 wt % based on the fabric and home care product. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Brighteners

Optical brighteners or other brightening or whitening agents may be incorporated at levels of from about 0.01% to about 1.2%, by weight of the composition, into the cleaning compositions described herein. Commercial fluorescent brighteners suitable for the present invention can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener herein comprises a compound of formula (1):

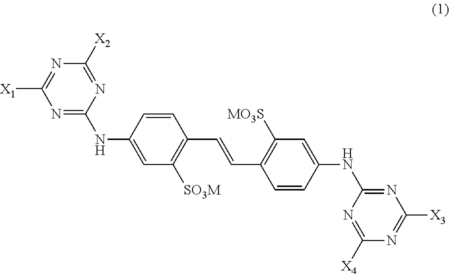

wherein: X₁, X₂, X₃, and X₄ are N(R¹)R², wherein R¹ and R² are independently selected from a hydrogen, a phenyl, hydroxyethyl, or an unsubstituted or substituted C₁-C₈ alkyl, or —N(R¹)R² form a heterocyclic ring, preferably R¹ and R² are independently selected from a hydrogen or phenyl, or —N(R¹)R² form a unsubstituted or substituted morpholine ring; and M is a hydrogen or a cation, preferably M is sodium or potassium, more preferably M is sodium.

Water-Soluble Film

The compositions of the present invention may also be encapsulated within a water-soluble film. Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the pouch material. Naturally, different film material and/or films of different thickness may be employed in making the compartments of the present invention. A benefit in selecting different films is that the resulting compartments may exhibit different solubility or release characteristics.

Most preferred film materials are PVA films known under the MonoSol trade reference M8630, M8900, H8779 .

Fabric Hueing Agents

The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes and mixtures thereof. In another aspect, suitable small molecule dyes include small molecule dyes selected from the group consisting of C. I. numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof.

Suitable dye clay conjugates include dye clay conjugates selected from the group comprising at least one cationic/basic dye and a smectite clay, and mixtures thereof.

Perfumes—Suitable adjunct perfume raw materials include those perfume raw materials listed in Table 2 below. Such adjunct perfume raw materials may be used in addition to the the silicone compounds disclosed in the present specification. For example, such adjunct perfume raw materials may be used to formulate a part or all of a neat perfume.

Additional Perfume Delivery Technologies—The consumer products may comprise one or more perfume delivery technologies that stabilize and enhance the deposition and release of perfume ingredients from treated substrate. Such perfume delivery technologies can also be used to increase the longevity of perfume release from the treated substrate. Perfume delivery technologies, methods of making certain perfume delivery technologies and the uses of such perfume delivery technologies are disclosed in US 2007/0275866 A1.

In one aspect, the fluid fabric enhancer composition may comprise from about 0.001% to about 20%, or from about 0.01% to about 10%, or from about 0.05% to about 5%, or even from about 0.1% to about 0.5% by weight of the perfume delivery technology. In one aspect, said perfume delivery technologies may be selected from the group consisting of: perfume microcapsules, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof:

In one aspect, said perfume delivery technology may comprise microcapsules formed by at least partially surrounding a benefit agent with a wall material. Said benefit agent may include materials selected from the group consisting of perfumes such In one aspect, the microcapsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol and mixtures thereof. In one aspect, said melamine wall material may comprise melamine crosslinked with formaldehyde, melamine-dimethoxyethanol crosslinked with formaldehyde, and mixtures thereof. In one aspect, said polystyrene wall material may comprise polyestyrene cross-linked with divinylbenzene. In one aspect, said polyurea wall material may comprise urea crosslinked with formaldehyde, urea crosslinked with gluteraldehyde, and mixtures thereof. In one aspect, said polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

In one aspect, said perfume delivery technology may comprise an amine compound (ARP) or a thio compound. One may also use “reactive” polymeric amines and or polymeric thios in which the amine and/or thio functionality is pre-reacted with one or more PRMs to form a compound. Typically the reactive amines are primary and/or secondary amines, and may be part of a polymer or a monomer (non-polymer).

Dye Transfer Inhibiting Agents

Fabric cleaning compositions may also include one or more materials effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2% by weight of the composition.

Chelating Agents

The detergent compositions described herein may also contain one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins and mixtures thereof. Chelating agents can be present in the acid or salt form including alkali metal, ammonium, and substituted ammonium salts thereof, and mixtures thereof.

Aminocarboxylates useful as chelating agents include, but are not limited to ethylenediaminetetracetates (EDTA); N-(hydroxyethyl)ethylenediaminetriacetates (HEDTA);

nitrilotriacetates (NTA); ethylenediamine tetraproprionates; triethylenetetraaminehexacetates, diethylenetriamine-pentaacetates (DTPA); methylglycinediacetic acid (MGDA); Glutamic acid diacetic acid (GLDA); ethanoldiglycines; triethylenetetraaminehexaacetic acid (TTHA); N-hydroxyethyliminodiacetic acid (HEIDA); dihydroxyethylglycine (DHEG); ethylenediaminetetrapropionic acid (EDTP) and derivatives thereof.

Phosphorus containing chelants include, but are not limited to diethylene triamine penta (methylene phosphonic acid) (DTPMP CAS 15827-60-8); ethylene diamine tetra(methylene phosphonic acid) (EDTMP CAS 1429-50-1); 2-Phosphonobutane 1,2,4-tricarboxylic acid (Bayhibit® AM); hexamethylene diamine tetra(methylene phosphonic acid) (CAS 56744-47-9); hydroxy-ethane diphosphonic acid (HEDP CAS 2809-21-4); hydroxyethane dimethylene phosphonic acid; 2-phosphono-1,2,4-Butanetricarboxylic acid (CAS 37971-36-1); 2-hydroxy-2-phosphono-Acetic acid (CAS 23783-26-8); Aminotri(methylenephosphonic acid) (ATMP CAS 6419-19-8); P,P′-(1,2-ethanediyl)bis-Phosphonic acid (CAS 6145-31-9); P,P′-methylenebis-Phosphonic acid (CAS 1984-15-2); Triethylenediaminetetra(methylene phosphonic acid) (CAS 28444-52-2); P-(1-hydroxy-1-methylethyl)-Phosphonic acid (CAS 4167-10-6); bis(hexamethylene triamine penta(methylenephosphonic acid)) (CAS 34690-00-1); N2,N2,N6,N6-tetrakis(phosphonomethyl)-Lysine (CAS 194933-56-7, CAS 172780-03-9), salts thereof, and mixtures thereof. Preferably, these aminophosphonates do not contain alkyl or alkenyl groups with more than about 6 carbon atoms.

A biodegradable chelator that may also be used herein is ethylenediamine disuccinate

(“EDDS”). In some examples, but of course not limited to this particular example, the[S,S] isomer. In other examples, the trisodium salt of EDDA may be used, though other forms, such as magnesium salts, may also be useful. Polymeric chelants such as Trilon P® from BASF may also be useful.

Hygiene and Malodour

The compositions of the present invention may also comprise one or more of zinc ricinoleate, thymol, quaternary ammonium salts such as Bardac®, polyethylenimines (such as Lupasol® from BASF) and zinc complexes thereof, silver and silver compounds, especially those designed to slowly release Ag+or nano-silver dispersions.

### Test Methods

### (1) ClogP

The logP values of many perfume ingredients have been reported; for example, the Pomona92 database, available from Daylight Chemical Information Systems, Inc. (Daylight CIS, Irvine, Calif.), contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful in the present invention.

### Test Methods

It is understood that the test methods that are disclosed in the Test Methods Section of the present application should be used to determine the respective values of the parameters of Applicants' invention as such invention is described and claimed herein.

### Viscosity Test Method

A preliminary estimate of the sample viscosity at 25° C. is used to select the appropriate instrument geometry to be used during the final viscosity measurement analyses, which are conducted on a model AR-G2 Rheometer (manufactured by TA Instruments Corp., New Castle, Del., USA). A preliminary estimate of the sample viscosity may be obtained by using a Brookfield Viscometer (Brookfield Engineering Laboratories Inc., Middleboro, Mass., USA). The selection of geometry for use on the AR-G2 Rheometer is determined in accordance with the following table, Table-2:

TABLE-2
AR-G2 Geometry Selection

| Preliminary Estimate of | |
|---|---|
| Sample Viscosity | AR-G2 Geometry and Plate Size |
| >1000 Pa*s | 25 mm parallel plate |
| 1 to 1000 Pa*s | 40 mm parallel plate |
| >Water-thin to <1 Pa*s | 60 mm parallel plate |
| Water-thin | Couette/Cup and Bob |

The geometry attached to the instrument, the instrument is mapped, the gap distance is zeroed, and the instrument temperature is set to 25° C. The measurement mode is selected as

Stiff Mode when using parallel plates, or to Soft mode when using the couett cup and bob geometry. Sample material is mounted into the sample holding geometry e.g., the base plate. The minimum gap distance allowable between the base plate and the selected geometry is 10× the diameter of the largest common particle present in sample. If there are common particles in the sample which have a diameter greater than 100 μm (as determined microscopically), then the gap value is set to 10× the diameter of the largest common particle, otherwise the gap distance is set to the default value of 1000 μm (ie 1 mm). The selected geometry is lowered to the appropriate gap and a plastic tool is used to trim off any excess sample material. The sample material is allowed to equilibrate to the temperature of the instrument. Three rheological measurement analyses are conducted, namely: Flow Curve, Stress Sweep, and Frequency Sweep, using the following selections and settings:

Flow Curve: select Stepped Flow 0.01 to 100; 10 pts/decade; shear stress; constant time 20;

average last 10.

Stress Sweep: set the Stress Range as 0.01 to 100 Pa; set the Frequency at 1 rad/s.

Frequency Sweep: Set the Angular Frequency Range as 0.1 to 100.

To ensure that the analysis is conducted within the Linear Viscoelastic Region set the Stress value at a third of the stress value that was present when G′ started to degrade during the prior Stress Sweep analysis.

The viscosity value for the test material obtained at 25° C. is reported.

### Amine Equivalent Test Method

The Amine Equivalent method is an ASTM standard D2074-07, but with the extra step of converting from Amine Value (meq/g) to Amine Equivalent (g/mol) as follows:

Amine Equivalent (g/mol)=1000/Amine Value (meq/g)

Method for assigning the Blocking Index (BI) to Test Samples Using a BI Reference Scale

The first step in the method for assigning a BI to a test sample material on the BI reference scale is to create the BI reference swatches. The swatches for the scale are created by treating clean fabrics swatches with a known amount of a known volume of isovaleric acid solution at a known concentration. Fabric swatches for this test are white knit polycotton (4 inch×4 inch) swatches from EMC ordered as PC 50/50. The supplier is instructed to strip the swatches first, stripping involves washing twice with a fragrance-free detergent and rinsing three times.

### Making the BI Reference Swatches

Make one solution of 0.08% isovaleric acid using 50%/ 50% EtOH/water as the diluent. The BI scale contains one clean swatch with no malodor applied. Three other swatches each have a different volume of the 0.08% isovaleric acid applied. Pipette 2μL, of the 0.08% isovaleric acid solution to one clean swatch, 5 pL of the 0.08% isovaleric acid solution to the next swatch and 20 μL of isovaleric acid to the final clean swatch. These solutions are pipetted to the middle of the swatches. This will create a sensory scale of three swatches with three different odor levels based on the volume of the 0.08% isovaleric acid solution pipetted onto the swatches. After drying for 30 minutes in a vented hood, the swatches are wrapped in aluminum foil to prevent odor contamination to the treated swatch. A clean untreated swatch is also included as the lowest anchor point of reference for malodor strength on the BI scale. The BI reference scale swatches should be used within 0.5 to 12 hours and discarded after 12 hours. The swatches are used as scale anchor points when graders evaluate a test sample(s) and are assigned a Blocker Index (BI) as show in Table 12.

At least three perfumers/expert graders are used to rank the isovaleric acid swatches in the BI scale. The perfumer/expert grader needs to demonstrate adequate discrimination on the scale. The perfumer/expert grader is asked to rank order swatches according to a scale between 0 and 3. The panel of graders must demonstrate statistical differences between the swatches (for additional details on training graders see as seen in US 2016/0090555 A1, starting on p 35 column 1, paragraph[0212] and ending on p 25 column 2 at and including Table 12, with the only difference being, 3 graders are used for the purposes of the present invention.

Making the Malodorous Swatches for Blocker Index Grading and Treating it with a Test Detergent

To evaluate the BI of test detergents containing the test materials (MOC oil or MOC reacted with silicone), first prepare swatches stained with body soil malodor composition. To create the body soil malodor composition first the malodor composition is made according to the formulation in Table A.

TABLE A
Malodor marker composition

| Material | CAS # | % Composition | Weight needed (g) |
|---|---|---|---|
| Iso Valeric acid | 503-74-2 | 12.00 | 9.0 |
| Undecanal | 112-44-7 | 0.20 | 0.15 |
| Undecanoic | 112-37-8 | 62.80 | 47.1 |
| Acid | | | |
| Skatole | 83-34-1 | 1.00 | 0.75 |
| Decanoic Acid | 334-48-5 | 22.00 | 16.5 |
| Ethyl | 627-90-7 | 2.00 | 1.5 |
| undecanoate | | | |

Next the body soil malodor composition is made by providing the specified amount of each material according to the Table B into a 200 mL glass jar with Teflon lined cap. Artificial body soil (ABS) is commercially available by Accurate Product Development; 2028 Bohlke Blvd, Fairfield, Ohio 45014.

TABLE B
Body soil malodor composition

| Material | Weight (g) |
|---|---|
| Malodor marker (from Table A) | 17.1 |
| Artificial Body Soil (ABS) | 15.8 |
| Di-propylene glycol | 105 |
| monomethyl ether | |
| (CAS: 34590-94-8) | |
| Squalene (cas # 111-02-4) | 15.8 |

The composition in Table B is used to prepare the swatches stained with the malodor body soil composition. Apply 300 μl of body soil malodor composition described in Table B to de-sized 4×4 inch PC 50/50 swatches from EMC.

To treat the stained swatches, 48 grams of liquid detergent according to Table 1B of Performance Example 1 is added to Duet 9200 washing appliance set to Normal cycle; 77° F. wash cycle followed by a 60° F. rinse cycle. Malodor test fabrics are washed in 7gpg wash water with 3.9 kg, 50×50 cm clean cotton and poly-cotton ballast then dried in a Maytag double stack tumble drier set to low for 20 minutes. The dried fabrics are placed in a mylar bag and sealed for 24 hours.

After 24 hours, at least three perfumers/expert graders are used to assign the BI to the test sample. The expert grader smells the isovaleric acid + test material swatch by holding that swatch one inch from their nose and then assigns the isovaleric acid + test material swatch a BI based on ranking its odor strength against the odor strength of the swatches in the BI reference scale. The test sample swatch is assigned a BI at or between numbers on the BI in table. In cases where the isovaleric acid + test material swatch odor is greater than 3 on the BI reference scale, this indicates the material is not a blocker.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

An aminoester terminated polydimethylsiloxane is produced as follows:

A carboxypropyl terminated polydimethylsiloxane, DMS-B31 (25.00 g; 28,000 MW; Available from Gelest, Inc., Morrisville, Pa.) is combined with NN-dimethylethanolannne (0.64 g; Available from Sigma-Aldrich, St. Louis, Mo.). The mixture is heated while stirring for 16 hours at 180° C. with liberation of water, after which the mixture is placed under reduced pressure to remove excess NN-dimethylethanolamine. The reaction product is analyzed via ¹H NMR and contains the ester functionality.

### Example 2

An amino/methacryloyloxy Michael Adduct side chain polydimethylsiloxane is produced as follows:

A (methacryloxypropyl)methylsiloxane—dimethylsiloxane copolymer, RMS-033 (5.00 g; 2600 Functional Group MW; Available from Gelest, Inc., Morrisville, Pa.) is combined with ethylenediamine (0.47 g; Available from Sigma-Aldrich, St. Louis, Mo.) and 2-ethyl-1-hexanol (1.37 g; Available from Sigma-Aldrich, St. Louis, Mo.). The mixture is heated while stirring for 16 hours at 135° C., after which the mixture is placed under reduced pressure to remove excess ethylenediamine. The reaction product is analyzed via ¹H NMR and contains the amino/methacryloyloxy Michael Adduct functionality.

### Example 3

A silicone compound comprising silicone moiety having a moiety comprising a cleavable bond linking a benefit agent to said silicone is produced as follows:

The amino/methacryloyloxy Michael Adduct side chain polydimethylsiloxane from Example 2 (2.5 g 1982 Functional Group MW) is combined with 6-damascone (0.24 g; Available from Sigma-Aldrich, St. Louis, Mo.). The mixture is heated while stirring for 4 hours at 125° C. The reaction product is analyzed via ¹1-1. NMR and contains the amino/damascone Michael Adduct functionality.

The silicone compound is tested and is found to serve as a perfume delivery vehicle as such silicone compound gradually releases the benefit agent which is 6-damascone

### Example 4

A silicone moiety having a moiety comprising a cleavable bond linking a benefit agent to said silicone is produced as follows:

The amino/methacryloyloxy Michael Adduct side chain polydimethylsiloxane from Example 2 (2.5 g 1982 Functional Group MW) is combined with melonal (0.18 g; Available from Sigma-Aldrich, St. Louis, Mo.) and para-toluenesulfonic acid (0.0025 g; Available from Sigma-Aldrich, St. Louis, Mo.). The mixture is heated while stirring for 4 hours at 125° C. with nitrogen sweep.

The reaction product is analyzed via ¹H NMR and contains the imine functionality.

The silicone compound is tested and is found to serve as a perfume delivery vehicle as such silicone compound gradually releases the benefit agent which is δ-damascone

### Example 5

An aminoester terminated polydimethylsiloxane is produced as follows:

A carboxydecyl terminated polydimethylsiloxane, DMS-B12 (25.00 g; 1000 MW; Available from Gelest, Inc., Morrisville, Pa.) is combined with N,N-dimethylethanolamine (17.83 g; Available from Sigma-Aldrich, St. Louis, Mo.). The mixture is heated while stirring for 16 hours at 180° C. with liberation of water, after which the mixture is placed under reduced pressure to remove excess N,N-dimethylethanolamine. The reaction product is analyzed via ¹H NMR and contains the ester functionality.

### Example 6

An (Aminoester)methylsiloxane-Dimethylsiloxane copolymer is produced as follows:

A (Carboxydecyl)methylsiloxane-Dimethylsiloxane copolymer, (25.00 g; 488 g/mol carboxy equivalence) is combined with N,N-dimethylethanolamine (18.27 g; Available from Sigma-Aldrich, St. Louis, Mo.). The mixture is heated while stirring for 16 hours at 180° C. with liberation of water, after which the mixture is placed under reduced pressure to remove excess N,N-dimethylethanolamine. The reaction product is analyzed via ¹H NMR and contains the ester functionality.

### Example 7

Non-limiting examples of product formulations containing a silicone compound are summarized in the following table.

| | EXAMPLES | | | | | | | | | |
|---|---|---|---|---|---|---|---|---|---|---|
| (% wt) | A | B | C | D | E | F | G | H | I | J |
| FSA ^{a} | 14 | 16.47 | 14 | 12 | 12 | 16.47 | — | — | 5 | 5 |
| FSA ^{b} | | | | | — | | 3.00 | — | — | — |
| FSA ^{c} | | | | | — | | — | 6.5 | — | — |
| Ethanol | 2.18 | 2.57 | 2.18 | 1.95 | 1.95 | 2.57 | — | — | 0.81 | 0.81 |
| Isopropyl | — | — | — | — | — | — | 0.33 | 1.22 | — | — |
| Alcohol | | | | | | | | | | |
| Starch ^{d} | 1.25 | 1.47 | 2.00 | 1.25 | — | 2.30 | 0.5 | 0.70 | 0.71 | 0.42 |
| Silicone | 0.0002 | 0.0001 | 0.0015 | 0.003 | 0.0001 | 0.0001 | 0.0001 | 0.0005 | 0.0001 | 0.0001 |
| compound | to 0.5 | to | | | to 0.1 | to 0.1 | to 0.1 | | to 0.1 | to 0.1 |
| according to | | 0.1 | | | | | | | | |
| Examples | | | | | | | | | | |
| 3-4 | | | | | | | | | | |
| Phase | 0.21 | 0.25 | 0.21 | 0.21 | 0.14 | — | — | 0.14 | — | — |
| Stabilizing | | | | | | | | | | |
| Polymer ^{f} | | | | | | | | | | |
| Suds | — | — | — | — | — | — | — | 0.1 | — | — |
| Suppressor ^{g} | | | | | | | | | | |
| Calcium | 0.15 | 0.176 | 0.15 | 0.q15 | 0.30 | 0.176 | — | 0.1- | — | — |
| Chloride | | | | | | | | 0.15 | | |
| DTPA ^{h} | 0.017 | 0.017 | 0.017 | 0.017 | 0.007 | 0.007 | 0.20 | — | 0.002 | 0.002 |
| Preservative | 5 | 5 | 5 | 5 | 5 | 5 | — | 250 ^{j} | 5 | 5 |
| (ppm) ^{i,j} | | | | | | | | | | |
| Antifoam^{k} | 0.015 | 0.018 | 0.015 | 0.015 | 0.015 | 0.015 | — | — | 0.015 | 0.015 |
| Dye | 40 | 40 | 40 | 40 | 40 | 40 | 11 | 30-300 | 30 | 30 |
| (ppm) | | | | | | | | | | |
| Ammonium | 0.100 | 0.118 | 0.100 | 0.100 | 0.115 | 0.115 | — | — | — | — |
| Chloride | | | | | | | | | | |
| HCl | 0.012 | 0.014 | 0.012 | 0.012 | 0.028 | 0.028 | 0.016 | 0.025 | 0.011 | 0.011 |
| Structurant^{l} | 0.01 | 0.01 | 0.01 | 0.01 | 0.01 | 0.01 | 0.01 | 0.01 | 0.01 | 0.01 |
| Neat | 0.8 | 0.7 | 0.9 | 0.5 | 1.2 | 0.5 | 1.1 | 0.6 | 1.0 | 0.9 |
| Perfume | | | | | | | | | | |
| Deionized | * | * | * | * | * | * | * | * | * | * |
| Water | | | | | | | | | | |

* Balance
^{a} N,N-di(tallowoyloxyethyl)-N,N-dimethylammonium chloride.
^{b} Methyl bis(tallow amidoethyl)2-hydroxyethyl ammonium methyl sulfate.
^{c} Compound of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{d} Cationic high amylose maize starch available from National Starch under the trade name CATO ®.
^{f} Copolymer of ethylene oxide and terephthalate having the formula described in US 5,574,179 at col.15, lines 1-5, wherein each X is methyl, each n is 40, u is 4, each R1 is essentially 1,4-phenylene moieties, each R2 is essentially ethylene, 1,2-propylene moieties, or mixtures thereof.
^{g} SE39 from Wacker
^{h} Diethylenetriaminepentaacetic acid.
ⁱ KATHON ® CG available from Rohm and Haas Co. “PPM” is “parts per million.”
^{j} Gluteraldehyde
^{k}(Silicone antifoam agent available from Dow Corning Corp. under the trade name DC2310.
^{l}Hydrophobically-modified ethoxylated urethane available from Rohm and Haas under the tradename Aculan 44.

### Example 8

### Silicone Compounds in Dry Laundry Formulations

| | % w/w granular | | | | | | |
|---|---|---|---|---|---|---|---|
| | laundry detergent composition | | | | | | |
| Component | A | B | C | D | E | F | G |
| Brightener | 0.1 | 0.1 | 0.1 | 0.2 | 0.1 | 0.2 | 0.1 |
| Soap | 0.6 | 0.6 | 0.6 | 0.6 | 0.6 | 0.6 | 0.6 |
| Ethylenediamine disuccinic acid | 0.1 | 0.1 | 0.1 | 0.1 | 0.1 | 0.1 | 0.1 |
| Acrylate/maleate copolymer | 1.5 | 1.5 | 1.5 | 1.5 | 1.5 | 1.5 | 1.5 |
| Hydroxyethane di(methylene | 0.4 | 0.4 | 0.4 | 0.4 | 0.4 | 0.4 | 0.4 |
| phosphonic acid) | | | | | | | |
| Mono-C₁₂₋₁₄ alkyl, di-methyl, | 0.5 | 0.5 | 0.5 | 0.5 | 0.5 | 0.5 | 0.5 |
| mono-hydroxyethyl quaternary | | | | | | | |
| ammonium chloride | | | | | | | |
| Linear alkyl benzene | 0.1 | 0.1 | 0.2 | 0.1 | 0.1 | 0.2 | 0.1 |
| Linear alkyl benzene sulphonate | 10.3 | 10.1 | 19.9 | 14.7 | 10.3 | 17 | 10.5 |
| Magnesium sulphate | 0.4 | 0.4 | 0.4 | 0.4 | 0.4 | 0.4 | 0.4 |
| Sodium carbonate | 19.5 | 19.2 | 10.1 | 18.5 | 29.9 | 10.1 | 16.8 |
| Sodium sulphate | 29.6 | 29.8 | 38.8 | 15.1 | 24.4 | 19.7 | 19.1 |
| Sodium Chloride | 0.1 | 0.1 | 0.1 | 0.1 | 0.1 | 0.1 | 0.1 |
| Zeolite | 9.6 | 9.4 | 8.1 | 18 | 10 | 13.2 | 17.3 |
| Photobleach particle | 0.1 | 0.1 | 0.2 | 0.1 | 0.2 | 0.1 | 0.2 |
| Blue and red carbonate speckles | 1.8 | 1.8 | 1.8 | 1.8 | 1.8 | 1.8 | 1.8 |
| Ethoxylated Alcohol AE7 | 1 | 1 | 1 | 1 | 1 | 1 | 1 |
| Tetraacetyl ethylene diamine | 0.9 | 0.9 | 0.9 | 0.9 | 0.9 | 0.9 | 0.9 |
| agglomerate (92 wt % active) | | | | | | | |
| Citric acid | 1.4 | 1.4 | 1.4 | 1.4 | 1.4 | 1.4 | 1.4 |
| PDMS/clay agglomerates (9.5% | 10.5 | 10.3 | 5 | 15 | 5.1 | 7.3 | 10.2 |
| wt % active PDMS) | | | | | | | |
| Polyethylene oxide | 0.2 | 0.2 | 0.2 | 0.2 | 0.2 | 0.2 | 0.2 |
| Enzymes e.g. Protease (84 mg/g | 0.2 | 0.3 | 0.2 | 0.1 | 0.2 | 0.1 | 0.2 |
| active), Amylase | | | | | | | |
| (22 mg/g active) | | | | | | | |
| Suds suppressor agglomerate | 0.2 | 0.2 | 0.2 | 0.2 | 0.2 | 0.2 | 0.2 |
| (12.4 wt % active) | | | | | | | |
| Sodium percarbonate (having | 7.2 | 7.1 | 4.9 | 5.4 | 6.9 | 19.3 | 13.1 |
| from 12% to 15% active AvOx) | | | | | | | |
| Perfume oil | 0.5 | 0.5 | 0.5 | 0.5 | 0.5 | 0.5 | 0.5 |
| Solid perfume particles | 0.4 | 0 | 0.4 | 0.4 | 0.4 | 0.4 | 0.6 |
| Silicone compound according | 0.0001 | 0.004 | 0.01 | 0.02 | 0.0001 | 0.0001 | 0.0001 |
| to Examples 3-4 | to | | | | to | to | to |
| | 0.1 | | | | 0.1 | 0.1 | 0.1 |
| Balance Water* | * | * | * | * | * | * | * |

### Example 9

### Liquid Laundry Formulations (HDLs) Comprising Silicone Compounds

| Ingredient | HDL 1 | HDL 2 | HDL3 | HDL4 | HDL 5 | HDL 6 |
|---|---|---|---|---|---|---|
| Alkyl Ether Sulphate | 0.00 | 0.50 | 12.0 | 12.0 | 6.0 | 7.0 |
| Dodecy Benzene | 8.0 | 8.0 | 1.0 | 1.0 | 2.0 | 3.0 |
| Sulphonic Acid | | | | | | |
| Ethoxylated Alcohol | 8.0 | 6.0 | 5.0 | 7.0 | 5.0 | 3.0 |
| Citric Acid | 5.0 | 3.0 | 3.0 | 5.0 | 2.0 | 3.0 |
| Fatty Acid | 3.0 | 5.0 | 5.0 | 3.0 | 6.0 | 5.0 |
| Ethoxysulfated | 1.9 | 1.2 | 1.5 | 2.0 | 1.0 | 1.0 |
| hexamethylene diamine | | | | | | |
| quatemized | | | | | | |
| Diethylene triamine penta | 0.3 | 0.2 | 0.2 | 0.3 | 0.1 | 0.2 |
| methylene phosphonic acid | | | | | | |
| Enzymes | 1.20 | 0.80 | 0 | 1.2 | 0 | 0.8 |
| Brightener (disulphonated | 0.14 | 0.09 | 0 | 0.14 | 0.01 | 0.09 |
| diamino stilbene based | | | | | | |
| FWA) | | | | | | |
| Cationic hydroxyethyl | 0 | 0 | 0.10 | 0 | 0.200 | 0.30 |
| cellulose | | | | | | |
| Poly(acrylamide-co- | 0 | 0 | 0 | 0.50 | 0.10 | 0 |
| diallyldimethylammonium | | | | | | |
| chloride) | | | | | | |
| Hydrogenated Castor Oil | 0.50 | 0.44 | 0.2 | 0.2 | 0.3 | 0.3 |
| Structurant | | | | | | |
| Boric acid | 2.4 | 1.5 | 1.0 | 2.4 | 1.0 | 1.5 |
| Ethanol | 0.50 | 1.0 | 2.0 | 2.0 | 1.0 | 1.0 |
| 1,2 propanediol | 2.0 | 3.0 | 1.0 | 1.0 | 0.01 | 0.01 |
| Glutaraldehyde | 0 | 0 | 19 ppm | 0 | 13 ppm | 0 |
| Diethyleneglycol (DEG) | 1.6 | 0 | 0 | 0 | 0 | 0 |
| 2,3-Methyl-1,3- | 1.0 | 1.0 | 0 | 0 | 0 | 0 |
| propanediol (M pdiol) | | | | | | |
| Mono Ethanol Amine | 1.0 | 0.5 | 0 | 0 | 0 | 0 |
| NaOH Sufficient To | pH 8 | pH 8 | pH 8 | pH 8 | pH 8 | pH 8 |
| Provide Formulation pH of: | | | | | | |
| Sodium Cumene | 2.00 | 0 | 0 | 0 | 0 | 0 |
| Sulphonate (NaCS) | | | | | | |
| Silicone (PDMS) emulsion | 0.003 | 0.003 | 0.003 | 0.003 | 0.003 | 0.003 |
| Perfume | 0.7 | 0.5 | 0.8 | 0.8 | 0.6 | 0.6 |
| Polyethyleneimine | 0.01 | 0.10 | 0.00 | 0.10 | 0.20 | 0.05 |
| Silicone compound | 0.0001 | 0.0001 | 0.003 | 0.0001 | 0.0001 | 0.0001 |
| according to Examples 3-4 | to 0.1 | to 0.1 | to 0.2 | to 0.1 | to 0.1 | to 0.5 |
| Water | Balance | Balance | Balance | Balance | Balance | Balance |
| | to | to | to | to | to | to |
| | 100% | 100% | 100% | 100% | 100% | 100% |

### Example 10

Examples of free flowing particles products that comprise silicone compound according to the present invention and/or microcapsule. The table below also exemplifies combinations which comprise also perfume free and in microcapsules or combinations of these with aforementioned combinations with malodor reduction materials and/or compositions. The table also exemplifies compositions having only malodor reduction materials and/or compositions free, in microcapsules and combinations thereof that have little to no fragrance to provide a product that is essentially ‘fragrance free’

| | COMPOSITION | | | |
|---|---|---|---|---|
| | 1 | 2 | 3 | 4 |
| | % Wt | % Wt | % Wt | % Wt |
| | Active | Active | Active | Active |
| Component | | | | |
| Polyethylene glycol | 70-99 | 0-20 | 0-29 | 0-40 |
| Clay | 0-29 | 0-20 | 0-20 | 0-10 |
| NaCl | 0-29 | 50-99 | 0-29 | 0-40 |
| Na2SO4 | 0-10 | 0-10 | 0-10 | 0-5 |
| Urea | 0-29 | 0-29 | 0-99 | 0-40 |
| Polysaccharide | 0-29 | 0-29 | 0-29 | 0-5 |
| Zeolite | 0-29 | 0-29 | 0-29 | 0-5 |
| Plasticizers/Solvents | | | | |
| Starch/Zeolite | 0-29 | 0-29 | 0-29 | 0-5 |
| Silica | 0-5 | 0-5 | 0-5 | 0-5 |
| Metal oxide | 0-29 | 0-29 | 0-29 | 0-29 |
| Metal catalyst | 0.001-0.5 | 0.001-0.5 | 0.001-0.5 | 0.001-0.5 |
| Opacifier | 0-5 | 0-5 | 0-1 | 0-1 |
| Perfume System (10) | 0-5 | 0-5 | 0-5 | 0-5 |
| Total Silicone compound according | 0.001-10 | 0.001-4.5 | 0.001-3 | 0.001-7.5 |
| to Examples 3-4 and optional | | | | |
| microcapsules | | | | |
| Balance Water* | * | * | * | * |
| | COMPOSITION | | | |
| | 5 | 6 | 7 | 8 |
| | % Wt | % Wt | % Wt | % Wt |
| | Active | Active | Active | Active |
| Component | | | | |
| Polyethylene glycol | 70-99 | 0-20 | 0-29 | 0-40 |
| Clay | 0-29 | 0-20 | 0-20 | 1-10 |
| NaCl | 0-29 | 50-99 | 1-29 | 0-40 |
| Na2SO4 | 0-10 | 0-10 | 0-10 | 0-5 |
| Urea | 0-29 | 0-29 | 0-99 | 0-40 |
| Polysaccharide | 0-29 | 0-29 | 0-29 | 0-5 |
| Zeolite | 0-29 | 0-29 | 0-29 | 0-5 |
| Plasticizers/Solvents | | | | |
| Starch/Zeolite | 0-29 | 0-29 | 0-29 | 0-5 |
| Silica | 0-5 | 0-5 | 0-5 | 0-5 |
| Metal oxide | 0-29 | 0-29 | 0-29 | 0-29 |
| Metal catalyst | 0-0.5 | 0-0.5 | 0.001-0.5 | 0.001-0.5 |
| Opacifier | 0-5 | 0-5 | 0-1 | 0-1 |
| Total Silicone compound according | 0.001-10 | 0.001-4.5 | 0.001-3 | 0.001-7.5 |
| to Examples 3-4 | | | | |
| Balance Water* | * | * | * | * |

(1) PEG
(2) Clay
(3) Urea
(4) Polysaccharide, mostly starches, unmodified starches, starch derivatives, acid-modified starch and kappa carrageenan
(5) Zeolite
(6) Starch/Zeolite - SEA
(7) Metal oxides - non-limiting examples - TiO2, ZnO, MnO
(8) Metal catalysts
(9) Opacifier
(10) Perfume system is selected from one or more of the following: free perfume, and perfume in one or more of the following delivery systems microencapsulates, polymer assisted delivery, molecular assisted delivery, cyclodextrin, starch encapsulated delivery, zeolite and/or inorganic.

### Examples 11

### Unit Dose Compositions

| Example of Unit Dose detergents | A | B | C | D |
|---|---|---|---|---|
| alkyl polyethoxylate nonionic | 5 | 15 | 25 | 25 |
| surfactant | | | | |
| Alkyl ethoxy sulfate | 15 | 10 | — | |
| Linear Alkylbenzene sulfonic | 20 | 15 | 25 | 15 |
| acid | | | | |
| Citric Acid | 1 | 0.5 | — | 3 |
| Fatty Acid | 5 | 10 | 10 | 15 |
| Enzymes | 1 | 1.5 | 1 | 0.5 |
| Chelant | 2 | 2 | 0.5 | 1 |
| Hydrogenated Castor Oil | 0.2 | 0.2 | — | — |
| Organic solvent (propanediol, | 25 | 25 | 15 | 25 |
| glycerol, dipropyleneglycol, | | | | |
| ethanol) | | | | |
| Mono Ethanol Amine | 10 | 6 | 8 | 7 |
| Total Silicone compound | 0.0001 to 0.9 | 0.003 to 0.9 | 0.001 to 0.02 | 0.0003 to 0.3 |
| according to Examples 3-4 | | | | |
| Water and minors (perfume | Up to 100% | Up to 100% | Up to 100% | Up to 100% |
| system*, dye, preservatives, | | | | |
| . . . ) | | | | |

*Perfume system is selected from one or more of the following: free perfume, and perfume in one or more of the following delivery systems microencapsulates, polymer

### Example 12

### Performance Example Malodor Control (MOC) Oils Reacted with Silicone Polymer vs. MOC oils Added as a Free Oil

Two MOC oils, MOC A and MOC B, are provided with compositions according to Table 12A.

TABLE 12A
Compositions of MOC A oil and MOC B oil.

| | | MOC A Oil | MOC B Oil |
|---|---|---|---|
| Ingredient | CAS Number | Wt % | Wt % |
| 1H-indene-ar-propanal, 2,3-dihydro-1,1-dimethyl- | 300371-33-9 | 0.25 | 0.40 |
| 3-(7,7-dimethyl-4-bicyclo[3.1.1]hept-3-enyl)-2,2- | 33885-52-8 | 25.00 | 35.00 |
| dimethylpropanal | | | |
| 1-(2,6,6-trimethyl-1-cyclohex-2-enyl)pent-1-en-3-one | 7779-30-8 | 15.00 | 0.00 |
| 3,4,4a,5,6,7,8,8a-octahydrochromen-2-one | 4430-31-3 | 10.00 | 0.00 |
| 3-methyl-5-phenylpentan-1-ol | 55066-48-3 | 10.50 | 0.00 |
| 1-(5,5-dimethyl-1-cyclohexenyl)pent-4-en-1-one | 56973-85-4 | 0.05 | 0.05 |
| 2,2-dimethyl-3-(3-methylphenyl)propan-1-ol | 103694-68-4 | 31.20 | 0.00 |
| 2,2,8,8-tetramethyl-octahydro-1H-2,4a- | 29461-14-1 | 8.00 | 0.00 |
| methanonapthalene-10-one | | | |
| (E)-1-(2,6,6-trimethyl-1-cyclohex-2-enyl)pent-1-en-3- | 127-42-4 | 0.00 | 25.00 |
| one (74-80%) | | | |
| 2,2,7,7-tetramethyltricyclo[6.2.1.01,6]undecan-5-one | 23787-90-8 | 0.00 | 39.55 |
| Total | N/A | 100.00 | 100.00 |

MOC A and MOC B are reacted with a silicone according to instructions of the present disclosure to provide a silicone+MOC oil compound having the general structure provided below, where substituent R is independently a component oil following the reaction.

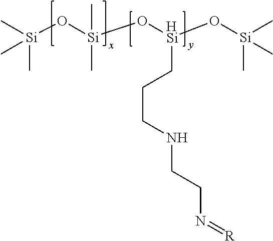

Detergents, some with the free oils or the oils reacted with silicone, are prepared according to the formulation in Table 12B. The performance of the detergents, as measured by Blocking Index (BI), are also provided in Table 12B.

TABLE 12B

| | Composition | | | | |
|---|---|---|---|---|---|
| | 1 | 2 | 3 | 4 | 5 |
| | (control) | (comp.) | (comp.) | (inv.) | (inv.) |
| Ingredient | % Wt | % Wt | % Wt | % Wt | % Wt |
| C11.8 HLAS | 8.36 | 8.36 | 8.36 | 8.36 | 8.36 |
| NI C24 EO9 | 0.50 | 0.50 | 0.50 | 0.50 | 0.50 |
| HDL AE1.8S Na (paste) | 14.05 | 14.05 | 14.05 | 14.05 | 14.05 |
| C12/14 amine oxide | 0.83 | 0.83 | 0.83 | 0.83 | 0.83 |
| Citric acid | 2.51 | 2.51 | 2.51 | 2.51 | 2.51 |
| C12-18 fatty acid | 1.10 | 1.10 | 1.10 | 1.10 | 1.10 |
| DTPA | 0.57 | 0.57 | 0.57 | 0.57 | 0.57 |
| Mannanase | 0.002 | 0.002 | 0.002 | 0.002 | 0.002 |
| Protease (54.5 mg/g active) | 0.057 | 0.057 | 0.057 | 0.057 | 0.057 |
| Amylase (29.3 mg/g active) | 0.008 | 0.008 | 0.008 | 0.008 | 0.008 |
| Xyloglucanase (20 mg/g active) | 0.002 | 0.002 | 0.002 | 0.002 | 0.002 |
| Sodium tetraborate | 1.21 | 1.21 | 1.21 | 1.21 | 1.21 |
| Sodium cumene sulfonate | 0.1-0.5 | 0.1-0.5 | 0.1-0.5 | 0.1-0.5 | 0.1-0.5 |
| Calcium formate solution | 0.14 | 0.14 | 0.14 | 0.14 | 0.14 |
| Monoethanol amine | 2.44 | 2.44 | 2.44 | 2.44 | 2.44 |
| PEI 600 EO20 | 2.60 | 2.60 | 2.60 | 2.60 | 2.60 |
| Ethyoxylated/propoxylated PEI | 1.66 | 1.66 | 1.66 | 1.66 | 1.66 |
| Brightener 49 premix | 0.09 | 0.09 | 0.09 | 0.09 | 0.09 |
| Brightener 15 premix | 0.23 | 0.23 | 0.23 | 0.23 | 0.23 |
| Diethylene glycol | 2.42 | 2.42 | 2.42 | 2.42 | 2.42 |
| Ethanol | 1.86 | 1.86 | 1.86 | 1.86 | 1.86 |
| Structurant (hydrogenated oil premix) | 0.044 | 0.044 | 0.044 | 0.044 | 0.044 |
| MOC A oil | — | 0.017 | — | — | — |
| MOC B oil | — | — | 0.017 | — | |
| MOC A + Silicone Reactant* | — | — | — | 0.017 | — |
| MOC B + Silicone Reactant* | — | — | — | — | 0.017 |
| Blocking Index (BI) | 3.0 | 2.8 | 2.5 | 2.2 | 1.5 |

*Wt % is based on active oil level of reacted product.

As shown by the BI results in Table 12B, Compositions 4 and 5, which included the MOC oils reacted with silicone, showed improved Blocking Index performance compared to the control and comparative compositions.

The dimensions and values disclosed herein are not to be understood as being strictly limited to the exact numerical values recited. Instead, unless otherwise specified, each such dimension is intended to mean both the recited value and functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is calimed is:

1. A silicone compound comprising:
a) a silicone moiety;
b) a moiety comprising a substituted organic moiety that comprises a benefit agent fragment; and
c) a moiety comprising a cleavable bond, said moiety comprising said cleavable bond linking said silicone moiety and said moiety comprising said substituted organic moiety.

2. A silicone compound according to claim 1, wherein said substituted organic moiety is selected from the group consisting of a substituted C₁-C₃₂ alkyl, a substituted C₅-C₃₂ aryl, and a substituted C₆-C₃₂ alkylaryl, each of said substituted C₁-C₃₂ alkyl, a substituted C₅-C₃₂ aryl, and a substituted C₆-C₃₂ alkylaryl comprising a substitutant selected from the group consisting of: 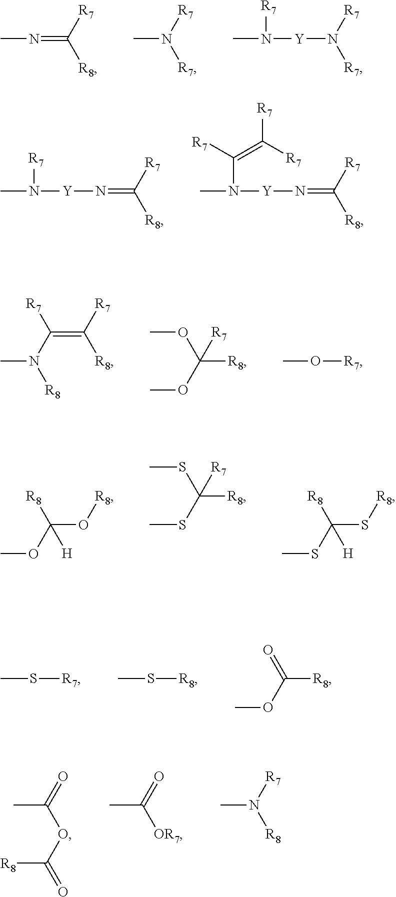
and combinations thereof; wherein: each R₇ is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl; each Rs is independently selected from the group consisting of C₁-C₃₂ alkyl, C₁-C₃₂ substituted alkyl, C₆-C₃₂ aryl,C₅-C₃₂ substituted aryl, C₆-C₃₂ alkylaryl, and C₅-C₃₂ substituted alkylaryl.

3. The silicone compound according to claim 1 wherein said silicone moiety has the formula:
[R₁R₂R₃SiO_{1/2}]₍ⱼ₊₂₁₊₂₎[R₄R₅SiO_{2/2}]ₘ[R₆SiO_{3/2}]ⱼ[SiO_{4/2}]ₗ
wherein:
a) j is an integer from 0 to 150;
b) m is an integer from 0 to 1500;
c) 1 is an integer from 0 to 150;
with the provisio j+m+l equals an integer greater than or equal to 1;
d) each of R₁, R₂, R₃, R₄, R₅ and R₆ moiety is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy,and —Xₜ-A-Y, wherein index t is 0 or 1, with the provisio that at least one of the moieties R₁ through R₆=—Xₜ-A-Y;
(i) each X moiety is independently, a substituted or unsubstituted divalent alkylene radical comprising, 1-24 carbon atoms;
(ii) each A moiety is independently selected from the group consisting of 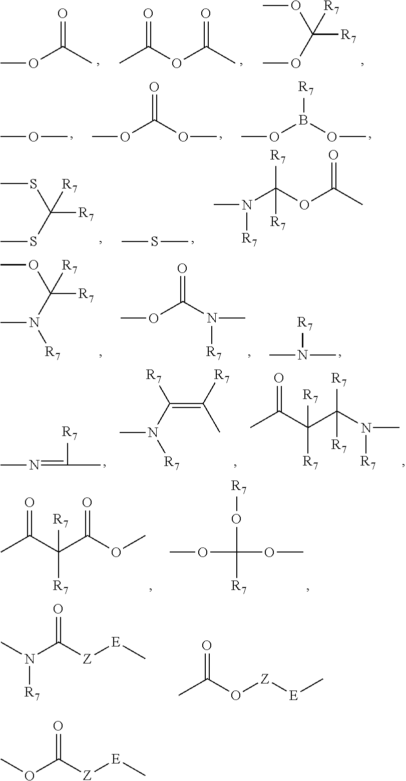
wherein, E=electron withdrawing group, 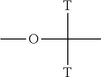
wherein T is selected from an electron withdrawing group E or R₇, with the proviso that at least one T is E; each R₇ moiety for each a moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; and
each Z for each A moiety is independently selected from the group consisting of: 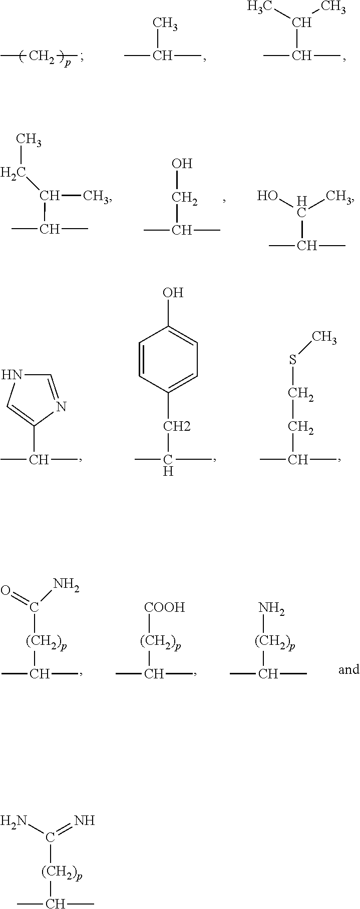
where p is an integer from 1-32;
(ii) each Y moiety is independently selected from the group consisting of a C₁-C₃₂ alkyl, a C₅-C₃₂ aryl, and a C₆-C₃₂ alkylaryl comprising at least one substituent selected from the group consisting of 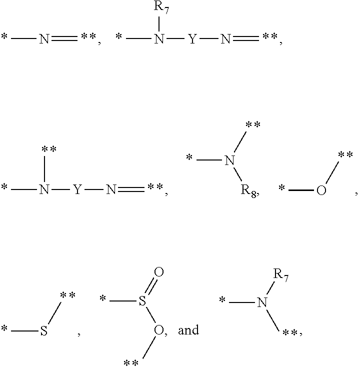
wherein said bonds having a single asterisk indicates a bond to A and said bonds having a double asterisk represent bonds to a benefit agent fragment.

4. A silicone compound according to claim 3 wherein each A moiety is independently selected from the group consisting of

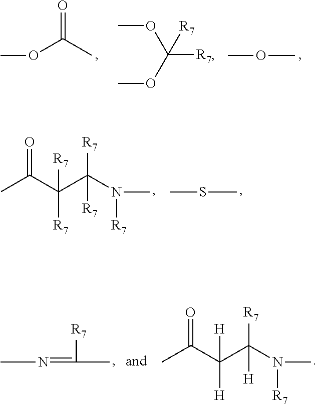

5. A silicone compound according to claim 2, wherein said substituted organic moiety is selected from the group consisting of a substituted C₁-C₃₂ alkyl, a substituted C₅-C₃₂ aryl, and a substituted C₆-C₃₂ alkylaryl, each of said substituted C₁-C₃₂ alkyl, a substituted C₅-C₃₂ aryl, and a substituted C₆-C₃₂ alkylaryl comprising a substitutant selected from the group consisting of: 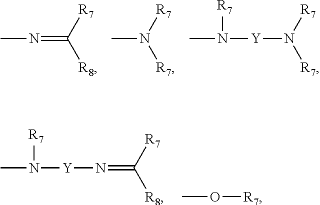
and combinations thereof; wherein: each R₇ is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl; each R₈ is independently selected from the group consisting of C₁-C₃₂ alkyl, C₁-C₃₂ substituted alkyl, C₆-C₃₂ aryl,C₅-C₃₂ substituted aryl, C₆-C₃₂ alkylaryl, and C₅-C₃₂ substituted alkylaryl.

6. The silicone compound according to claim 3 wherein for said silicone moiety
a) j is an integer from 0 to 20;
b) m is an integer from 20 to 400;
c) 1 is an integer from 0 to 20;
d) each of R₁, R₂, R₃, R₄, R₅ and R₆ moiety is independently selected from the group consisting of OH, C₁-C₃₂ alkyl and —Xₜ-A-Y,
wherein the index t is 0 or 1, with the provisio that at least one of the moieties R₁ through R₆=—Xₜ-A-Y;
(i) each X moiety is independently, a substituted or unsubstituted divalent alkylene radical comprising 2-12 carbon atoms;
(ii) each A moiety is independently selected from the group consisting of 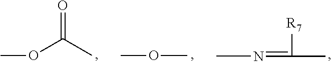
(ii) each Y moiety is independently selected from the group consisting of a C₁-C₃₂ alkyl, a C₅-C₃₂ aryl, and a C₆-C₃₂ alkylaryl comprising at least one substituent selected from the group consisting of

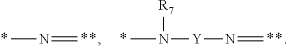

7. A silicone compound according to claim 6, wherein said substituted organic moiety is selected from the group consisting of a substituted C₁-C₃₂ alkyl, a substituted C₅-C₃₂ aryl, and a substituted C₆-C₃₂ alkylaryl, each of said substituted C₁-C₃₂ alkyl, a substituted C₅-C₃₂ aryl, and a substituted C₆-C₃₂ alkylaryl comprising a substitutant selected from the group consisting of: 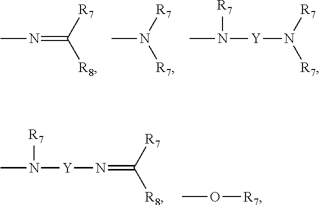
and combinations thereof; wherein: each R₇ is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, and C₅-C₃₂ substituted alkylaryl; each Rs is independently selected from the group consisting of C₁-C₃₂ alkyl, C₁-C₃₂ substituted alkyl, C₆-C₃₂ aryl,C₅-C₃₂ substituted aryl, C₆-C₃₂ alkylaryl, and C₅-C₃₂ substituted alkylaryl.

8. The silicone compound according to claim 1, wherein said benefit agent fragment is a fragment of a benefit agent selected from the group consisting of a silicones, perfume raw materials, deodorants, odor counteractants, malodors, essential oils, ethers, esters, ketones, alcohols, glycols, silicone hydrocarbons, cyclic hydrocarbons, aldehydes, terpines, insecticides, insect repellants, pesticides, antimicrobial agents, fungicides, herbicides and mixtures thereof.

9. The silicone compound according to claim 1, wherein said benefit agent fragment is a fragment of a benefit agent that comprises a moiety selected from the group consisting of a vinyl ether, ketone, hydroxyl, aldehyde, thiol, carboxyl, silanol, alkoxy, acetoxy and mixtures thereof.

10. The silicone compound according to claim 1, wherein said benefit agent fragment is a fragment of a benefit agent selected from the group consisting of 2-(p-tolyl)propan-2-ol; (2-hydroxy-4-methoxyphenyl)(phenyl)methanone; 4-methyl-1-oxaspiro115.51undecan-4-ol; 7-methyl-2H-benzo[b][1,41dioxepin-3(4H)-one; 1,8-dioxacycloheptadecan-9-one; 4-(tert-pentyl)cyclohexan-1-one; 3,7-dimethyloctanal; octanal; 2-methyl-6-methyleneoct-7-en-2-ol; tetradecanal; 2,2,6,8-tetramethyl-1,2,3,4,4a,5,8,8a-octahydronaphthalen-1-ol; (E)-2,6-dimethylocta-5,7-dien-2-ol; (E)-2,7-dimethylocta-1,5,7-trien-3-ol; (4R,4aS,6R)-4,4a-dimethyl-6-(prop-1-en-2-yl)-4,4a,5,6,7,8-hexahydronaphthalen-2(3H)-one; nonan-1-ol; nonanal; 3,3-Dimethyl-5(2,2,3-Trimethyl-3-Cyclopenten-1yl)-4-Penten-2-ol; 1-(3-methylbenzofuran-2-yl)ethan-1-one; (E)-3,7,11-trimethyldodeca-1,6,10-trien-3-ol; (Z)-3,7-dimethylocta-2,6-dien-1-ol; 2-(2-(4-methylcyclohex-3-en-1-yl)propyl)cyclopentan-1-one; 6,6-dimethylbicyclol3.1.11hept-2-ene-2-carbaldehyde; (E)-4-(2,2,3,6-tetramethylcyclohexyl)but-3-en-2-one; (Z)-1-(2,6,6-trimethylcyclohex-1-en-1-yl)pent-1-en-3-one; 1,7-dioxacycloheptadecan-8-one; 1-(4-(tert-butyl)-2,6-dimethyl-3,5-dinitrophenyl)ethan-1-one; 3-methylcyclopentadecan-1-one; (E)-3-methylcyclopentadec-4-en-1-one; (E)-3,7-dimethylocta-4,6-dien-3-ol; 3-methyl-4-phenylbutan-2-ol; 1-(4-isopropylcyclohexyl)ethan-1-ol; 1-(4-isopropylcyclohexyl)ethan-1-ol; 2-methyldecanal; 4-phenylbutan-2-ol; undecan-2-one; 2-methylundecanal; 1-hydroxydecan-3-one; 1-(naphthalen-2-yl)ethan-1-one; 6-methoxy-2,6-dimethylheptanal; 7-methoxy-3,7-dimethyloctanal; 7-isopropyl-10-methyl-1,5-dioxaspirol5.51undecan-3-ol; octahydro-1H-4,7-methanoindene-1-carbaldehyde; ((1s,4s)-4-isopropylcyclohexyl)methanol; 3-(3-(tert-butyl)phenyl)-2-methylpropanal; 2,2-dimethyl-3-(m-tolyl)propan-1-ol; 8-isopropyl-6-methylbicyclol2.2.2loct-5-ene-2-carbaldehyde; 4-(4-hydroxy-4-methylpentyl)cyclohex-3-ene-1-carbaldehyde; (Z)-3-hexen-1-yl-2-cyclopenten-1-one; 2-(5-methyl-5-vinyltetrahydrofuran-2-yl)propan-2-ol; 6-methyl-2-(oxiran-2-yl)hept-5-en-2-ol; 3,7-dimethylocta-1,6-dien-3-ol; 3-(4-methylcyclohex-3-en-1-yl)butanal; (2,5-dimethyl-1,3-dihydroinden-2-yl)methanol; 3-(4-(tert-butyl)phenyl)-2-methylpropanal; 2-Methyl-5-(1-methylethenyl)-2-cyclohexenone; (1S,5R)-2-methyl-5-(prop-1-en-2-yl)cyclohex-2-en-1-ol; dodecan-1-ol; 5-hexyl-5-methyldihydrofuran-2(3H)-one; dodecanal; 3,6-dimethylhexahydrobenzofuran-2(3H)-one; 4-(1-ethoxyvinyl)-3,3,5,5-tetramethylcyclohexan-1-one; ((3S,3aR,6R,8aS)-7,7-dimethyl-8-methyleneoctahydro-1H-3a,6-methanoazulen-3-yl)methanol; (1-methyl-24(1,2,2-trimethylbicyclo[3.1.0]hexan-3-yl)methyl)cyclopropyl)methanol; (E)-6-(pent-3-en-1-yl)tetrahydro-2H-pyran-2-one; 2-hexylcyclopentan-1-one; (Z)-4-(6,6-dimethylcyclohex-2-en-1-yl)-3-methylbut-3-en-2-one; (1R,2S,5R)-5-methyl-2-(prop-1-en-2-yl)cyclohexan-1-ol; 4,9-dimethoxy-7H-furo[3,2-g]chromen-7-one; (E)-cyclohexadec-8-en-1-one; (2S,5S)-2-isopropyl-5-methylcyclohexan-1-one; 2-hexylcyclopent-2-en-1-one; (2S,5S)-2-isopropyl-5-methylcyclohexan-1-one; 4-(4-methylpent-3-en-1-yl)cyclohex-3-ene-1-carbaldehyde; 1-((2S,3S)-2,3,8,8-tetramethyl-1,2,3,4,5,6,7,8-octahydronaphthalen-2-yl)ethan-1-one; 2,5,6-trimethylcyclohex-3-ene-1-carbaldehyde; 4-((2R)-1,7,7-trimethylbicyclo[2.2.1]heptan-2-yl)cyclohexan-1-ol; 1,7,7-trimethylbicyclo[2.2.1]heptan-2-ol; (E)-oxacycloheptadec-10-en-2-one; (E)-8-(1H-indo1-1-yl)-2,6-dimethyloct-7-en-2-ol; 8,8-di(1H-indo1-1-yl)-2,6-dimethyloctan-2-ol; (7,7,8,8-tetramethyloctahydro-2,3b-methanocyclopenta[1,3]cyclopropa[1,2]benzen-4-yemethanol; 3,7-dimethyloctane-1,7-diol; 2-cyclododecylpropan-1-ol; 3-phenylpropan-1-ol; 5-ethyl-4-hydroxy-2-methylfuran-3(2H)-one; 2,3-dihydro-3,3-dimethyl-1H-indene-5-propanal; 3-(3,3-dimethyl-2,3-dihydro-1H-inden-5-yl)propanal; (Z)-2-benzylideneoctanal; oxacycloheptadecan-2-one; 3-(benzo[d][1,3]dioxo1-5-yl)-2-methylpropanal; (E)-oxacyclohexadec-13-en-2-one; 2-((3S,5R,8S)-3,8-dimethyl-1,2,3,4,5,6,7,8-octahydroazulen-5-yl)propan-2-ol; 1-(2,6,6-trimethylcyclohex-2-en-1-yl)pentan-3-one; (6E,10E)-3,7,11,15-tetramethylhexadeca-1,6,10,14-tetraen-3-ol; (E)-2-(3,7-dimethylocta-2,6-dien-1-yl)cyclopentan-1-one; 5-heptyldihydrofuran-2(3H)-one; 1-methyl-4-(propan-2-ylidene)cyclohexan-1-ol; 5-pentyldihydrofuran-2(3H)-one; 5-[(Z)-hex-3-enyl]oxolan-2-one; (Z)-4-(2,2-dimethyl-6-methylenecyclohexyl)but-3-en-2-one; 2-((2R,4aR)-4a,8-dimethyl-1,2,3,4,4a,5,6,7-octahydronaphthalen-2-yl)propan-2-ol; 5-octyldihydrofuran-2(3H)-one; (Z)-1-(2,2-dimethyl-6-methylenecyclohexyl)but-2-en-1-one; 5-hexyldihydrofuran-2(3H)-one; 1-(3,3-dimethylcyclohexyl)pent-4-en-1-one; (6-isopropyl-9-methyl-1,4-dioxaspiro[4.5]decan-2-yl)methanol; 2-isobutyl-4-methyltetrahydro-2H-pyran-4-ol; (Z)-6-ethylideneoctahydro-2H-5,8-methanochromen-2-one; 3-(2-ethylphenyl)-2,2-dimethylpropanal; 3-(2-ethylphenyl)-2,2-dimethylpropanal; (E)-4,8-dimethyldeca-4,9-dienal; (E)-4-((3aR,4R,7R,7aR)-1,3a,4,6,7,7a-hexahydro-5H-4,7-methanoinden-5-ylidene)-3-methylbutan-2-ol; 2-heptylcyclopentan-1-one; 1,3,3-trimethylbicyclo[2.2.1]heptan-2-ol; (2E,6E)-3,7,11-trimethyldodeca-2,6,10-trien-1-ol; oxacyclohexadecan-2-one; (E)-cyclopentadec-4-en-1-one; 1-cyclopentadec-4-en-1-one; 2-methoxy-4-(4-methylenetetrahydro-2H-pyran-2-yl)phenol; 4-allyl-2-methoxyphenol; 1,4-dioxacycloheptadecane-5,17-dione; (E)-3,7-dimethylnona-1,6-dien-3-ol; nonan-3-one; 2-41R,3S,4S)-4-methyl-3-(prop-1-en-2-yl)-4-vinylcyclohexyl)propan-2-ol; (E)-3-methyl-5-(2,2,3-trimethylcyclopent-3-en-1-yl)pent-4-en-2-ol; (2R,3S,4R)-2,3,4,5-tetrahydroxypentanal; (E)-4-((3aS,7aS)-octahydro-5H-4,7-methanoinden-5-ylidene)butanal; (2R,5R)-2-methyl-5-(prop-1-en-2-yl)cyclohexan-1-one; 2-(2-hydroxypropoxy)propan-1-ol; 7,9-dimethylspiro[5.5]undecan-3-one; 2,6-dimethyloct-7-en-4-one; 2,6-dimethyloct-7-en-2-ol; 3-methyl-2-pentylcyclopent-2-en-1-one; 3,3,5-trimethylcyclohexan-1-one; 2-methoxy-4-propylphenol; 2-methyl-5-(prop-1-en-2-yl)cyclohexan-1-one; 2-methyl-5-(prop-1-en-2-yl)cyclohexan-1-ol; 4-(2,6,6-trimethylcyclohex-2-en-1-yl)butan-2-one; 3,7-dimethyloct-6-en-3-ol; 6-hexyltetrahydro-2H-pyran-2-one; 6-heptyltetrahydro-2H-pyran-2-one; 6-pentyltetrahydro-2H-pyran-2-one; (Z)-1-((lR,2S)-2,6,6-trimethylcyclohex-3-en-1-yl)but-2-en-1-one; dec-9-en-1-ol; decahydronaphthalen-2-ol; 3-(4-isopropylphenyl)-2-methylpropanal; cyclopentadecanone; 1,4-dioxacyclohexadecane-5,16-dione; 8,8-dimethyl-1,2,3,4,5,6,7,8-octahydronaphthalene-2-carbaldehyde; (4-isopropylphenyl)methanol; 1-(benzofuran-2-yl)ethan-1-one; 4-cyclohexyl-2-methylbutan-2-ol; (E)-cycloheptadec-9-en-1-one; 3-(4-methylcyclohex-3-en-1-yl)butan-1-ol; 3,7-dimethyloct-6-en-1-ol; 3,7-dimethyloct-6-enal; (Z)-3-methyl-2-(pent-2-en-1-yl)cyclopent-2-en-1-one; (E)-oxacycloheptadec-11-en-2-one; (Z)-non-6-en-1-ol; (1R,5R)-2-methyl-5-(prop-1-en-2-yl)cyclohex-2-en-1-ol; (Z)-dec-4-enal; (3Z,6Z)-nona-3,6-dien-1-ol; (E)-3-phenylprop-2-en-1-ol; 4-chloro-3,5-dimethylphenol; hexadecan-1-ol; (E)-1-(2,6,6-trimethylcyclohex-2-en-1-yl)hepta-1,6-dien-3-one; 2-methyl-4-(2,6,6-trimethylcyclohex-1-en-1-yl)butanal; 1,6-dioxacycloheptadecan-7-one; 1-(6-(tert-butyl)-1,1-dimethyl-2,3-dihydro-1H-inden-4-yl)ethan-1-one; (3R,3aS,6R,7R,8aS)-3,6,8,8-tetramethyloctahydro-1H-3a,7-methanoazulen-6-ol; 1,1,2,3,3-pentamethyl-1,2,3,5,6,7-hexahydro-4H-inden-4-one; (1S,2S,5R,8S)-4,4,8-trimethyltricyclo[6.3.1.02,5]dodecan-1-ol; 5-isopropyl-2-methylphenol; 2-methyl-5-(prop-1-en-2-yl)cyclohex-2-en-1-one; octan-1-ol; decanal; 3-(4-methoxyphenyl)-2-methylpropanal; 1,7,7-trimethylbicyclo[2.2.1]heptan-2-one; 2,6-di-tert-butyl-4-methylphenol; 2-methyl-4-(2,2,3-trimethylcyclopent-3-en-1-yl)butan-1-ol; 3-(4-(tert-butyl)phenyl)propanal; (E)-2-methyl-4-(2,6,6-trimethylcyclohex-1-en-1-yl)but-2-enal; (1S,2R,4S)-1,7,7-trimethylbicyclo[2.2.1]heptan-2-ol; (5R,10R)-6,10-dimethyl-2-(propan-2-ylidene)spiro[4.5]dec-6-en-8-one; 1-methyl-4-(prop-1-en-2-yl)cyclohexan-1-ol; (2Z,6E)-2,6-dimethyl-10-methylenedodeca-2,6,11-trienal; (Z)-2-methyl-54(1S,2R,4R)-2-methyl-3-methylenebicyclo[2.2.1]heptan-2-yl)pent-2-en-1-ol; (S)-4-methyl-1-((S)-6-methylhept-5-en-2-yl)cyclohex-3-en-1-ol; (Z)-4-(2,2,6-trimethyl-7-oxabicyclo[4.1.0]heptan-1-yl)but-3-en-2-one; 4-methoxy-7H-furo[3,2-glchromen-7-one; 2-methyl-4-phenylbutan-2-ol; 2-methyl-1-phenylpropan-2-ol; benzophenone; 7-isopentyl-2H-benzo[1,4[dioxepin-3(4H)-one; 2,5,5-trimethyl-1,2,3,4,5,6,7,8-octahydronaphthalen-2-ol; 2,5,5-trimethyl-1,2,3,4,4a,5,6,7-octahydronaphthalen-2-ol; 1-((2-(tert-butyl)cyclohexyl)oxy)butan-2-ol; (1S,4R,5R)-1-isopropyl-4-methylbicyclo[3.1.0]hexan-3-one; (4R,4aS)-4,4a-dimethyl-6-(propan-2-ylidene)-4,4a,5,6,7,8-hexahydronaphthalen-2(3H)-one; (2Z,6E,9E)-2,6,10-trimethyldodeca-2,6,9,11-tetraenal; (E)-5-(2,3-dimethyltricyclo[2.2.1.02,6]heptan-3-yl)-2-methylpent-2-en-1-ol; 1-(5,5-dimethylcyclohex-1-en-1-yl)pent-4-en-1-one; (R,Z)-1-(2,6,6-trimethylcyclohex-2-en-1-yl)pent-1-en-3-one; (Z)-3-methyl-4-(2,6,6-trimethylcyclohex-2-en-1-yl)but-3-en-2-one; (Z)-4-(2,5,6,6-tetramethylcyclohex-2-en-1-yl)but-3-en-2-one; 2-((2R,4aR,8aR)-4a,8-dimethyl-1,2,3,4,4a,5,6,8a-octahydronaphthalen-2-yl)propan-2-ol; (1R,4S,4aR,8aR)-4-isopropyl-1,6-dimethyl-1,2,3,4,4a,7,8,8a-octahydronaphthalen-1-ol; (R)-2-((R)-4-methylcyclohex-3-en-1-yl)hex-5-en-2-ol; (E)-2-benzylideneheptan-1-ol; (E)-2-benzylideneheptanal; 1-methyl-4-(4-methylpent-3-en-1-yl)cyclohex-3-ene-1-carbaldehyde; 1-phenylpentan-2-ol; 3-methyl-1-phenylpentan-3-ol; 2,3,4-trimethoxybenzaldehyde; 2,4,5-trimethoxybenzaldehyde; 2,4,6-trimethoxybenzaldehyde; Trans,Trans-2,4-Nonadienal; 4-methoxy-2,5-dimethylfuran-3(2H)-one; 2,6,10-trimethylundecanal; alpha-4-Dimethyl benzenepropanal; (E)-undec-9-enal; 2,6,10-trimethylundec-9-enal; (Z)-2-(4-methylbenzylidene)heptanal; dec-9-enal; (Z)-oxacycloheptadec-8-en-2-one; 7-methoxy-2H-chromen-2-one; 2-((2S,4aR,8aR)-4a,8-dimethyl-1,2,3,4,4a,5,6,8a-octahydronaphthalen-2-yl)propan-2-ol; 1-(3,5,5,6,8,8-hexamethyl-5,6,7,8-tetrahydronaphthalen-2-yl)ethan-1-one; 6,8-dimethylnonan-2-ol; 3-(6,6-dimethylbicyclo[3.1.1]hept-2-en-2-yl)propanal; 6,10,14-trimethylpentadecan-2-one; (E)-cyclohexadec-5-en-1-one; 1-isopropyl-4-methylcyclohex-3-en-1-ol; 1-phenylpent-4-en-1-one; 5-methyl-5-phenylhexan-3-one; 1-isopropyl-4-methylcyclohex-3-en-1-ol; 4-(4-methoxyphenyl)butan-2-one; (1aR,2S,4aS)-2,4a,8,8-tetramethyloctahydrocyclopropa[d]naphthalen-3(1H)-one; (E)-3-propylideneisobenzofuran-1(3H)-one; (Z)-dodec-2-enal; 3-methyl-5-phenylpentanal; 3,7-dimethyl-2-methyleneoct-6-enal; 3,7-dimethyloctan-1-ol; 3,4,5-trimethoxybenzaldehyde; 3-(4-isopropylphenyl)propanal; (E)-undec-2-enal; (2E,6E)-nona-2,6-dienal; (Z)-3-(furan-2-yl)-2-phenylacrylaldehyde; 2-phenoxyethan-1-ol; (Z)-non-2-enal; nonan-2-ol; nonan-2-one; (E)-2-isopropyl-5-methylhex-2-enal; (E)-2-hexylidenecyclopentan-1-one; (E)-dec-2-enal; (2E,6E)-nona-2,6-dienal; (2E,6E)-nona-2,6-dien-1-ol; 2,6-dimethyloctanal; decan-1-ol; undec-10-en-1-ol; undec-10-enal; 2-((2R,4aS)-4a,8-dimethyl-1,2,3,4,4a,5,6,7-octahydronaphthalen-2-yl)propan-2-ol; 3,7-dimethyloct-6-en-3-ol; (Z)-1-(2,6,6-trimethylcyclohex-2-en-1-yl)but-2-en-1-one; (1S,5S)-4,6,6-trimethylbicyclo[3.1.1]hept-3-en-2-one; (Z)-dodec-3-enal; (S)-5-heptyldihydrofuran-2(3H)-one; (R)-5-heptyldihydrofuran-2(3H)-one; (R)-3,7-dimethylocta-1,6-dien-3-ol; 3,7-dimethyloct-6-enal; (R)-3,7-dimethyloct-6-enal; (2S,5S,6S)-2,6,10,10-tetramethyl-1-oxaspiro[4.5]decan-6-ol; (1S,2S,5S)-2-methyl-5-(prop-1-en-2-yl)cyclohexan-1-ol; 3,7-dimethyloct-6-en-1-ol; 3,7-dimethyloct-6-en-1-ol; (S)-2-methyl-5-(prop-1-en-2-yl)cyclohex-2-en-1-one; (2S,5R)-2-isopropyl-5-methylcyclohexan-1-one; (R,E)-2-methyl-4-(2,2,3-trimethylcyclopent-3-en-1-yl)but-2-en-1-ol; (E)-4-(2,2-dimethyl-6-methylenecyclohexyl)-3-methylbut-3-en-2-one; 3-(3-isopropylphenyl)butanal; 2-((3S,3aS,5R)-3,8-dimethyl-1,2,3,3a,4,5,6,7-octahydroazulen-5-yl)propan-2-ol; 2-hydroxy-1,2-diphenylethan-1-one; 3-(6,6-dimethylbicyclo[3.1.1]hept-2-en-2-yl)-2,2-dimethylpropanal; 1-(1,1,2,3,3,6-hexamethyl-2,3-dihydro-1H-inden-5-yl)ethan-1-one; 2-(m-tolyl)ethan-1-ol; (3E,6E)-nona-3,6-dien-1-ol; (E)-tridec-2-enal; (1R,4S,4aS,6R,8aS)-4,8a,9,9-tetramethyloctahydro-1,6-methanonaphthalen-1(2H)-ol; 5-hexyl-4-methyldihydrofuran-2(3H)-one; 4-(prop-1-en-2-yl)cyclohex-1-ene-1-carbaldehyde; (4-(prop-1-en-2-yl)cyclohex-1-en-1-yl)methanol; 2-cyclohexylhepta-1,6-dien-3-one; 2-phenylethan-1-ol; 3-methyl-5-phenylpentan-1-ol; 2-(6,6-dimethylbicyclo[3.1.1]hept-2-en-2-yl)acetaldehyde; 6,6-dimethyl-2-methylenebicyclo[3.1.1]heptan-3-ol; 4-(benzo[d][1,3]dioxo1-5-yl)butan-2-one; (4aR,8aS)-7-methyloctahydro-1,4-methanonaphthalen-6(2H)-one; 1,2-dimethyl-3-(prop-1-en-2-yl)cyclopentan-1-ol; 4-isopropyl-1-methylcyclohex-3-en-1-ol; (E)-3,3-dimethyl-5-(2,2,3-trimethylcyclopent-3-en-1-yl)pent-4-en-2-ol; (2Z,5Z)-5,6,7-trimethylocta-2,5-dien-4-one; 1-methyl-4-(4-methylpent-3-en-1-yl)cyclohex-3-ene-1-carbaldehyde; propane-1,2-diol; 4-(tert-pentyl)cyclohexan-1-ol; 3,7-dimethyloct-7-en-1-ol; 2-methyl-5-phenylpentan-1-ol; (S)-3,7-dimethylocta-1,6-dien-3-ol; 5-isopropyl-2-methylbicyclo[3.1.0]hexan-2-ol; (1S,3R,5S)-1-isopropyl-4-methylenebicyclo[3.1.0]hexan-3-ol; 2,2,7,9-tetramethylspiro(5.5)undec-8-en-1-one; 3-methyl-5-(2,2,3-trimethylcyclopent-3-en-1-yl)pentan-2-ol; (Z)-2-ethyl-4-(2,2,3-trimethylcyclopent-3-en-1-yl)but-2-en-1-ol; (E)-2-methyl-4-(2,2,3-trimethylcyclopent-3-en-1-yl)but-2-en-1-ol; 5-methoxyoctahydro-1H-4,7-methanoindene-2-carbaldehyde; 5-methoxyoctahydro-1H-4,7-methanoindene-2-carbaldehyde; 1-(3-hydroxy-3-methylpent-4-en-1-yl)-2,5,5,8a-tetramethyldecahydronaphthalen-2-ol; 3-(4-isobutylphenyl)-2-methylpropanal; (1aR,4aR,7S,7aR,7bR)-1,1,7-trimethyl-4-methylenedecahydro-1H-cyclopropa[e]azulen-7-ol; 1-(spiro[4.5]dec-7-en-7-yl)pent-4-en-1-one; 2-(4-methylthiazol-5-yl)ethan-1-ol; (Z)-dodec-4-enal; (1S,4S,4aR,8aR)-4-isopropyl-1,6-dimethyl-1,2,3,4,4a,7,8,8a-octahydronaphthalen-1-ol; (1S,4S,4aR,8aS)-4-isopropyl-1,6-dimethyl-1,2,3,4,4a,7,8,8a-octahydronaphthalen-1-ol; 3,7-dimethyloctanal; 4-(2,2,6-trimethylcyclohexyl)butan-2-ol; 3-methyl-2-pentylcyclopentan-1-one; 3,7-dimethyloctan-3-ol; 2-(2-mercaptopropan-2-yl)-5-methylcyclohexan-1-one; 2-isopropyl-5-methylphenol; 1-(2,2,6-trimethylcyclohexyl)hexan-3-ol; (2Z,4E)-nona-2,4-dienal; (2E,6E)-3,7,11-trimethyldodeca-2,6,10-trien-1-ol; (2E,6Z)-nona-2,6-dienal; (Z)-dec-2-enal; (E)-non-2-enal; (1R,2S)-2-(tert-butyl)cyclohexan-1-ol; (3E,6Z)-nona-3,6-dien-1-ol; (E)-dec-4-enal; (Z)-1-(2,6,6-trimethylcyclohex-2-en-1-yl)but-2-en-1-one; (Z)-oxacycloheptadec-8-en-2-one; (2R,5R)-2-methyl-5-(prop-1-en-2-yl)cyclohexan-1-one; (E)-3,7-dimethylocta-2,6-dien-1-ol; 7-(1,1-Dimethylethyl)-2H-1,5-benzodioxepin-3(4H)-one; (1R-(1alpha,3alpha,4aalpha))-2,3,4,4a,5,6-hexahydro-2,2-dimethyl-1,3-methanonaphthalen-7(1H)-one; tridecan-1-ol; 1-((2E,5Z,9Z)-2,6,10-trimethylcyclododeca-2,5,9-trien-1-yl)ethan-1-one; 2-mercapto-2-methylpentan-1-ol; 13-methyl oxacyclopentadec-10-en-2-one; undecanal; (E)-4-methyldec-3-en-5-ol; 2-((2R,8R,8aS)-8,8a-dimethyl-1,2,3,4,6,7,8,8a-octahydronaphthalen-2-yl)propan-2-ol; 2,2,5-trimethyl-5-pentylcyclopentan-1-one; (Z)-2-methyl-4-(2,6,6-trimethylcyclohex-2-en-1-yl)but-2-enal; (1R,5R)-4,6,6-trimethylbicyclo[3.1.1]hept-3-en-2-one; 2-(tert-butyl)cyclohexan-1-ol; 1-((3R,3aR,7R,8aS)-3,6,8,8-tetramethyl-2,3,4,7,8,8a-hexahydro-1H-3a,7-methanoazulen-5-yl)ethan-1-one; 4,8-dimethyl-2-(propan-2-ylidene)-1,2,3,3a,4,5,6,8a-octahydroazulen-6-ol; (1aR,4S,4aS,7R,7aS,7bS)-1,1,4,7-tetramethyldecahydro-1H-cyclopropa[e]azulen-4-ol; (1S,2S,3S,5R)-2,6,6-trimethylspiro[bicyclo[3.1.1]heptane-3,1′-cyclohexan]-2′-en-4′-one; 4-(4-hydroxy-3-methoxyphenyl)butan-2-one; 1,3,4,6,7,8alpha-hexahydro-1,1,5,5-tetramethyl-2H-2,4alpha-methanophtalen-8(5H)-one; 2,2′-oxybis(ethan-1-ol); butane-1,3-diol; hexane-1,6-diol; 2,2′-(ethane-1,2-diylbis(oxy))bis(ethan-1-ol); 2-methylpentane-2,4-diol; (2E,4E)-hepta-2,4-dien-1-ol; hexane-1,2,6-triol; (Z)-oct-5-en-1-ol; (E)-oct-3-en-1-ol; (Z)-oct-5-enal; 2,5-dimethyl-1,4-dithiane-2,5-diol; 2-methyloctan-2-ol; (E)-non-2-en-1-ol; (E)-non-6-en-1-ol; (E)-non-3-en-1-ol; (Z)-non-3-en-1-ol; (2E,6Z)-nona-2,6-dien-1-ol; Mannitol; 3,5-dimethylcyclopentane-1,2-dione; 2,2′, 2″-nitrilotris(ethan-1-ol); 3,4,4-trimethylcyclopentane-1,2-dione; 3-Nonen-2-one; (E)-non-5-en-2-one; 2-(cyclohexyloxy)ethan-1-ol; octane-1,8-dithiol; (E)-dec-2-en-1-ol; a-D-Glucopyranose; (E)-dec-5-en-1-ol; 2,3,6-trimethylphenol; (2E,4E)-deca-2,4-dienal; (2E,4Z)-deca-2,4-dienal; decane-1,10-diol; 2-phenylpropan-2-ol; 5-hydroxyoctan-4-one; nonan-3-ol; (Z)-dec-7-enal; (E)-2-methyloct-2-enal; decan-2-ol; 3-(hydroxymethyl)phenol; non-1-en-3-ol; (2-methoxyphenyl)methanol; decan-2-one; 2-(o-tolyl)ethan-1-ol; undecan-1-ol; (E)-dec-3-en-2-one; 3-ethyl-2-hydroxy-4-methylcyclopent-2-en-1-one; 3-phenylpropan-1-ol; 3,5-Octadien-2-ol, 2,6-dimethyl-, (?,Z)—; 3,5-Octadien-2-ol, 2,6-dimethyl-, (?,E)-; Benzenemethanol, 4-methyl-; 2-(benzyloxy)ethan-1-ol; 4,4′-thiobis(butan-2-one); (E)-undec-2-en-1-ol; (2Z,4E)-undeca-2,4-dien-1-ol; (E)-7-methyl-3-methyleneocta-4,6-dien-2-ol; (Z)-undec-2-enal; (E)-undec-2-enal; (2Z,4Z)-undeca-2,4-dienal; (2E,4E)-undeca-2,4-dienal; 3-Cyclohexene-1-propanal; decan-3-ol; (E)-undec-8-enal; cyclodecanol; decan-5-ol; 1-benzyl-2-methyldisulfane; (1S,3S,4R,5R)-1-isopropyl-4-methylbicyclo[3.1.0]hexan-3-ol; Bicyclo[3.2.1]octan-8-ol, 1,5,8-trimethyl-; 1-(p-tolyl)ethan-1-ol; undecan-2-ol; 7-methoxy-3,7-dimethyloctan-2-ol; (E)-3,7-dimethylocta-2,6-dien-1-ol; 4-(2-hydroxyethyl)phenol; 2-(tert-butyl)cyclohexan-1-one; 2,6-dimethylheptan-4-one; 2-(furan-2-yl)-4-methyl-1,3-dioxolane; decan-4-one; (4-methoxyphenyl)methanol; 2-methoxy-2-phenylethan-1-ol; (E)-2-isopropyl-5-methylhex-2-en-1-ol; re1-2-42R,5S)-5-methyl-5-vinyltetrahydrofuran-2-yepropan-2-ol; 4-phenylbutan-1-ol; 2-(p-tolyl)ethan-1-ol; 6-methyl-3-(propan-2-ylidene)-7-oxabicyclo[4.1.0]heptan-2-one; (E)-dodec-2-en-1-ol; (2E,6Z)-nona-2,6-dien-1-yl acetate; 2-(p-tolyloxy)ethan-1-ol; 7-methyl-3-methyleneoct-6-enal; (2E,4E)-dodeca-2,4-dien-1-ol; 3-(hydroxymethyl)nonan-2-one; (E)-dodec-2-enal; (2E,4E)-dodeca-2,4-dienal; (E)-2,6-dimethylocta-1,5,7-trien-3-ol; (E)-5-(methylthio)-2-((methylthio)methyl)pent-2-enal; (E)-3-methylnon-3-enoic acid; 1-methyl-4-(prop-1-en-2-yl)-7-oxabicyclo[4.1.0]heptane; (E)-dodec-3-enal; 4-(hydroxymethyl)-2-methoxyphenol; 3,7-dimethyloctane-1,6-diol; undecan-1-ol; (E)-dodec-4-enal; 4-allylphenol; (2E,6Z)-dodeca-2,6-dienal; 3-(5-methylfuran-2-yl)butanal; (E)-4-phenylbut-3-en-2-ol; 2-pentylcyclopent-2-en-1-one; 2-isopropyl-4-methylphenol; dodecan-2-ol; 3,7-dimethyloct-7-ene-1,6-diol; (E)-2-(pent-2-en-1-yl)cyclopentan-1-one; (1R,2S,3R,5S)-2,6,6-trimethylbicyclo[3.1.1]heptan-3-ol; 1-(furan-2-yl)hexan-1-one; benzo[d][1,3]dioxo1-5-ylmethanol; undecane-2,3-dione; undecan-4-one; (Z)-2,7-dimethyloct-5-en-4-one; (E)-3-methylnon-2-enenitrile; 8-ethyl-1,5-dimethylbicyclo[3.2.1]octan-8-ol; dodecan-2-one; undec-1-en-3-one; 2,6-dimethoxy-4-methylphenol; (1S,2S,5S)-2-methyl-5-(prop-1-en-2-yl)cyclohexan-1-ol; 5-phenylpentan-1-ol; rel-(1R,2S,5R)-5-methyl-2-(prop-1-en-2-yl)cyclohexan-1-ol; (1S,2R,5R)-2,6,6-trimethylbicyclo[3.1.1]heptan-3-one; (2R,5R)-5-isopropyl-2-methylcyclohexan-1-one; allyl octanoate; (E)-2-methyl-3-phenylprop-2-en-1-ol; (2S,5R)-2-isopropyl-5-methylcyclohexan-1-one; (E)-2-(3-methylbut-1-en-1-yl)cyclopentan-1-one; (E)-tridec-2-en-1-ol; 41S,2S,5S)-6,6-dimethylbicyclo[3.1.1]heptan-2-yl)methanol; tridecanal; 2-methylundecan-1-ol; 2-(3,4-dimethylphenyl)acetaldehyde; 2-(2,4-dimethylphenyl)acetaldehyde; 6,6-dimethyl-2-methylenebicyclo[3.1.1]heptan-3-one; 1,3-dihydro-2H-inden-2-one; (2E,4E)-trideca-2,4-dienal; (6,6-dimethylbicyclo[3.1.1]hept-2-en-2-yl)methanol; 3-(p-tolyl)propanal; (4S,4aS,8aR)-4,8a-dimethyloctahydronaphthalen-4a(2H)-ol; (E)-2-(hex-2-en-1-yl)cyclopentan-1-ol; 2-(2-hydroxypropan-2-yl)-5-methylcyclohexan-1-ol; 11-methyldodecan-1-ol; (2E,4Z,7Z)-trideca-2,4,7-trienal; cyclododecanol; 2-(4-methylcyclohex-3-en-1-yl)prop-2-en-1-ol; (R)-2-(4-methylcyclohex-3-en-1-yl)prop-2-en-1-ol; (E)-2-methyl-3-(pent-2-en-1-yl)cyclopent-2-en-1-one; (Z)-2-hexylidenecyclopentan-1-one; (E)-3-methyl-2-(pent-2-en-1-yl)cyclopent-2-en-1-one; (2E,6E)-3,7-dimethylnona-2,6-dienal; dodecan-3-one; 1-phenylpentan-1-one; 2,6-diisopropylphenol; (E)-2-(hex-2-en-1-yl)cyclopentan-1-one; 1-(3,3-dimethylbicyclo[2.2.1]heptan-2-yl)ethan-1-ol; 2-(4-methylenecyclohexyl)propanal; 6-pentyl-2H-pyran-2-one; (S)-4-(prop-1-en-2-yl)cyclohex-1-ene-1-carbaldehyde; 4-methyl-5-pentyldihydrofuran-2(3H)-one; (4aS,8aS)-4,4,8a-trimethyloctahydronaphthalen-4a(2H)-ol; tridecan-2-one; 3-methyl-1-phenylbutan-2-ol; 1-(4-isopropylphenyl)ethan-1-one; (E)-3-(4-methoxyphenyl)acrylaldehyde; (R)-6-pentyl-5,6-dihydro-2H-pyran-2-one; tetradecan-1-ol; (E)-6-(pent-2-en-1-yl)tetrahydro-2H-pyran-2-one; 6-phenylhexan-1-ol; 2-(4-isopropylcyclohexyl)ethan-1-ol; 2-methyl-1-(p-tolyl)propan-2-ol; 1-(3,3-dimethylbicyclol2.2.11heptan-2-yl)ethan-1-one; (E)-2-ethyl-2-(3-methylbut-2-en-1-yl)hex-3-en-1-ol; 2-(4-ethylphenyl)acetaldehyde; 3-ethylhexahydrobenzofuran-2(3H)-one; (E)-3-methyl-1-phenylpent-1-en-3-ol; (2-hexyl-1,3-dioxolan-4-yl)methanol; 6-ethyl-3-methyloct-5-en-1-ol; 1-(3,4-dimethoxyphenyl)ethan-1-one; octahydronaphthalen-2(1H)-one; 2-(4-isopropylphenyl)ethan-1-ol; 1-methyl-4-(prop-1-en-2-yl)-7-oxabicyclol4.1.01heptan-2-one; (E)-5,9-dimethyldeca-4,9-dienal; 5-methyl-3,4-dihydronaphthalen-1(2H)-one; 8-methyl-3,4-dihydronaphthalen-1(2H)-one; (E)-tetradec-2-enal; 4-(tert-butyl)cyclohexane-1-carbaldehyde; 2-(6,6-dimethylbicyclo[3.1.1]hept-2-en-2-yl)ethan-1-ol; (4,7,7-trimethylbicyclol4.1.01hept-4-en-3-yl)methanol; (Z)-2-(3,3-dimethylbicyclol2.2.11heptan-2-ylidene)ethan-1-ol; (3 aR,7aR)-octahydro-5H-4,7-methanoinden-5-one; 4-(3-hydroxybutyl)phenol; 2,5,7,7-tetramethyloctanal; 7-isopropyl-4-methyloxepan-2-one; 2-phenylpent-4-enal; 4-hydroxy-3,5-dimethoxybenzaldehyde; (E)-4-(3-hydroxyprop-1-en-1-yl)-2-methoxyphenol; 3,6-dimethyl-5,6,7,7 a-tetrahydrobenzofuran-2(4H)-one; (6R,7 aR)-3,6-dimethyl-5,6,7,7 a-tetrahydrobenzofuran-2(4H)-one; 2-methyl-4-phenylbutanal; (Z)-2-heptylidenecyclopentan-1-one; 3-(4-methoxyphenyl)butan-2-one; 2-ethyl-5-methoxybicyclol2.2.11heptane; tridecan-3-one; (Z)-2-hexylidenecyclohexan-1-one; 2-pentylcyclohex-2-en-1-one; 4-ethyl-2,6-dimethoxyphenol; 2-((1,7,7-trimethylbicyclol2.2.11heptan-2-yeoxy)ethan-1-ol; 4-(2,6,6-trimethylcyclohex-1-en-1-yl)butan-2-ol; 145-isopropyl-2-methylphenyeethan-1-one; pentadecan-1-ol; (E)-4-(2,6,6-trimethylcyclohex-1-en-1-yl)but-3-en-2-ol; 1-(4-hydroxy-3,5-dimethoxyphenyl)ethan-1-one; (2-phenyl-1,3-dioxolan-4-yl)methanol; 1-(4,7,7-trimethylbicyclol4.1.01hept-4-en-3-yl)ethan-1-one; octyl 2-methylbutanoate; (E)-4-(2,6,6-trimethylcyclohex-2-en-1-yl)but-3-en-2-ol; 1-allyl-2,2,7,7-tetramethylcycloheptan-1-ol; (S)-2,5,5-trimethyl-1,2,3,4,5,6,7,8-octahydronaphthalen-2-ol; 1-(naphthalen-1-yl)ethan-1-one; -ethyl-2-methylnonan-1-ol; 8,8-dimethoxy-2,6-dimethyloctan-2-ol; 3-(but-3-en-1-yl)-2,4,4-trimethylcyclohex-2-en-1-one; 2-(4-isopropylcyclohexyl)propan-1-ol; pentadecanal; (E)-3,7,9-trimethyldeca-1,6-dien-3-ol; (Z)-2-ethylideneundecanal; (E)-1-(2,6,6-trimethylcyclohex-3-en-1-yl)but-2-en-1-one; 4-(2,2-dimethyl-6-methylenecyclohexyl)butan-2-ol; (5s,8s)-8-isopropyl-1-oxaspirol4.51decan-2-one; (5r,8r)-8-isopropyl-1-oxaspirol4.51decan-2-one; 2,5,5-trimethyl-2,3,4,4a,5,6,7,8-octahydronaphthalen-2-ol; 3,5-diethyl-2,6-dimethylc yclohex-2-en-1-one; (Z)-4-(4-methylcyclohex-3-en-1-ylidene)pentanal; (2R,5S,6S)-2,6,10,10-tetramethyl-1-oxaspirol4.51decan-6-ol; 6-methyl-3,4-dihydronaphthalen-1(2H)-one; ethyl benzo[di[1,3]dioxole-5-carboxylate; 7-methyl-3,4-dihydronaphthalen-1(2H)-one; 5-ethyl-2-methylnonanal; (3E,5E)-6,10-dimethylundeca-3,5,9-trien-2-one;[1,1′-bncyclohexan)]-1′-en-2-one; 4-(2,2-dimethyl-6-methylenecyclohexyl)butan-2-one; 2-isopropyl-2,3-dihydro-1H-inden-1-one; (E)-4-(2,3,6-trimethylphenyl)but-3-en-2-one; 2-(4-isopropylphenyl)propanal; 6,10-dimethylundec-9-en-2-one; (E)-6,10-dimethylundec a-5,9-dien-2-one; 1-(4-methoxy-2,2,6,6-tetramethylcyclohex-3-en-1-yl)ethan-1-one; (E)-6,10-dimethylundeca-3,9-dien-2-one; 1-(4-butylphenyl)ethan-1-one; tetradecan-3-one; 3-propylbicyclo[2.2.1]hept-5-ene-2-carbaldehyde; (E)-2,6-dimethoxy-4-(prop-1-en-1-yl)phenol; (E)-2-(oct-2-en-1-yl)cyclopentan-1-one; pentadecan-2-one; (E)-6,10-dimethylundeca-5,10-dien-2-one; 4,4a,6,7,8,8a-hexahydro-1,4-methanonaphthalen-5(1H)-one; 3-heptyl-5-methyldihydrofuran-2(3H)-one; (Z)-5-(oct-2-en-1-yl)dihydrofuran-2(3H)-one; 4,7,7-trimethylspiro[bicyclo[2.2.1]heptane-2,1′-cyclopentan] -3-one; (E)-1-(2,6,6-trimethylcyclohex-1-en-1-yl)pent-1-en-3-ol; 4-allyl-2,6-dimethoxyphenol; 2,6,8-trimethylnonan-4-one; (2,8,8-trimethyl-1,2,3,4,5,6,7,8-octahydronaphthalen-2-yl)methanol; (E)-3-(4-methoxyphenyl)-2-methylacrylaldehyde; (2E,6E)-3,7,9-trimethyldeca-2,6-dienal; (5,6-dimethyl-1-(prop-1-en-2-yl)bicyclo[2.2.1]hept-5-en-2-yl)methanol; 1-(2,4-dimethylcyclohex-3-en-1-yl)-2,2-dimethylpropan-1-one; (E)-3-butylideneisobenzofuran-1(3H)-one; 5-(6-methylhept-5-en-2-yl)dihydrofuran-2(3H)-one; 2-(4-(tert-butyl)-2-methylphenoxy)acetaldehyde; (E)-4-(4-hydroxy-3-methoxyphenyl)but-3-en-2-one; 1-(2,4-diethylphenyl)ethan-1-one; (E)-4-(3-hydroxyprop-1-en-1-yl)-2,6-dimethoxyphenol; 3-butylisobenzofuran-1(3H)-one; 2,4,5-trimethyl-4-phenyl-1,3-dioxane; 4-methyl-1-phenylpentan-2-one; 14-methylpentadecan-1-ol; adamantan-2-ol; (3 aS,4S,8S,8aR)-2,2,4-trimethyldecahydro-4,8-methanoazulen-9-ol; (E)-3-(4-hydroxy-3,5-dimethoxyphenyl)acrylaldehyde; (3E,5E)-3,6,10-trimethylundeca-3,5,9-trien-2-one; (E)-2,5,9-trimethyldeca-4,9-dienal; (E)-4-(benzo[d][1,3]dioxo1-5-yl)but-3-en-2-one; 446,6-dimethylbicyclo[3.1.1]hept-2-en-2-yl)butanal; 2,8,8-trimethyloctahydro-2H-4a,2-(epoxymethano)naphthalen-10-one; (E)-3,6,10-trimethylundeca-3,9-dien-2-one; 4-methyl-8-methyleneadamantan-2-ol; 3-methyl-4-(2,2,6-trimethylcyclohexyl)butan-2-ol; hexadecan-2-one; adamantan-2-one; heptadecan-1-ol; 4-(4-methoxyphenyl)-3-methylbutan-2-one; (E)-3-methyl-5-(2,2,3-trimethylcyclopent-3-en-1-yl)pent-3-en-2-one; 2,4-di-tert-butylcyclohexan-1-one; 145-isopropyl-2-methylcyclohex-2-en-1-yl)propan-1-one; (E)-2-methyl-4-(2,6,6-trimethylcyclohex-2-en-1-yl)but-3-enal; (E)-2,6,10-trimethylundeca-5,9-dien-1-ol; 1-methyl-4-(4-methylpentyl)cyclohex-3-ene-1-carbaldehyde; (E)-3-(benzo[d][1,3]dioxo1-5-yl)-2-methylacrylaldehyde; 1-(2,6,6-trimethylcyclohex-2-en-1-yl)pentan-3-one; (R,E)-1-(2,6,6-trimethylcyclohex-2-en-1-yl)pent-1-en-3-one; (S,E)-3,7,11-trimethyldodeca-1,6,10-trien-3-ol; (E)-2,6,10-trimethylundeca-5,9-dienal; 2,6-di-tert-butyl-4-(hydroxymethyl)phenol; (Z)-2-benzylidenehexanal; 5,5,6,7,7-pentamethylhexahydroindeno[3a,4-b]oxiren-4(1aH)-one; (4E,6E)-7,11-dimethyldodeca-4,6,10-trien-3-one; 2,5-di-tert-butylbenzene-1,4-diol; 2-methoxy-4-(4-methyl-1,3-dioxolan-2-yl)phenol; 4-(3,4-dimethoxyphenyl)butan-2-one; (Z)-2-(furan-2-ylmethylene)octanal; (E)-1-(4-methoxyphenyl)pent-1-en-3-one; 3-(4-isopropylphenyl)-2-methylpropan-1-ol; (E)-6-(2,2,3-trimethylcyclopent-3-en-1-yl)hex-5-en-3-ol; 1-(benzo[d][1,3]dioxo1-5-yl)butan-2-one; 1-(1,1,3-trimethyl-2,3,4,5,6,7-hexahydro-1H-inden-5-yl)ethan-1-one; 10-methyl-1,2,3,4,5,6,7,8,9,10-decahydro-5,9-methanobenzo[8]annulen-11-one; 3-(2-oxopropyl)-2-pentylcyclopentan-1-one; octadecan-1-ol; 3-(4-hydroxy-4-methylpentyl)cyclohex-3-ene-1-carbaldehyde; 2-((lR,3S,4S)-4-methyl-3-(prop-1-en-2-yl)-4-vinylcyclohexyl)propan-2-ol; (E)-1-(4-methoxyphenyl)-4-methylpent-1-en-3-one; (2R,4aR,8aS)-1,1,5,5-tetramethylhexahydro-2H-2,4a-methanonaphthalen-8(5H)-one; (E)-2,3-dimethyl-4-(2,6,6-trimethylcyclohex-2-en-1-yl)but-3-enal; 6-isopropyldecahydronaphthalen-2-ol; (2E,6E)-3,7,11-trimethyldodeca-2,6,10-trienal; 1,7,7-trimethylbicyclo[2.2.1]heptan-2-yl isobutyrate; (Z)-octadec-9-en-1-ol; 2-methyl-3-41,7,7-trimethylbicyclo[2.2.1]heptan-2-yl)oxy)propan-1-ol; (E)-2-methyl-1-(2,6,6-trimethylcyclohex-2-en-1-yl)pent-1-en-3-one; 3-(4-(tert-butyl)phenyl)-2-methylpropan-1-ol; 4,7,7-trimethyl-4-(3-methylbut-2-en-1-yl)bicyclo[4.1.0]heptan-3-one; (Z)-2-methyl-1-(2,2,6-trimethylcyclohex-3-en-1-yl)pent-1-en-3-one; 34(2-isopropyl-5-methylcyclohexyl)oxy)propane-1,2-diol; (Z)-2-benzylideneheptanal; 4,7,7-trimethyl-2-(3-methylbut-2-en-1-yl)bicyclo[4.1.0]heptan-3-one; (E)-2-((1S,3aR,4S,8aS)-4, 8,8-trimethyldecahydro-1,4-methanoazulen-9-ylidene)ethan-1-ol; 6-isopropyloctahydronaphthalen-2(1H)-one; 7-ethoxy-4-methyl-2H-chromen-2-one; (E)-4-methyl-6-(2,2,3-trimethylcyclopent-3-en-1-yl)hex-4-en-3-ol; 3, 8,8-trimethyl-6-methyleneoctahydro-1H-3a,7-methanoazulen-5-ol; (3R,3aR,6S,7S,8aS)-3,6,8,8-tetramethylhexahydro-1H-3a,7-methanoazulen-5(4H)-one; (E)-4-methyl-6-(2,2,3-trimethylcyclopent-3-en-1-yl)hex-5-en-3-ol; 1-(4,4-dimethyl-1,2,3,4-tetrahydronaphthalen-1-yl)propan-1-one; 8,12-dimethyltridec-11-en-6-one; 2-ethoxy-4-(4-methyl-1,3-dioxolan-2-yl)phenol; 3-benzylheptan-4-one; heptadecan-9-one; ((2S,4aR)-1,1,5,5-tetramethyl-1,3,4,5,6,7-hexahydro-2H-2,4a-methanonaphthalen-8-yl)methanol; (octahydro-1H-4,7-methanoindene-2,5-diyl)dimethanol; (1R,5S,9S,E)-4,11,11-trimethyl-8-methylenebicyclo[7.2.0]undec-3-en-5-ol; 1-(4-butoxy-2,2,6,6-tetramethylcyclohex-3-en-1-yl)ethan-1-one; (E)-2-methyl-1-(1-methylbicyclo[2.2.1]hept-5-en-2-yl)pent-1-en-3-ol; (E)-1-(3,5,6-trimethylcyclohex-3-en-1-yl)pent-1-en-3-one; (E)-1-(2,4,6-trimethylcyclohex-3-en-1-yl)pent-1-en-3-one; 2-((3S,3aS,5R,8S,8aS)-3,8-dimethyldecahydroazulen-5-yl)propan-2-ol; (2E,6E,9E)-2,6,10-trimethyldodeca-2,6,9,11-tetraenal; 1-(2,5,5-trimethyl-1,3,4,5,6,7-hexahydro-2H-2,4a-ethanonaphthalen-8-yl)ethan-1-one; oxacyclohexadecane-2,13-dione; (3R,3aR,7S,8aS)-3,6,8,8-tetramethyl-1,2,3,7,8,8a-hexahydro-4H-3a,7-methanoazulen-4-one; 1-(2,3,8,8-tetramethyl-1,2,3,5,6,7,8,8a-octahydronaphthalen-2-yl)ethan-1-one; (E)-chalcone; (E)-4-(1,3 a,4,6,7,7 a-hexahydro-5H-4,7-methanoinden-5-ylidene)butan-2-ol; (E)-3-((2,6,6-trimethylcyclohex-2-en-1-ylidene)methyl)hex-5-en-2-one; (3aR,5aS,9aS,9bR)-3a,6,6,9a-tetramethyldecahydronaphtho[2,1-blfuran-2(1H)-one; (E)-5-methyl-1-(2,6,6-trimethylcyclohex-2-en-1-yl)hex-1-en-3-one; 10,11-dihydro-5H-dibenzo[a,c1][71annulen-5-one; 5,5,7,8,8-pentamethyl-5,6,7,8-tetrahydronaphthalene-2-c arbaldehyde; (4R,4aS,6R,8aS)-4,4a-dimethyl-6-(prop-1-en-2-yl)octahydronaphthalen-2(1H)-one; 2-(1,1,2,3,3-pentamethyl-2,3-dihydro-1H-inden-5-yl)propan-1-ol; 8-(tert-butyl)-4,6-dimethyl-2H-chromen-2-one; (E)-4-(3a,4,5,6,7,7 a-hexahydro-1H-4,7-methanoinden-5-yl)-3-methylbut-3-en-2-ol; (E)-4-(3a,4,5,6,7,7a-hexahydro-1H-4,7-methanoinden-6-yl)-3-methylbut-3-en-2-ol; 2-((4-isopropylcyclohex-1-en-1-yl)methyl)cyclopentan-1-one; 445,5,6-trimethylbicyclo[2.2.1]heptan-2-yl)cyclohexan-1-ol; 1,3-diphenylpropan-2-one; 3-((2R)-5,5,6-trimethylbicyclo[2.2.1]heptan-2-yl)cyclohexan-1-ol; 3-ethyl-5,5,8,8-tetramethyl-5,6,7,8-tetrahydronaphthalene-2-carbaldehyde; (1S)-3-((Z)-benzylidene)-1,7,7-trimethylbicyclo[2.2.1]heptan-2-one; (Z)-3-benzylidene-1,7,7-trimethylbicyclo[2.2.1]heptan-2-one; 3-(5,5-dimethyl-6-methylenebicyclo[2.2.1]heptan-2-yl)cyclohexan-1-ol; 6,10,14-trimethylpentadecan-2-one; 1-(3-ethyl-5,5,8,8-tetramethyl-5,6,7,8-tetrahydronaphthalen-2-yl)ethan-1-one; 2-octyldodecan-1-ol; 2-isopropoxy-1,2-diphenylethan-1-one; 2-methoxy-4-(1,7,7-trimethylbicyclo[2.2.1]heptan-2-yl)phenol; 2-(2-(3,3,5-trimethylcyclohexyl)acetyl)cyclopentan-1-one; 2-butoxy-1,2-diphenylethan-1-one; (6E,10E)-3,7,11,15-tetramethylhexadeca-6,10,14-trien-3-ol; (6E,10E)-3,7,11,15-tetramethylhexadeca-1,6,10,14-tetraen-3-ol; 2-isobutoxy-1,2-diphenylethan-1-one; (1R)-1,7,7-trimethyl-3-((Z)-4-methylbenzylidene)bicyclo[2.2.1]heptan-2-one; 1-(4-hydroxy-3-methoxyphenyl)dec an-3-one; 3,7,11,15-tetramethylhexadec-1-yn-3-ol; (7R,11R,E)-3,7,11,15-tetramethylhexadec-2-en-1-ol; (3R,5S,8R,9S,10S,13R,14S)-10,13-dimethyl-2,3,4,5,6,7,8,9,10,11,12,13,14,15-tetradecahydro-1H-cyclopenta[alphenanthren-3-ol; 1-phenethoxy-2-(p-tolyloxy)ethan-1-ol; (7-isopropyl-1,4a-dimethyltetradecahydrophenanthren-1-yl)methanol; (5S,8R,9S,10S,13R,14S)-10,13-dimethyl-1,2,4,5,6,7,8,9,10,11,12,13,14,15-tetradecahydro-3H-cyclopenta[alphenanthren-3-one; (7-isopropyl-1,4a-dimethyl-1,2,3,4,4b,5,6,7,8,8a,9,10-dodecahydro-4a15-phenanthren-1-yl)methanol; 1-(4-(tert-butyl)phenyl)-3-(4-methoxyphenyl)propane-1,3-dione; 2,5,7,8-tetramethyl-2-(4,8,12-trimethyltridecyl)chroman-6-ol; 2,5,8-trimethyl-2-(4,8,12-trimethyltridecyl)chroman-6-ol; 2,7,8-trimethyl-2-(4,8,12-trimethyltridecyl)chroman-6-ol; 2,8-dimethyl-2-(4,8,12-trimethyltridecyl)chroman-6-ol; (1E,6E)-1,7-bis(4-hydroxy-3-methoxyphenyl)hepta-1,6-diene-3,5-dione; (1R,2R,4aS,8aS)-14(E)-6-((S)-2,2-dimethyl-6-methylenecyclohexyl)-4-methylhex-3-en-1-yl)-2,5,5,8a-tetramethyldecahydronaphthalen-2-ol; (2E,4E,6E,8E,10E,12E,14E,16E)-2,6,11,15-tetramethyl-17-(2,6,6-trimethylcyclohex-1-en-1-yl)heptadeca-2,4,6,8,10,12,14,16-octaenal; 8,8-di(1H-indol-3-yl)-2,6-dimethyloctan-2-ol and mixtures thereof.

11. The silicone compound according to claim 1, wherein said benefit agent moiety is a fragment of a benefit agent selected from the group consisting of 3,7-dimethyloctanal; octanal; tetradecanal; 2,2,6,8-tetramethyl-1,2,3,4,4a,5,8,8a-octahydronaphthalen-1-ol; (4R,4aS,6R)-4,4a-dimethyl-6-(prop-1-en-2-yl)-4,4a,5,6,7,8-hexahydronaphthalen-2(3H)-one; nonan-1-ol; nonanal; (Z)-3,7-dimethylocta-2,6-dien-1-ol; 6,6-dimethylbicyclo[3.1.1]hept-2-ene-2-carbaldehyde; (E)-4-(2,2,3,6-tetramethylcyclohexyl)but-3-en-2-one; (Z)-1-(2,6,6-trimethylcyclohex-1-en-1-yl)pent-1-en-3-one; (E)-3-methylcyclopentadec-4-en-1-one; 1-(4-isopropylcyclohexyl)ethan-1-ol; 1-(4-isopropylcyclohexyl)ethan-1-ol; 2-methyldecanal; 2-methylundecanal; 6-methoxy-2,6-dimethylheptanal; 7-methoxy-3,7-dimethyloctanal; octahydro-1H-4,7-methanoindene-1-carbaldehyde; ((1 s,4s)-4-isopropylcyclohexyl)methanol; 3-(3-(tert-butyl)phenyl)-2-methylpropanal; 2,2-dimethyl-3-(m-tolyl)propan-1-ol; 8-isopropyl-6-methylbicyclo[2.2.2]loct-5-ene-2-carbaldehyde; 4-(4-hydroxy-4-methylpentyl)cyclohex-3-ene-1-carbaldehyde; (Z)-3-hexen-1-yl-2-cyclopenten-1-one; 3-(4-methylcyclohex-3-en-1-yl)butanal; 3-(4-(tert-butyl)phenyl)-2-methylpropanal; 2-Methyl-5-(1-methylethenyl)-2-cyclohexenone; (1S,5R)-2-methyl-5-(prop-1-en-2-yl)cyclohex-2-en-1-ol; dodecan-1-ol; Dodecanal; ((3S,3aR,6R,8aS)-7,7-dimethyl-8-methyleneoctahydro-1H-3a,6-methanoazulen-3-yl)methanol; (1-methyl-24(1,2,2-trimethylbicyclol3.1.01hexan-3-yl)methyl)cyclopropyl)methanol; (Z)-4-(6,6-dimethylcyclohex-2-en-1-yl)-3-methylbut-3-en-2-one; (1R,2S,5R)-5-methyl-2-(prop-1-en-2-yl)cyclohexan-1-ol; 4,9-dimethoxy-7H-furo[3,2-g]chromen-7-one; 2-hexylcyclopent-2-en- l-one; 4-(4-methylpent-3-en-1-yl)cyclohex-3-ene-1-carbaldehyde; 2,5,6-trimethylcyclohex-3-ene-1-carbaldehyde; 4-42R)-1,7,7-trimethylbicyclo[2.2.1]heptan-2-yl)cyclohexan-1-ol; (7,7,8,8-tetramethyloctahydro-2,3b-methanocyclopental1,31cyclopropal[1,2benzen-4-yl)methanol; 2-cyclododecylpropan-1-ol; 3-phenylpropan-1-ol; 2,3-dihydro-3,3-dimethyl-1H-indene-5-propanal; 343,3-dimethyl-2,3-dihydro-1H-inden-5-yl)propanal; (Z)-2-benzylideneoctanal; 3-(benzo[d][1,3]dioxol-5-yl)-2-methylpropanal; 1-methyl-4-(propan-2-ylidene)cyclohexan-1-ol; (Z)-4-(2,2-dimethyl-6-methylenecyclohexyl)but-3-en-2-one; (Z)-1-(2,2-dimethyl-6-methylenecyclohexyl)but-2-en-1-one; 1-(3,3-dimethylcyclohexyl)pent-4-en-1-one; (6-isopropyl-9-methyl-1,4-dioxaspirol4.51decan-2-yl)methanol; 3-(2-ethylpheny0-2,2-dimethylpropanal; 3-(2-ethylphenyl)-2,2-dimethylpropanal; (E)-4,8-dimethyldeca-4,9-dienal; (2E,6E)-3,7,11-trimethyldodeca-2,6,10-trien-1-ol; (E)-cyclopentadec-4-en-1-one; 1-cyclopentadec-4-en-1-one; 2-methoxy-4-(4-methylenetetrahydro-2H-pyran-2-yl)phenol; 4-allyl-2-methoxyphenol; (2R,3S,4R)-2,3,4,5-tetrahydroxypentanal; (E)-4-((3aS,7aS)-octahydro-5H-4,7-methanoinden-5-ylidene)butanal; 2-(2-hydroxypropoxy)propan-1-ol; 2,6-dimethyloct-7-en-4-one; 3-methyl-2-pentylcyclopent-2-en-1-one; 2-methoxy-4-propylphenol; 2-methyl-5-(prop-1-en-2-yl)cyclohexan-1-ol; (Z)-1-((lR,2S)-2,6,6-trimethylcyclohex-3-en-1-yl)but-2-en-1-one; dec-9-en-1-ol; 3-(4-isopropylphenyl)-2-methylpropanal; 8,8-dimethyl-1,2,3,4,5,6,7,8-octahydronaphthalene-2-carbaldehyde; (4-isopropylphenyl)methanol; 3-(4-methylcyclohex-3-en-1-yl)butan-1-ol; 3,7-dimethyloct-6-en-1-ol; 3,7-dimethyloct-6-enal; (Z)-3-methyl-2-(pent-2-en-1-yl)cyclopent-2-en-1-one; (Z)-non-6-en-1-ol; (1R,5R)-2-methyl-5-(prop-1-en-2-yl)cyclohex-2-en-1-ol; (Z)-dec-4-enal; (3Z,6Z)-nona-3,6-dien-1-ol; (E)-3-phenylprop-2-en-1-ol; 4-chloro-3,5-dimethylphenol; hexadecan-1-ol; (E)-1-(2,6,6-trimethylcyclohex-2-en-1-yl)hepta-1,6-dien-3-one; 2-methyl-4-(2,6,6-trimethylcyclohex-1-en-1-yl)butanal; 1,1,2,3,3-pentamethyl-1,2,3,5,6,7-hexahydro-4H-inden-4-one; (1S,2S,5R,8S)-4,4,8-trimethyltricyclo[6.3.1.02,5]dodecan-1-ol; 5-isopropyl-2-methylphenol; 2-methyl-5-(prop-1-en-2-yl)cyclohex-2-en-1-one; octan-1-ol; Decanal; 3-(4-methoxyphenyl)-2-methylpropanal; 2,6-di-tert-butyl-4-methylphenol; 2-methyl-4-(2,2,3-trimethylcyclopent-3-en-1-yl)butan-1-ol; 3-(4-(tert-butyl)phenyl)propanal; (E)-2-methyl-4-(2,6,6-trimethylcyclohex-1-en-1-yl)but-2-enal; (5R,10R)-6,10-dimethyl-2-(propan-2-ylidene)spiro[4.5]dec-6-en-8-one; 1-methyl-4-(prop-1-en-2-yl)cyclohexan-1-ol; (2Z,6E)-2,6-dimethyl-10-methylenedodeca-2,6,11-trienal; (Z)-2-methyl-5-41S,2R,4R)-2-methyl-3-methylenebicyclo[2.2.1]heptan-2-yl)pent-2-en-1-ol; (S)-4-methyl-1-((S)-6-methylhept-5-en-2-yl)cyclohex-3-en-1-ol; (Z)-4-(2,2,6-trimethyl-7-oxabicyclo[4.1.0]heptan-1-yl)but-3-en-2-one; 4-methoxy-7H-furo[3,2-glchromen-7-one; (4R,4aS)-4,4a-dimethyl-6-(propan-2-ylidene)-4,4a,5,6,7,8-hexahydronaphthalen-2(3H)-one; (2Z,6E,9E)-2,6,10-trimethyldodeca-2,6,9,11-tetraenal; (E)-5-(2,3-dimethyltricyclo[2.2.1.02,6]heptan-3-yl)-2-methylpent-2-en-1-ol; 1-(5,5-dimethylcyclohex-1-en-1-yl)pent-4-en-1-one; (R,Z)-1-(2,6,6-trimethylcyclohex-2-en-1-yl)pent-1-en-3-one; (Z)-3-methyl-4-(2,6,6-trimethylcyclohex-2-en-1-yl)but-3-en-2-one; (Z)-4-(2,5,6,6-tetramethylcyclohex-2-en-1-yl)but-3-en-2-one; (1R,4S,4aR,8aR)-4-isopropyl-1,6-dimethyl-1,2,3,4,4a,7,8,8a-octahydronaphthalen-1-ol; (E)-2-benzylideneheptan-1-ol; (E)-2-benzylideneheptanal; 1-methyl-4-(4-methylpent-3-en-1-yl)cyclohex-3-ene-1-carbaldehyde; 2,3,4-trimethoxybenzaldehyde; 2,4,5-trimethoxybenzaldehyde; 2,4,6-trimethoxybenzaldehyde; Trans,Trans-2,4-Nonadienal; 2,6,10-trimethylundecanal; alpha-4-Dimethyl benzenepropanal; (E)-undec-9-enal; 2,6,10-trimethylundec-9-enal; (Z)-2-(4-methylbenzylidene)heptanal; dec-9-enal; 7-methoxy-2H-chromen-2-one; 1-(3,5,5,6,8,8-hexamethyl-5,6,7,8-tetrahydronaphthalen-2-yl)ethan-1-one; 3-(6,6-dimethylbicyclo[3.1.1]hept-2-en-2-yl)propanal; 1-isopropyl-4-methylcyclohex-3-en-1-ol; 1-phenylpent-4-en-1-one; 1-isopropyl-4-methylcyclohex-3-en-1-ol; (1aR,2S,4aS)-2,4a,8,8-tetramethyloctahydrocyclopropa[d]naphthalen-3(1H)-one; (Z)-dodec-2-enal; 3-methyl-5-phenylpentanal; 3,7-dimethyl-2-methyleneoct-6-enal; 3,7-dimethyloctan-1-ol; 3,4,5-trimethoxybenzaldehyde; 3-(4-isopropylphenyl)propanal; (E)-undec-2-enal; (2E,6E)-nona-2,6-dienal; (Z)-3-(furan-2-yl)-2-phenylacrylaldehyde; 2-phenoxyethan-1-ol; (Z)-non-2-enal; (E)-2-isopropyl-5-methylhex-2-enal; (E)-dec-2-enal; (2E,6E)-nona-2,6-dienal; (2E,6E)-nona-2,6-dien-1-ol; 2,6-dimethyloctanal; decan-1-ol; undec-10-en-1-ol; undec-10-enal; (Z)-1-(2,6,6-trimethylcyclohex-2-en-1-yl)but-2-en-1-one; (1S,5S)-4,6,6-trimethylbicyclo[3.1.1]hept-3-en-2-one; (Z)-dodec-3-enal; 3,7-dimethyloct-6-enal; (R)-3,7-dimethyloct-6-enal; (1S,2S,5S)-2-methyl-5-(prop-1-en-2-yl)cyclohexan-1-ol; 3,7-dimethyloct-6-en-1-ol; 3,7-dimethyloct-6-en-1-ol; (S)-2-methyl-5-(prop-1-en-2-yl)cyclohex-2-en-1-one; (R,E)-2-methyl-4-(2,2,3-trimethylcyclopent-3-en-1-yl)but-2-en-1-ol; (E)-4-(2,2-dimethyl-6-methylenecyclohexyl)-3-methylbut-3-en-2-one; 3-(3-isopropylphenyl)butanal; 3-(6,6-dimethylbicyclo[3.1.1]hept-2-en-2-yl)-2,2-dimethylpropanal; 2-(m-tolyl)ethan-1-ol; (3E,6E)-nona-3,6-dien-1-ol; (E)-tridec-2-enal; (1R,4S,4aS,6R,8aS)-4,8a,9,9-tetramethyloctahydro-1,6-methanonaphthalen-1(2H)-ol; 4-(prop-1-en-2-yl)cyclohex-1-ene-1-carbaldehyde; (4-(prop-1-en-2-yl)cyclohex-1-en-1-yl)methanol; 2-cyclohexylhepta-1,6-dien-3-one; 2-phenylethan-1-ol; 3-methyl-5-phenylpentan-1-ol; dimethylbicyclo[3.1.1]hept-2-en-2-yl)acetaldehyde; (4aR,8aS)-7-methyloctahydro-1,4-methanonaphthalen-6(2H)-one; 1,2-dimethyl-3-(prop-1-en-2-yl)cyclopentan-1-ol; 4-isopropyl-1-methylcyclohex-3-en-1-ol; (2Z,5Z)-5,6,7-trimethylocta-2,5-dien-4-one; 1-methyl-4-(4-methylpent-3-en-1-yl)cyclohex-3-ene-1-carbaldehyde; propane-1,2-diol; 4-(tert-pentyl)cyclohexan-1-ol; 3,7-dimethyloct-7-en-1-ol; 2-methyl-5-phenylpentan-1-ol; (Z)-2-ethyl-4-(2,2,3-trimethylcyclopent-3-en-1-yl)but-2-en-1-ol; (E)-2-methyl-4-(2,2,3-trimethylcyclopent-3-en-1-yl)but-2-en-1-ol; 5-methoxyoctahydro-1H-4,7-methanoindene-2-carbaldehyde; 5-methoxyoctahydro-1H-4,7-methanoindene-2-carbaldehyde; 3-(4-isobutylphenyl)-2-methylpropanal; 1-(spiro[4.5]dec-7-en-7-yl)pent-4-en-1-one; 2-(4-methylthiazol-5-yl)ethan-1-ol; (Z)-dodec-4-enal; (1S,4S,4aR,8aR)-4-isopropyl-1,6-dimethyl-1,2,3,4,4a,7,8,8a-octahydronaphthalen-1-ol; (1S,4S,4aR,8aS)-4-isopropyl-1,6-dimethyl-1,2,3,4,4a,7,8,8a-octahydronaphthalen-1-ol; 3,7-dimethyloctanal; 2-isopropyl-5-methylphenol; (2Z,4E)-nona-2,4-dienal; (2E,6E)-3,7,11-trimethyldodeca-2,6,10-trien-1-ol; (2E,6Z)-nona-2,6-dienal; (Z)-dec-2-enal; (E)-non-2-enal; (1R,2S)-2-(tert-butyl)cyclohexan-1-ol; (3E,6Z)-nona-3,6-dien-1-ol; (E)-dec-4-enal; (Z)-1-(2,6,6-trimethylcyclohex-2-en-1-yl)but-2-en-1-one; (E)-3,7-dimethylocta-2,6-dien-1-ol; (1R-(lalpha,3alpha,4aalpha))-2,3,4,4a,5,6-hexahydro-2,2-dimethyl-1,3-methanonaphthalen-7(1H)-one; tridecan-1-ol; 1-((2E,5Z,9Z)-2,6,10-trimethylcyclododeca-2,5,9-trien-1-yl)ethan-1-one; 2-mercapto-2-methylpentan-1-ol; undecanal; (Z)-2-methyl-4-(2,6,6-trimethycyclohex-2-en-1-yl)but-2-enal; (1R,5R)-4,6,6-trimethylbicyclo[3.1.1]hept-3-en-2-one; 2-(tert-butyl)cyclohexan-1-ol; 1,3,4,6,7,8alpha-hexahydro-1,1,5,5-tetramethyl-2H-2,4alpha-methanophtalen-8(5H)-one; 3-(3,3-dimethyl-2,3-dihydro-1H-inden-5-yl)propanal; 2,2′-oxybis(ethan-1-ol); butane-1,3-diol; hexane-1,6-diol; 2,2′-(ethane-1,2-diylbis(oxy))bis(ethan-1-ol); 2-methylpentane-2,4-diol; (2E,4E)-hepta-2,4-dien-1-ol; hexane-1,2,6-triol; (Z)-oct-5-en-1-ol; (E)-oct-3-en-1-ol; (Z)-oct-5-enal; 2,5-dimethyl-1,4-dithiane-2,5-diol; (E)-non-2-en-1-ol; (E)-non-6-en-1-ol; (E)-non-3-en-1-ol; (Z)-non-3-en-1-ol; (2E,6Z)-nona-2,6-dien-1-ol; Mannitol; 2,2′, 2″-nitrilotris(ethan-1-ol); 3-Nonen-2-one; (E)-non-5-en-2-one; 2-(cyclohexyloxy)ethan-1-ol; (E)-dec-2-en-1-ol; a-D-Glucopyranose; (E)-dec-5-en-1-ol; 2,3,6-trimethylphenol; (2E,4E)-deca-2,4-dienal; (2E,4Z)-deca-2,4-dienal; decane-1,10-diol; (Z)-dec-7-enal; (E)-2-methyloct-2-enal; 3-(hydroxymethyl)phenol; (2-methoxyphenyl)methanol; decan-2-one; 2-(o-tolyl)ethan-1-ol; undecan-1-ol; (E)-dec-3-en-2-one; 3-ethyl-2-hydroxy-4-methylcyclopent-2-en-1-one; 3-phenylpropan-1-ol; 3,5-Octadien-2-ol, 2,6-dimethyl-, (?,Z)-; 3,5-Octadien-2-ol, 2,6-dimethyl-, (?,E)—; Benzenemethanol, 4-methyl-; 2-(benzyloxy)ethan-1-ol; (E)-undec-2-en-1-ol; (2Z,4E)-undeca-2,4-dien-1-ol; (E)-7-methyl-3-methyleneocta-4,6-dien-2-ol; (Z)-undec-2-enal; (E)-undec-2-enal; (2Z,4Z)-undeca-2,4-dienal; (2E,4E)-undeca-2,4-dienal; 3-Cyclohexene-1-propanal; (E)-undec-8-enal; 1-(p-tolyl)ethan-1-ol; (E)-3,7-dimethylocta-2,6-dien-1-ol; 4-(2-hydroxyethyl)phenol; (4-methoxyphenyl)methanol; 2-methoxy-2-phenylethan-1-ol; (E)-2-isopropyl-5-methylhex-2-en-1-ol; 4-phenylbutan-1-ol; 2-(p-tolyl)ethan-1-ol; (E)-dodec-2-en-1-ol; 2-(p-tolyloxy)ethan-1-ol; 7-methyl-3-methyleneoct-6-enal; (2E,4E)-dodeca-2,4-dien-1-ol; (E)-dodec-2-enal; (2E,4E)-dodeca-2,4-dienal; (E)-5-(methylthio)-2-((methylthio)methyl)pent-2-enal; (E)-dodec-3-enal; 4-(hydroxymethyl)-2-methoxyphenol; undecan-1-ol; (E)-dodec-4-enal; 4-allylphenol; (2E,6Z)-dodeca-2,6-dienal; 3-(5-methylfuran-2-yl)butanal; 2-pentylcyclopent-2-en-1-one; 2-isopropyl-4-methylphenol; 3,7-dimethyloct-7-ene-1,6-diol; benzo[d][1,3]dioxo1-5-ylmethanol; (Z)-2,7-dimethyloct-5-en-4-one; undec-1-en-3-one; 2,6-dimethoxy-4-methylphenol; (1S,2S,5S)-2-methyl-5-(prop-1-en-2-yl)cyclohexan-1-ol; 5-phenylpentan-1-ol; rel-(1R,2S,5R)-5-methyl-2-(prop-1-en-2-yl)cyclohexan-1-ol; (E)-2-methyl-3-phenylprop-2-en-1-ol; (E)-tridec-2-en-1-ol; ((lS,2S,5S)-6,6-dimethylbicyclo[3.1.1]heptan-2-yl)methanol; tridecanal; 2-methylundecan-1-ol; 2-(3,4-dimethylphenyl)acetaldehyde; 2-(2,4-dimethylphenyl)acetaldehyde; 1,3-dihydro-2H-inden-2-one; (2E,4E)-trideca-2,4-dienal; (6,6-dimethylbicyclo[3.1.1]hept-2-en-2-yl)methanol; 3-(p-tolyl)propanal; (E)-2-(hex-2-en-1-yl)cyclopentan-1-ol; 2-(2-hydroxypropan-2-yl)-5-methylcyclohexan-1-ol; 11-methyldodecan-1-ol; (2E,4Z,7Z)-trideca-2,4,7-trienal; cyclododecanol; 2-(4-methylcyclohex-3-en-1-yl)prop-2-en-1-ol; (R)-2-(4-methylcyclohex-3-en-1-yl)prop-2-en-1-ol; (E)-2-methyl-3-(pent-2-en-1-yl)cyclopent-2-en-1-one; (E)-3-methyl-2-(pent-2-en-1-yl)cyclopent-2-en-1-one; (2E,6E)-3,7-dimethylnona-2,6-dienal; 2,6-diisopropylphenol; 1-(3,3-dimethylbicyclo[2.2.1]heptan-2-yl)ethan-1-ol; 2-(4-methylenecyclohexyl)propanal; (S)-4-(prop-1-en-2-yl)cyclohex-1-ene-1-carbaldehyde; (E)-3-(4-methoxyphenyl)acrylaldehyde; tetradecan-1-ol; 6-phenylhexan-1-ol; 2-(4-isopropylcyclohexyl)ethan-1-ol; (E)-2-ethyl-2-(3-methylbut-2-en-1-yl)hex-3-en-1-ol; 2-(4-ethylphenyl)acetaldehyde; (E)-3-methyl-1-phenylpent-1-en-3-ol; (2-hexyl-1,3-dioxolan-4-yl)methanol; 6-ethyl-3-methyloct-5-en-1-ol; octahydronaphthalen-2(1H)-one; 2-(4-isopropylphenyl)ethan-1-ol; (E)-5,9-dimethyldeca-4,9-dienal; 5-methyl-3,4-dihydronaphthalen-1(2H)-one; 8-methyl-3,4-dihydronaphthalen-1(2H)-one; (E)-tetradec-2-enal; 4-(tert-butyl)cyclohexane-1-carbaldehyde; dimethylbicyclo[3.1.1]hept-2-en-2-yl)ethan-1-ol; (4,7,7-trimethylbicyclo[4.1.0]hept-4-en-3-yl)methanol; (Z)-2-(3,3-dimethylbicyclo[2.2.1]heptan-2-ylidene)ethan-1-ol; (3 aR,7aR)-octahydro-5H-4,7-methanoinden-5-one; 4-(3-hydroxybutyl)phenol; 2,5,7,7-tetramethyloctanal; 2-phenylpent-4-enal; 4-hydroxy-3,5-dimethoxybenzaldehyde; (E)-4-(3-hydroxyprop-1-en-1-yl)-2-methoxyphenol; 2-methyl-4-phenylbutanal; 2-pentylcyclohex-2-en-1-one; 4-ethyl-2,6-dimethoxyphenol; 2-((1,7,7-trimethylbicyclo[2.2.1]heptan-2-yeoxy)ethan-1-ol; pentadecan-1-ol; (2-phenyl-1,3-dioxolan-4-yl)methanol; 1-allyl-2,2,7,7-tetramethylcycloheptan-1-ol; 5-ethyl-2-methylnonan-1-ol; 3-(but-3-en-1-yl)-2,4,4-trimethylcyclohex-2-en-1-one; 2-(4-isopropylcyclohexyl)propan-1-ol; pentadecanal; (Z)-2-ethylideneundecanal; (E)-1-(2,6,6-trimethylcyclohex-3-en-1-yl)but-2-en-1-one; 3,5-diethyl-2,6-dimethylcyclohex-2-en-1-one; (Z)-4-(4-methylcyclohex-3-en-1-ylidene)pentanal; 6-methyl-3,4-dihydronaphthalen-1(2H)-one; 7-methyl-3,4-dihydronaphthalen-1(2H)-one; 5-ethyl-2-methylnonanal; (3E,5E)-6,10-dimethylundeca-3,5,9-trien-2-one;[1,1′-bncyclohexan)]-1′-en-2-one; (E)-4-(2,3,6-trimethylphenyl)but-3-en-2-one; 2-(4-isopropylphenyl)propanal; (E)-6,10-dimethylundeca-3,9-dien-2-one; 3-propylbicyclo[2.2.1]hept-5-ene-2-carbaldehyde; (E)-2,6-dimethoxy-4-(prop-1-en-1-yl)phenol; 4,4a,6,7,8,8a-hexahydro-1,4-methanonaphthalen-5(1H)-one; 4-allyl-2,6-dimethoxyphenol; (2,8,8-trimethyl-1,2,3,4,5,6,7,8-octahydronaphthalen-2-yl)methanol; (E)-3-(4-methoxyphenyl)-2-methylacrylaldehyde; (2E,6E)-3,7,9-trimethyldeca-2,6-dienal; (5,6-dimethyl-1-(prop-1-en-2-yl)bicyclo[2.2.1]hept-5-en-2-yemethanol; 2-(4-(tert-butyl)-2-methylphenoxy)acetaldehyde; (E)-4-(4-hydroxy-3-methoxyphenyl)but-3-en-2-one; (E)-4-(3-hydroxyprop-1-en-1-yl)-2,6-dimethoxyphenol; 14-methylpentadecan-1-ol; (E)-3-(4-hydroxy-3,5-dimethoxyphenyl)acrylaldehyde; (3E,5E)-3,6,10-trimethylundeca-3,5,9-trien-2-one; (E)-2,5,9-trimethyldeca-4,9-dienal; (E)-4-(benzo[di[1,3]dioxo1-5-yl)but-3-en-2-one; 446,6-dimethylbicyclo[3.1.1]hept-2-en-2-yl)butanal; 2,8,8-trimethyloctahydro-2H-4a,2-(epoxymethano)naphthalen-10-one; (E)-3,6,10-trimethylundeca-3,9-dien-2-one; heptadecan-1-ol; (E)-3-methyl-5-(2,2,3-trimethylcyclopent-3-en-1-yl)pent-3-en-2-one; (E)-2-methyl-4-(2,6,6-trimethylcyclohex-2-en-1-yl)but-3-enal; (E)-2,6,10-trimethylundeca-5,9-dien-1-ol; 1-methyl-4-(4-methylpentyl)cyclohex-3-ene-1-carbaldehyde; (E)-3-(benzo[d][1,3]dioxo1-5-yl)-2-methylacrylaldehyde; (R,E)-1-(2,6,6-trimethylcyclohex-2-en-1-yl)pent-1-en-3-one; (E)-2,6,10-trimethylundeca-5,9-dienal; 2,6-di-tert-butyl-4-(hydroxymethyl)phenol; (Z)-2-benzylidenehexanal; (4E,6E)-7,11-dimethyldodeca-4,6,10-trien-3-one; 2,5-di-tert-butylbenzene-1,4-diol; 2-methoxy-4-(4-methyl-1,3-dioxolan-2-yl)phenol; (Z)-2-(furan-2-ylmethylene)octanal; (E)-1-(4-methoxyphenyl)pent-1-en-3-one; 3-(4-isopropylphenyl)-2-methylpropan-1-ol; octadecan-1-ol; 3-(4-hydroxy-4-methylpentyl)cyclohex-3-ene-1-carbaldehyde; (E)-1-(4-methoxyphenyl)-4-methylpent-1-en-3-one; (2R,4aR,8aS)-1,1,5,5-tetramethylhexahydro-2H-2,4a-methanonaphthalen-8(5H)-one; (E)-2,3-dimethyl-4-(2,6,6-trimethylcyclohex-2-en-1-yl)but-3-enal; (2E,6E)-3,7,11-trimethyldodeca-2,6,10-trienal; (Z)-octadec-9-en-1-ol; 2-methyl-34(1,7,7-trimethylbicyclo[2.2.1]heptan-2-yl)oxy)propan-1-ol; (E)-2-methyl-1-(2,6,6-trimethylcyclohex-2-en-1-yl)pent-1-en-3-one; 3-(4-(tert-butyl)phenyl)-2-methylpropan-1-ol; (Z)-2-methyl-1-(2,2,6-trimethylcyclohex-3-en-1-yl)pent-1-en-3-one; 3-((2-isopropyl-5-methylcyclohexyl)oxy)propane-1,2-diol; (Z)-2-benzylideneheptanal; (E)-2-((1S,3aR,4S,8aS)-4,8,8-trimethyldecahydro-1,4-methanoazulen-9-ylidene)ethan-1-ol; 6-isopropyloctahydronaphthalen-2(1H)-one; 2-ethoxy-4-(4-methyl-1,3-dioxolan-2-yl)phenol; ((2S,4aR)-1,1,5,5-tetramethyl-1,3,4,5,6,7-hexahydro-2H-2,4a-methanonaphthalen-8-yl)methanol; (octahydro-1H-4,7-methanoindene-2,5-diyl)dimethanol; (E)-1-(3,5,6-trimethylcyclohex-3-en-1-yl)pent-1-en-3-one; (E)-1-(2,4,6-trimethylcyclohex-3-en-1-yl)pent-1-en-3-one; (2E,6E,9E)-2,6,10-trimethyldodeca-2,6,9,11-tetraenal; (E)-chalcone; (E)-5-methyl-1-(2,6,6-trimethylcyclohex-2-en-1-yl)hex-1-en-3-one; 5,5,7,8,8-pentamethyl-5,6,7,8-tetrahydronaphthalene-2-carbaldehyde; (4R,4aS,6R,8aS)-4,4a-dimethyl-6-(prop-1-en-2-yl)octahydronaphthalen-2(1H)-one; 2-(1,1,2,3,3-pentamethyl-2,3-dihydro-1H-inden-5-yl)propan-1-ol; 4-(5,5,6-trimethylbicyclo[2.2.1]heptan-2-yl)cyclohexan-1-ol; 34(2R)-5,5,6-trimethylbicyclo[2.2.1]heptan-2-yl)cyclohexan-1-ol; 3-ethyl-5,S,8,8-tetramethyl-5,6,7,8-tetrahydronaphthalene-2-carbaldehyde; 3-(5,5-dimethyl-6-methylenebicyclo[2.2.1]heptan-2-yl)cyclohexan-1-ol; 2-octyldodecan-1-ol; 2-methoxy-4-(1,7,7-trimethylbicyclo[2.2.1]heptan-2-yl)phenol; (7R,11R,E)-3,7,11,15-tetramethylhexadec-2-en-1-ol; 1-phenethoxy-2-(p-tolyloxy)ethan-1-ol; (7-isopropyl-1,4a-dimethyltetradecahydrophenanthren-1-yl)methanol; (7-isopropyl-1,4a-dimethyl-1,2,3,4,4b,5,6,7,8,8a,9,10-dodecahydro-4a15-phenanthren-1-yl)methanol; (1E,6E)-1,7-bis(4-hydroxy-3-methoxyphenyl)hepta-1,6-diene-3,5-dione; (2E,4E,6E,8E,10E,12E,14E,16E)-2,6,11,15-tetramethyl-17-(2,6,6-trimethylcyclohex-1-en-1-yl)heptadeca-2,4,6,8,10,12,14,16-octaenal and mixtures thereof.

12. A consumer product composition comprising:
a.) from 0.0001% to 10% of a silicone compound according to claim 1; and
b.) a consumer product ingredient.

13. A consumer product according to claim 12, said consumer product being a cleaning and/or treatment composition.

14. A cleaning and/or treatment composition according to claim 12 comprising a consumer product ingredient selected from the group consisting of surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume, an additional perfume delivery system, structure elasticizing agents, thickeners/structurants, fabric softeners, carriers, hydrotropes, oligoamines, processing aids, hueing agents, pigments and mixtures thereof.

15. A consumer product comprising a silicone compound according to claim 1 and packaging, said packaging comprising a silicone compound according to claim 1 that is attached or adhered to said packaging.

16. A display comprising a silicone compound according to claim 1 and a display material, said silicone compound being attached or adhered to said display material.

17. A method of treating and/or cleaning a situs, said method comprising
a.) optionally washing and/or rinsing said situs;
b.) contacting said situs with a silicone compound according to claim 1; and
c.) optionally washing and/or rinsing said situs.

18. A situs treated with a consumer product according to claims 12.
